(19) United States
(12) Patent Application Publication
(10) Pub. No.: US 2026/0084972 A1
(43) Pub. Date: Mar. 26, 2026

(54) SYSTEMS, ARTICLES, AND METHODS RELATED TO TRANSPARENT INSULATION MATERIALS INCLUDING AEROGELS

(71) Applicant: AeroShield Materials, Inc., Waltham, MA (US)

(72) Inventors: William Mullin, Quincy, MA (US); Vishnu Ramasawmy, Roxbury, MA (US); Zachary Goodman, Salem, NH (US); Peter Armstrong, Charlestown, MA (US); Harold Klei, Uxbridge, MA (US); Elizabeth Votta, Boston, MA (US); Emely Gonzalez, Roxbury, MA (US); Chris Champagne, Waltham, MA (US); Omar Laris, Boulder, CO (US); David Avison, Boxboro, MA (US); Kyle Wilke, Cambridge, MA (US)

(73) Assignee: AeroShield Materials, Inc., Waltham, MA (US)

(21) Appl. No.: 19/334,709

(22) Filed: Sep. 19, 2025

Related U.S. Application Data
(60) Provisional application No. 63/697,116, filed on Sep. 20, 2024.
(60) Provisional application No. 63/733,506, filed on Dec. 13, 2024.

(51) Int. Cl. C01B 33/158

(52) U.S. Cl. CPC C01B 33/1585; C01P 2006/10; C01P 2006/12; C01P 2006/32; C01P 2006/60; C01P 2006/90

(57) ABSTRACT

Aerogels having relatively large areas and/or relatively low numbers of defects are generally described. In some embodiments, the aerogel has one or more properties (e.g., optical and/or thermal properties) that do not substantially vary across the aerogel. Insulated glass units and/or solar thermal receivers comprising aerogels are also generally described. Articles, systems, and methods related to aerogels coupled to substrates are also generally described. Aerogels, including monolithic aerogels, may be coupled to transparent substrates such that the resulting article has advantageous insulation properties for window applications. Such articles may be used to retrofit existing windows or be incorporated into insulated glass units. The coupling of the aerogel to the substrate, in some embodiments, does not significantly impact the optical properties of the substrate and/or the aerogel. Insulated units comprising the aerogels are also described.

### RELATED APPLICATIONS

This application claims priority under 35 U.S.C. § 119 (e) to U.S. Provisional Patent Application No. 63/697,116, filed Sep. 20, 2024, and entitled “Systems, Articles, and Methods Related to Transparent Insulation Materials Including Aerogels” and to U.S. Provisional Patent Application No. 63/733,506, filed Dec. 13, 2025, and entitled “Systems, Articles, and Methods Related to Coupling of Aerogels to Substrates,” each of which is incorporated herein by reference in their entirety for all purposes.

### GOVERNMENT SPONSORSHIP

This invention was made with Government support under Award No. 2155248 and 2037715 awarded by the National Science Foundation. The Government has certain rights in the invention.

### TECHNICAL FIELD

System, articles, and methods involving aerogels having a relatively large area and/or a relatively high transmittance are generally described.

### BACKGROUND

Poorly insulated windows and other desirably-transparent articles may exacerbate undesirable heat transfer between external environments and the interior of the structures, such as commercial and residential buildings, which they separate. Such heat transfer may result in increased energy expenditure as climate control systems may need to operate for longer durations of time. Conventional thermal insulation materials are generally not well suited for window applications as they do not have sufficient transparency. Accordingly, improved transparent insulation materials are needed.

### SUMMARY

Aerogels having a relatively large area and/or a relatively high transmittance are generally described. The subject matter of the present disclosure involves, in some cases, interrelated products, alternative solutions to a particular problem, and/or a plurality of different uses of one or more systems and/or articles.

In one aspect of the disclosure, articles are provided. In some embodiments, the article comprises: an aerogel comprising silica, wherein the aerogel has a volume greater than or equal to 400 cm³ and haze less than or equal to 5% through at least a portion of the aerogel.

In some embodiments, the article comprises: an aerogel comprising silica and having a surface with a continuous substantially transparent area of at least 900 cm², wherein the entire continuous substantially transparent area is defined by a plurality of 1 cm² geometric areas, and transmittance measured through the aerogel perpendicular to the surface through at least one location within each of the 1 cm² geometric areas is greater than or equal to 85% at at least one wavelength greater than or equal to 360 nm and less than or equal to 780 nm when measured at a thickness of at least 0.5 mm.

In some embodiments, the article comprises: an aerogel comprising silica and having a surface with a continuous substantially transparent area of at least 900 cm², wherein the entire continuous substantially transparent area is defined by a plurality of 1 cm² geometric areas, and at no location within the entire continuous substantially transparent area is there a 1 cm² geometric area through which maximum transmittance through the aerogel perpendicular to the surface differs by more than 10% relative to the average of transmittance through all of the 1 cm² geometric areas of the continuous substantially transparent area, all measured at at least one wavelength greater than or equal to 360 nm and less than or equal to 780 nm and measured at a thickness of at least 0.5 mm.

In some embodiments, the article comprises: an aerogel, including a free-standing portion formed in a mold having a mold portion corresponding to the free-standing portion of the article, wherein a first dimension in the mold portion is reproduced in the article as a second dimension with less than or equal to 10% geometric deviation from the first dimension.

In some embodiments, the article comprises: a first layer comprising a transparent material, an aerogel, and an electromagnetic radiation pathway traversing at least a portion of each of the aerogel and the first layer, wherein, along the electromagnetic radiation pathway, the article has: (a) a transmittance greater than or equal to 85% at at least one wavelength greater than or equal to 360 nm and less than or equal to 780 nm, and (b) a thermal conductivity less than or equal to 25 mW/mK, wherein an essentially identical article, absent the aerogel, has: (a) a transmittance within at least 20% of the transmittance along the electromagnetic radiation pathway of the article at at least one wavelength greater than or equal to 360 nm and less than or equal to 780 nm, and (b) a thermal conductivity at least 5% greater than the thermal conductivity of the article.

In some embodiments, the article comprises: an aerogel comprising silica and having a surface with a continuous substantially transparent area of at least 900 cm², wherein transmittance measured through the aerogel perpendicular to the surface through at least 5 selected locations within the continuous substantially transparent area, separated from all other selected locations by at least 5 cm is greater than or equal to 85% at at least one wavelength greater than or equal to 360 nm and less than or equal to 780 nm when measured at a thickness of at least 0.5 mm.

In some embodiments, the article comprises: an aerogel coupled to a substrate, wherein the ultimate shear strength between the aerogel and the substrate is greater than or equal to 0.1 kPa and haze through at least a portion of the aerogel and the substrate is less than or equal to 15%.

In some embodiments, the article comprises: an aerogel coupled to a substrate, wherein the article is capable of undergoing at least 25,000 cycles, in accordance with the WDMA TM-7 testing standard, without exhibiting a greater number of cracks than the number of cracks present in the article prior to the at least 25,000 cycles, and wherein at least 200 g is exerted on at least a portion of the article each cycle.

In some embodiments, the article comprises: a substrate, an aerogel, and an electromagnetic radiation pathway traversing at least a portion of each of the aerogel and the substrate, wherein, along the electromagnetic radiation pathway, the article has a haze and/or a transmittance at at least one wavelength greater than or equal to 360 nm and less than or equal to 780 nm, wherein an essentially identical article, absent the aerogel, has: (a) a haze within 5% of the haze of the articles, and/or (b) a transmittance within at least 20% of the transmittance along the electromagnetic radiation pathway of the article at at least one wavelength greater than or equal to 360 nm and less than or equal to 780 nm.

In some embodiments, the article comprises: a substrate, an aerogel, and an electromagnetic radiation pathway traversing at least a portion of each of the aerogel and the substrate, wherein, along the electromagnetic radiation pathway, the article has a haze less than or equal to 15%, and wherein an essentially identical article, absent the aerogel, has a haze within 5% of the haze of the articles.

In another aspect of the disclosure, methods are provided. In some embodiments, the method comprises: forming an aerogel comprising silica, from casting through annealing, such that the aerogel comprises a surface with a continuous substantially transparent area of at least 900 cm², wherein the entire continuous substantially transparent area of the aerogel is defined by a plurality of 1 cm² geometric areas, and transmittance measured through the aerogel perpendicular to the surface through at least one location within each of the 1 cm² geometric areas of the continuous substantially transparent area is greater than or equal to 85% at at least one wavelength greater than or equal to 360 nm and less than or equal to 780 nm when measured at a thickness of at least 0.5 mm.

In some embodiments, the method comprises: coupling an aerogel to a substrate such that the ultimate shear strength between the aerogel and the substrate is greater than or equal to 0.1 kPa and haze through at least a portion of the aerogel and the substrate is less than or equal to 15%.

In yet another aspect of the disclosure, insulated units are provided. In some embodiments, the insulated unit comprises: a first layer comprising a monolithic aerogel comprising silica, and having a first side and a second side; a second layer comprising a transparent substrate, the second layer disposed on the first side of the first layer; a third layer comprising a transparent substrate, the third layer disposed on the second side of the first layer; and a coating disposed on one or more sides of the second layer, wherein: the coating has an emissivity of less than or equal to 0.9 and greater than or equal to 0.01.

In some embodiments, the insulated unit comprises: a first, aerogel layer comprising a monolithic aerogel comprising silica; a second layer comprising the transparent substrate, and having a first side and a second side; a third layer comprising the transparent substrate, the third layer disposed on a first side of the second layer; and a fourth layer comprising a transparent substrate, the third layer disposed on a second side of the second layer, wherein: the first, aerogel layer is positioned between the second layer and the third layer; and/or the first, aerogel layer is positioned between the third layer and the fourth layer.

In some embodiments, the insulated unit comprises: a first, aerogel layer comprising a monolithic aerogel comprising silica, and having a first side and a second side; a second layer comprising a transparent substrate, the second layer disposed on a first side of the first, aerogel layer; and a third layer comprising the transparent substrate, the third layer disposed on a second side of the first, aerogel layer, wherein: a ratio of the Rᵥₐₗ of the insulated unit to the thickness of the insulated unit is greater than or equal to 3 h·ft²·F/Btu·in.

In some embodiments, the insulated unit comprises: a first layer comprising a transparent substrate, and having a first side and a second side; a second layer comprising the transparent substrate, the second layer disposed on a first side of the first layer; and a third layer comprising the transparent substrate, the third layer disposed on a second side of the first layer, wherein: a ratio of the Rᵥₐₗ of the insulated unit to the thickness of the insulated unit is greater than or equal to 7.1 h·ft²·F/Btu·in.

Other advantages and novel features of the present disclosure will become apparent from the following detailed description of various non-limiting embodiments of the disclosure when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present disclosure will be described by way of example with reference to the accompanying figures, which are schematic and are not intended to be drawn to scale unless otherwise indicated. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIG. 1A is a schematic diagram describing an aerogel, according to some embodiments.

FIG. 1B is a schematic diagram describing an aerogel comprising defects, according to some embodiments.

FIG. 1C is a schematic diagram depicting an aerogel having a continuous substantially transparent area, according to some embodiments.

FIG. 1D is a schematic diagram depicting an aerogel having a continuous volume, according to some embodiments.

FIG. 2A is a flow chart depicting the general fabrication process of an aerogel having a relatively large size and/or a relatively low number of defects, according to certain embodiments.

FIG. 2B is a flow chart depicting the fabrication process of an aerogel wherein a solvent exchange is performed prior to a heat treatment, according to certain embodiments.

FIG. 3 is a schematic diagram depicting an aerogel and a mold, in accordance with certain embodiments.

FIG. 4 is a plot depicting the dimensional stability of the aerogel through various stages of the fabrication process, according to some embodiments.

FIG. 5 is a plot depicting the dimensional stability of the aerogel through various stages of the fabrication process, specifically for aerogels having length greater than or equal to 31 mm and less than or equal to 34 mm, according to some embodiments.

FIG. 6 is a plot depicting the density of aerogels as a function of the duration of a high-temperature bath, according to some embodiments.

FIG. 7 is a plot depicting the haze of aerogels as a function of the duration of a high-temperature bath, according to some embodiments.

FIG. 8A is an image depicting an aerogel having a relatively large number of defects, according to some embodiments.

FIG. 8B is an image depicting an aerogel having a relatively small number of defects, according to some embodiments.

FIG. 8C is an image depicting an aerogel having undergone a heat treatment in the presence of water compared to an aerogel not having undergone heat treatment in the presence of water, according to some embodiments.

FIG. 9 is a plot depicting the probability of failure of an aerogel relative to the flexural strength of the aerogel, according to some embodiments.

FIGS. 10-11 are plots depicting the Weibull modulus of an aerogel, according to some embodiments.

FIG. 12 is a plot depicting the fracture toughness of aerogels, according to some embodiments.

FIG. 13 is a plot depicting the critical flaw size of aerogels, according to some embodiments.

FIG. 14 is a plot depicting the rupture strength of aerogels, according to some embodiments.

FIGS. 15A-15D are schematic diagrams depicting aerogels coupled to substrates, according to some embodiments.

FIG. 16 is a diagram of cyclic slam testing (e.g., durability testing) using a 2″×2″ sample, according to some embodiments.

FIG. 17 is a plot depicting the ultimate shear strength of 2″×2″ samples prepped with 100% isopropyl, according to some embodiments.

FIG. 18 is a table depicting visual analysis of the composite, according to some embodiments.

FIG. 19 is a plot depicting haze measurement results of aerogel with OCA8211 and OCA8213 against a control aerogel sample with no OCA applied to it, according to some embodiments.

FIG. 20 is a plot describing the ultimate shear strength of the aerogel-substrate composite coupled using Hydrosil 1151+GLYMO, 100% Isopropyl, Silbond H5, VPS 4721 and VPS SIVO 180.

FIG. 21 is a plot depicting haze measurement results of an aerogel-glass composite with Hydrosil 1151+GLYMO, 100% Isopropyl, Silbond H5, VPS 4721 and VPS SIVO 180, according to some embodiments.

FIG. 22 is a plot depicting haze measurement results of an aerogel-glass composite, an aerogel-glass composite with a OCA 8211 adhesive, and an aerogel-glass composite with a OCA 8213 adhesive, according to some embodiments.

FIG. 23A is a schematic diagram depicting an insulating unit comprising two substrate layer and an aerogel layer without a gap, according to some embodiments.

FIG. 23B is a schematic diagram depicting an insulating unit comprising a first substrate layer, a second substrate layer, an aerogel layer coupled to the first substrate layer, and a gap positioned between the aerogel layer and the second substrate layer, according to some embodiments.

FIG. 23C is a schematic diagram depicting an insulating unit having a coating disposed on a substrate layer, according to some embodiments.

FIG. 24A is a schematic diagram depicting a triple-pane insulating unit having an aerogel layer and three substrate layers, according to some embodiments.

FIG. 24B is a schematic diagram depicting a triple-pane insulating unit having an aerogel layer and three substrate layers, wherein the aerogel layer is coupled to a second substrate layer, according to some embodiments.

FIG. 24C is a schematic diagram depicting a triple-pane insulating unit having an aerogel layer and three substrate layers, wherein the aerogel layer is coupled to a third substrate layer, according to some embodiments.

FIG. 24D is a schematic diagram depicting a triple-pane insulating unit having two aerogel layers and three substrate layers, according to some embodiments.

FIG. 24E is a schematic diagram depicting a triple-pane insulating unit having three aerogel layers and three substrate layers, according to some embodiments.

FIG. 24F is a schematic diagram depicting a triple-pane insulating unit having three aerogel layers, three substrate layers, and coating layers, according to some embodiments.

FIG. 24G is a schematic diagram depicting a triple-pane insulating unit having four aerogel layers and three substrate layers, according to some embodiments.

FIG. 25 is a schematic diagram depicting a double-pane insulating unit having two coating layers, according to some embodiments.

### DETAILED DESCRIPTION

The present disclosure relates generally to aerogels, and/or related devices, systems, and/or methods. Aerogels are a class of materials that are generally known for their relatively high porosity, low thermal conductivity, and in some cases, relatively high transparency. Yet many prior aerogels exhibit compromised properties, and/or are difficult to make and/or use effectively. This disclosure describes significant advances in aerogels and related articles and uses.

In some embodiments, aerogels of this disclosure comprise a porous network including a framework material defining a plurality of pores (e.g., voids). The pores are generally of a material different from the framework. E.g., within the pores of the porous network can be contained a solid, liquid, or a gas generally different in whole or in part from the framework that defines the pores (present surrounding the pores). In many instances, a gas is contained within the pores (e.g., air, an inert gas, or another gas or mixture of gases). In one set of common embodiments, the pores contain air. In another set of embodiments, the aerogel may be under vacuum, and pores of the aerogel may contain substantially no gases.

Characteristics of an aerogel, such as the ratio of overall volume consumed by the pores relative to the volume of the framework (i.e., the porosity of the aerogel), and content of the pores, may limit thermal conduction through articles that include the aerogels allowing the aerogel and/or article to have a relatively low overall thermal conductivity, i.e., a high insulative quality. Accordingly, aerogels may be a promising material for any of a variety of insulation applications (e.g., thermal insulation and/or acoustic insulation).

In certain instances, it is desirable that aerogels, or at least portions of aerogels, are at least partially transmissive of electromagnetic radiation at specific wavelengths, and/or within wavelength ranges (e.g., transparent to visible light having wavelengths greater than or equal to 360 nm and less than or equal to 780 nm). In some cases, it may be desirable that aerogels, or at least portions of aerogels, have relatively low haze so that light transmitted along an electromagnetic energy pathway through the aerogel is not excessively diffused. Aerogels having relatively low thermal conductivity and high transparency may be suitable to serve as a window or window component, a component of a solar thermal receiver, etc., e.g., an insulation layer for window applications (e.g., windows on commercial/residential buildings and/or vehicles).

Typically, it is challenging to fabricate aerogels, using conventional techniques, having sufficient insulative properties and also sufficient size (area) and transparency for window applications. Many prior aerogel fabrication techniques rely on sol-gel process(es). Such processes generally involve inducing gelation of a colloidal solution of particles, then removing the liquid from the solution such that voids remain within the gel structure. The removal of the liquid (e.g., the solvent) often shrinks the gel or creates other dimensional instability during or after the process. Such shrinkage may introduce defects (as described elsewhere in this disclosure) within the aerogel that not only harm the transparency of the aerogel but may introduce variations in one or more desirable properties of the aerogel (e.g., optical properties and/or mechanical properties) rendering the aerogel unsuitable and/or undesirable for a desired application, e.g. a window application. Additionally, when fabricating aerogels having a relatively large volume (e.g., having a surface with a continuous area of at least 900 cm²), removal of the liquid may result in shrinkage that cracks and/or fractures the aerogel thereby limiting its use in window applications as well as other applications.

Moreover, it is challenging to fabricate aerogels in a manner that is conducive for use in window applications. For example, to serve as a transparent insulator for window applications, it may be desirable for the aerogel to be coupled to a transparent substrate (e.g., glass or a transparent plastic such as acrylic) to form an article such as a glass-aerogel composite. The composite may serve to retrofit existing windows and/or form a portion of an insulated glass unit (IGU). It may also be desirable for the aerogel and the substrate to remain coupled throughout the duration of its use. The aerogel and the substrate may undergo numerous cycles of stress via the opening and/or closing of structures that incorporate it, such as windows, doors, and/or other structures. If the aerogel and the substrate decouple under this stress, damage may be imparted on the aerogel thereby decreasing its effectiveness has a transparent insulator. Adhesives may be used to couple (e.g., bond, adhere, immobilize, and/or otherwise connect) the aerogel to the substrate. However, conventional adhesive regimes may undesirably increase the haze and/or decrease the transparency along an electromagnetic radiation pathway through the composite (e.g., through at least a portion of the aerogel and at least a portion of the substrate coupled to the aerogel). It is generally challenging to couple aerogels, especially relatively large-area aerogels, to substrates with sufficient strength for practical applications while maintaining suitable optical properties for window applications.

Insulated units, such as insulated glass units, comprising such aerogels are generally challenging to make, but may provide a number of advantages over conventional insulated glass units. Insulated units that include the aerogels described herein may provide advantageous insulative properties and sound dampening properties over conventional window and/or insulated glass units. Moreover, monolithic aerogels allow for the design of insulated glass units to be tailored for specific environments. For example, as described later in this disclosure, layers of aerogels can positioned within an insulated unit to provide thermal and/or sound insulation without significantly compromising the clarity of the insulated unit. The number of aerogel layers may correlate to the thermal and/or sound insulative properties of the aerogel and may be chosen based on the environment the insulated unit will be used in. The light-weight nature of aerogels also allows the insulated units described herein to possess such advantageous properties without substantially increasing the overall weight of the insulated unit.

Thus, this disclosure provides high-quality aerogels and related articles, including articles that are generally larger than some prior or otherwise comparative articles, with good mechanical and transmissive properties. This disclosure also provides improved fabrication methods that can produce aerogels having a relatively large size with a relatively low defect level. The present disclosure also describes aerogels and related articles, including articles that are generally more insulative than otherwise comparative articles. Moreover, this disclosure provides improved processes for coupling (e.g., bonding, adhering, immobilizing, etc.) an aerogel to a substrate. Insulated units (e.g., insulated glass units (IGU)) are also provided including insulated units comprising aerogels (e.g., monolithic aerogels) comprising silica).

In one set of embodiments, aerogels having a relatively large area with low number of defects, and/or low defect impact level are generally described. In some embodiments, the aerogel comprises a relatively low quantity of defects, and/or a relatively low defect density. That is, the aerogel, in this set of embodiments, includes a relatively low number of defects per unit volume and/or per unit area of the aerogel. Where “area” is used herein, this generally means the area of a surface of an aerogel, or article that includes an aerogel, where the surface is perpendicular to the smaller or smallest dimension of the article, e.g., perpendicular to the thinnest portion of the article. The presence of defects within a volume of the aerogel may compromise optical properties by, for example, reducing and/or altering the transmission of light through the aerogel, and/or negatively affect certain mechanical properties of the aerogel. By reducing and/or eliminating defects from a volume of the aerogel, the optical properties (e.g., transmissivity, haze) and/or mechanical properties (e.g., modulus, compression strength, density) of the aerogel may advantageously improve and/or have limited variability throughout the aerogel. The presence of defects on a surface of and/or within the aerogel may also create variability in one or more properties of the aerogel. For example, the transparency through a first portion of the aerogel that includes a threshold level of defects may be relatively lower than that through a second portion of the aerogel that includes less defects, or even essentially no defects. The same can be the case for variability, in the aerogel, of mechanical properties.

As used herein, “defect” has a meaning that would be readily understood by those of ordinary skill in the art. As an example, a defect may include any of a variety of abnormalities, inconsistencies, and/or blemishes on a surface of and/or within the aerogel, such as contaminants and/or particulates, cracks, striations, bubbles (e.g., voids, outside of the normal bubble/void characteristic, by design, of the aerogel itself), patterned surfaces (e.g., from substrates involved in the fabrication process), and/or markings or other blemishes derived from the fabrication process. In some embodiments, a defect can be any of the imperfections described in ASTM C1036-21 (2021) which is herein incorporated by reference in its entirety for all purposes. In some embodiments, defects arise during any step during the formation of the aerogel including but not limited to the casting step, the one or more solvent exchange processes, the drying step, and/or the annealing step. Further, in one set of embodiments, a defect is an abnormality or other characteristic of the aerogel which interacts with electromagnetic radiation as follows: when transmittance is measured through the defect (the entire defect or one section of the defect), through the aerogel perpendicular to a continuous substantially transparent area of the aerogel as described herein, the measured transmittance is less than or equal to 99% (e.g., less than or equal to 98%, less than or equal to 95%, less than or equal to 90%, less than or equal to 85%, or less than or equal to 80%) of the measured transmittance averaged across the entire substantially transparent area, at at least one wavelength greater than or equal to 360 nm and less than or equal to 780 nm when measured through an aerogel thickness of at least 0.5 mm. That is, the transmittance through the defect or at least one portion of it, when measured through an aerogel thickness of at least 0.5 mm of the continuous substantially transparent area, at any point location within that area, is less than or equal to 90% (e.g., less than or equal to 98%, less than or equal to 95%, less than or equal to 90%, less than or equal to 85%, or less than or equal to 80%) of the measured transmittance averaged across the entire substantially transparent area at at least one wavelength greater than or equal to 360 nm and less than or equal to 780 nm (e.g., greater than or equal to 380 nm and less than or equal to 410 nm).

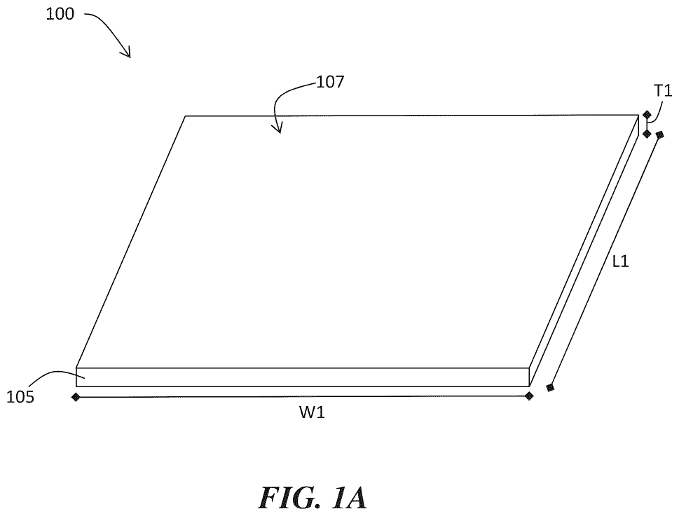

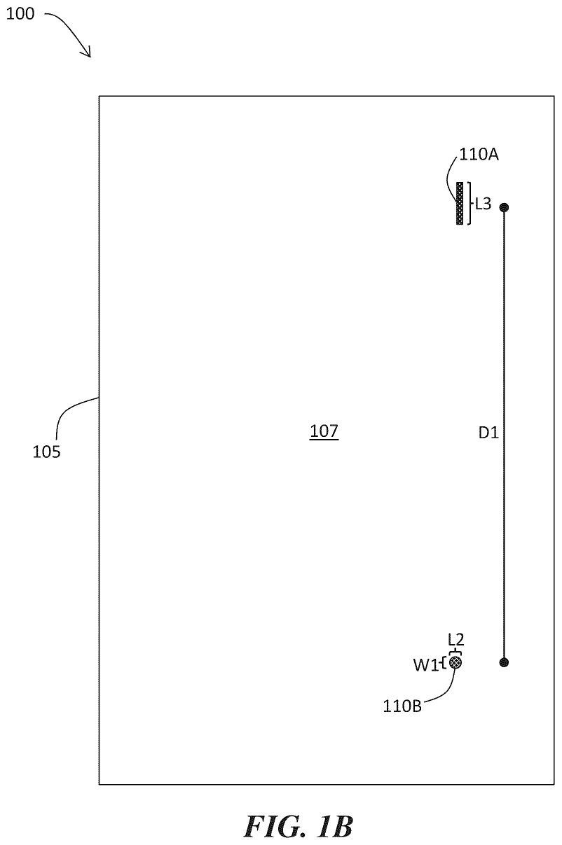

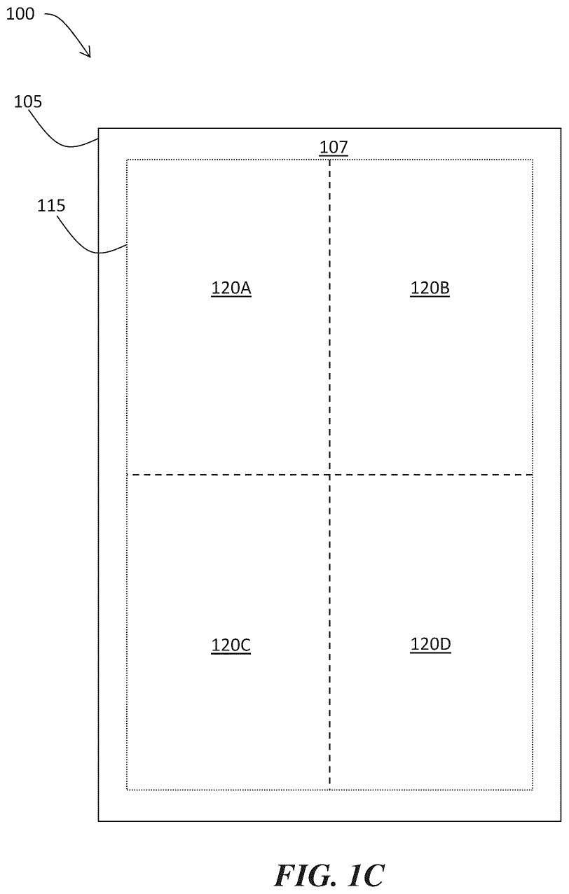

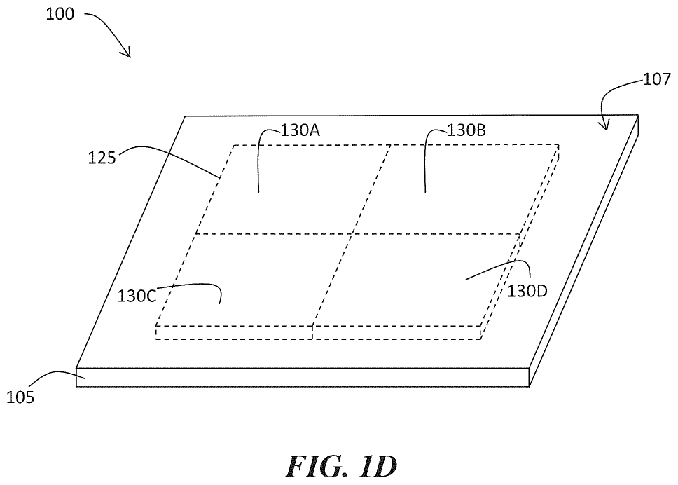

In some embodiments, the aerogel has few if any detectable defects despite having a relatively large volume and/or area. In some embodiments, the aerogel is substantially free of defects. In some embodiments, an aerogel substantially free of defects has substantially the same properties, including any of those described in the present disclosure, as an otherwise essentially identical aerogel having no defects. For example, as shown in FIG. 1A, article 100 comprises aerogel 105 that is free of defects and has a relatively large volume having dimension of width W1, length L1, and thickness T1. In FIG. 1A, aerogel 105 that is free of defects has surface 107 having a relatively large area having dimensions of width W1 and length L1. In some embodiments, the aerogel has no detectable defects. In some embodiments, defects may be detected using optical microscopy. In some embodiments, the aerogel may have defects that are relatively small (e.g., less than or equal to 0.5 mm) and/or have defects having relatively large distances between each other (e.g., greater than or equal to 1500 mm). Accordingly, the aerogel, in certain cases, may have advantageous properties (e.g., high transmittance of the visible light) and/or limited variation of such properties across the aerogel which may be desirable in window applications and/or other applications (e.g., for use in a solar thermal receiver).

It should be noted that, as used herein, a “surface” of an aerogel generally refers to a geometric area of the aerogel, or at least a portion thereof, forming the exterior boundaries of the aerogel rather than an internal surface of the aerogel (e.g., a surface on the porous network itself). Accordingly, in some embodiments, the surface includes areas of the porous network and any voids, defects, and/or pores present across the surface. For example, as shown in FIG. 1A, article 100 has surface 107 that is a geometric area of article 100 forming a portion of the exterior boundaries of article 100. Surface 107 does not represent the surface of the internal porous network (not shown) of the article. Moreover, as used herein, “surface area” generally refers to the calculate area of the “surface” as described above, rather than the internal surface area associated with the porous network. For example, an aerogel having external dimensions including a width of 10 cm and a length of 12 cm may have a surface that also has width of 10 cm and a length of 12 cm. In such a case, the surface area of the surface will be 120 cm², which is far smaller than the surface area of the internal porous structure of the aerogel. In some embodiments, defects present in the aerogel, if any, may have any of a variety of sizes. In some embodiments, defects present in the aerogel, if any, have a size less than or equal to 2.5 mm, less than or equal to 2 mm, less than or equal to 1.5 mm, less than or equal to 1.2 mm, less than or equal to 0.8 mm, less than or equal to 0.5 mm, or less than or equal to 0.25 mm. In some embodiments, defects in the aerogel, if any, have a size greater than or equal to 0.25 mm, greater than or equal to 0.5 mm, greater than or equal to 0.8 mm, greater than or equal to 1.2 mm, greater than or equal to 1.5 mm, greater than or equal to 2 mm, or greater than or equal to 2.5 mm. Combinations of these ranges are possible (e.g., less than or equal to 2.5 mm and greater than or equal to 0.25 mm). Other ranges are also possible. In some embodiments, the size of the defect can be determined by calculating the average of the maximum width and the maximum length of the defect, as described in ASTM C1036-21. For example, as shown in FIG. 1B, aerogel 105 comprises defect 110B having width W2 and length L2. Accordingly, the size of defect 110B is the numerical average of width W2 and length L2. In some embodiments, the size of the defect can be represented by the length of the defect, such as when the defect comprises a crack, scratch, and/or other defects having relatively high aspect ratios (e.g., dust or dust fibers). For example, as shown in FIG. 1B, aerogel 105 comprises defect 110A having a relatively high aspect ratio. The size of defect 110A can be characterized by length L3. The size of defects in the aerogel can be measured in the same manner as the size of imperfections (e.g., blemishes) in flat glass in accordance with ASTM C1036-21.

In some embodiments, defects present in the aerogel, if any, are separated by a relatively large distance. For example, as shown in FIG. 1B, aerogel 105 comprises defect 110A and defect 110B separated by distance D1. In some embodiments, the distance between defects present in the aerogel, if any, is greater than or equal to 50 mm, greater than or equal to 100 mm, greater than or equal to 300 mm, greater than or equal to 600 mm, greater than or equal to 1000 mm, greater than or equal to 1200 mm, or greater than or equal to 1600 mm. In some embodiments, the distance between defects present in the aerogel, if any, is less than or equal to 1600 mm, less than or equal to 1200 mm, less than or equal to 1000 mm, less than or equal to 600 mm, less than or equal to 300 mm, less than or equal to 100 mm, or less than or equal to 50 mm. Combinations of these ranges are possible (e.g., greater than or equal to 1600 mm and less than or equal to 50 mm). Other ranges are also possible. In some embodiments, the distance separating two defects can be determined by measuring the distance between the two closest points of each defect as described in ASTM C1036-21. The distance separating defects in the aerogel can be measured in the same manner as the minimum blemish separation in flat glass in accordance with ASTM C1036-21.

In some embodiments, cracks present in the aerogel, if any, have a relatively small length. In some embodiments, the defects present in the aerogel, if any, comprise cracks having a length less than or equal to 3 mm, less than or equal to 2.5 mm, less than or equal to 2 mm, less than or equal to 1.5 mm, less than or equal to 1 mm, less than or equal to 0.5 mm, less than or equal to 0.25 mm, or less than or equal to 0.1 mm. In some embodiments, the defects present in the aerogel, if any, comprise cracks having a length greater than or equal to 0.1 mm, greater than or equal to 0.25 mm, greater than or equal to 0.5 mm, greater than or equal to 1 mm, greater than or equal to 1.5 mm, greater than or equal to 2 mm, greater than or equal to 2.5 mm, greater than or equal to 3 mm. Combination of these ranges are possible (e.g., less than or equal to 3 mm and greater than or equal to 0.1 mm). Other ranges are also possible.

The aerogels described herein may have one or more properties that are quite uniform; they do not vary across an area or a volume of the aerogel. In some embodiments, the transmittance through the aerogel does not substantially vary across the aerogel. In some embodiments, a relatively low defect or defect-free aerogel has a surface, and a continuous substantially transparent area (e.g., an area having a transmittance, measured perpendicular to the surface and through the aerogel, greater than or equal to 85% at at least one wavelength between 360 nm and 780 nm) of at least 900 cm² (e.g., at least 1000 cm², at least 1500 cm², at least 1800 cm², at least 1900 cm², at least 2000 cm², and/or up to 5000 cm², up to 10000 cm², or up to 50000 cm²) wherein the entire continuous substantially transparent area of the aerogel is defined by a plurality of 1 cm² (or 2 cm², 5 cm², 10 cm², 25 cm², or 50 cm²) geometric areas, and transmittance measured through the aerogel perpendicular to the surface through at least one location within each of the 1 cm² (or 2 cm², 5 cm², 10 cm², 25 cm², or 50 cm²) geometric areas of the continuous substantially transparent area is greater than or equal to 85% (e.g., greater than or equal to 87.5%, greater than or equal to 90%, greater than or equal to 92.5%, greater than or equal to 95%, greater than or equal to 97%, and/or less than or equal to 99%, less than or equal to 99.9%, or less than or equal to 100%) transmittance at at least one wavelength greater than or equal to 360 nm and less than or equal to 780 nm, when measured at an aerogel thickness of at least 0.5 mm (e.g., at least 1 mm, at least 2 mm, at least 3 mm, at least 4 mm, at least 5 mm, at least 6 mm, at least 7 mm, and/or up to 10 mm, up to 20 mm, or up to 50 mm). For example, as shown in FIG. 1C, aerogel 105 has surface 107 with continuous substantially transparent area 115 of aerogel 105 defined by a plurality of geometric areas, in this example, comprising first area 120A, second area 120B, third area 120C, and fourth area 120D (although any number of such areas can be defined according to this description of relative uniformity). In FIG. 1C, the transmittance measured through at least one location within first area 120A, second area 120B, third area 120C, and fourth area 120D of continuous substantially transparent area 115 is greater than or equal to 85% at at least one wavelength greater than or equal to 360 nm and less than or equal to 780 nm. In some embodiments, the transmittance through an aerogel, at any point on a surface having a thickness of at least 0.5 mm (e.g., at least 1 mm, at least 2 mm, at least 3 mm, at least 4 mm, at least 5 mm, at least 6 mm, at least 7 mm, and/or up to 10 mm, up to 20 mm, or up to 30 mm), must be at least 85% (e.g., at least 87.5%, at least 90%, at least 92.5%, at least 95%, at least 97%, and/or up to 99%, up to 99.9%, or up to 100%) at at least one wavelength greater than or equal to 360 nm and less than or equal to 780 nm through at least one location within each of the 1 cm² (or 2 cm², 5 cm², 10 cm², 25 cm², or 50 cm²) geometric areas of the continuous substantially transparent area. In some embodiments, the transmittance through the aerogel may be determined, as described above, by monitoring the transmission of electromagnetic radiation having at least one wavelength greater than or equal to 360 nm and less than or equal to 2000 nm through the aerogel.

In another set of embodiments, the aerogel having a surface with a continuous substantially transparent area of at least 900 cm² (e.g., at least 1000 cm², at least 1500 cm², at least 1800 cm², at least 1900 cm², at least 2000 cm², and/or up to 5000 cm², up to 10000 cm², or up to 50000 cm²) wherein at no location within the entire continuous substantially transparent area is there a 1 cm² (or 2 cm², 5 cm², 10 cm², 25 cm², or 50 cm²) geometric area through which maximum transmittance through the aerogel perpendicular to the surface differs by greater than or equal to 10% (e.g., greater than or equal to 9%, greater than or equal to 8%, greater than or equal to 7%, and/or greater than or equal to 6%) relative to the average of transmittance through all of the 1 cm² geometric areas of the continuous substantially transparent area, all measured at at least one wavelength greater than or equal to 360 nm and less than or equal to 780 nm and measured at a thickness of at least 0.5 mm (e.g., at least 1 mm, at least 2 mm, at least 3 mm, at least 4 mm, at least 5 mm, at least 6 mm, at least 7 mm, and/or up to 10 mm, up to 20 mm, or up to 50 mm). For example, as shown in FIG. 1C, aerogel 105 having surface 107 with continuous substantially transparent area 115 wherein at no location within entire continuous substantially area 115 is there a geometric area among first area 120A, second area 120B, third area 120C, or fourth area 120D, through which maximum transmittance through aerogel 105 perpendicular to surface 107 differs by greater than or equal to 10% relative to the average transmittance through first area 120A, second area 120B, third area 120C, and fourth area 120D of continuous substantially transparent area 115 all measured at at least one wavelength greater than or equal to 360 nm and less than or equal to 780 nm when measured at a thickness of at least 0.5 mm.

In some embodiments, the transmittance measured through the aerogel is measured through at least 5, at least 7, at least 10, at least 20, or at least 30 selected locations within the continuous substantially transparent area, separated from all other selected locations by at least 5 cm, at least 10 cm, at least 15 cm, at least 20 cm, or more.

In another set of embodiments, transmittance measured through the aerogel perpendicular to the surface through at least one location within each of the 1 cm² (or 2 cm², 5 cm², 10 cm², 25 cm², or 50 cm²) geometric areas of the continuous substantially transparent area is greater than or equal to 90% (e.g., greater than or equal to 92.5%, greater than or equal to 95%, and/or greater than or equal to 97.5%) of the average transmittance through the entire continuous substantially transparent area, measured at at least one wavelength greater than or equal to 360 nm and less than or equal to 780 nm, when measured at an aerogel thickness of at least 0.5 mm (e.g., at least 1 mm, at least 2 mm, at least 3 mm, at least 4 mm, at least 5 mm, at least 6 mm, at least 7 mm, and/or up to 10 mm, up to 20 mm, or up to 50 mm).

In another set of embodiments, the characteristics and/or density of defects, and/or transmittance properties through the aerogel, are measured where the entire substantially transparent area is at least 0.5 mm (e.g., at least 1 mm, at least 2 mm, at least 3 mm, at least 4 mm, at least 5 mm, at least 6 mm, at least 7 mm, and/or up to 10 mm, up to 20 mm, or up to 50 mm) thick at all locations.

In another set of embodiments where, as described above, a transmittance characteristic involves at least a certain transmittance percentage at at least one wavelength greater than or equal to 360 nm and less than or equal to 780 nm, and/or a certain percentage when compared to the average transmittance across the entire substantially transparent area of the aerogel, instead, the transmittance property is present at all wavelengths greater than or equal to 360 nm and less than or equal to 780 nm. In some embodiments, the haze of the aerogel can be measured as calculated in accordance with ASTM standard D1003-13 which is hereby incorporated by reference in its entirety for all purposes. In some embodiments, the haze of the aerogel is measured through the shortest pathway through the article (e.g., the aerogel). In some embodiments, the haze of the aerogel may be determined by measuring the haze, in accordance with ASTM standard D1003-13, through the thickness direction of the aerogel wherein the thickness direction of the aerogel is the shortest pathway through the aerogel. For example, as shown in FIG. 1A, aerogel 105 has thickness T1 wherein thickness T1 is the shortest pathway through aerogel 105.

In some embodiments, the aerogel has relatively low haze. Aerogels having relatively low haze may be particularly advantageous in window applications. In some embodiments, the haze of at least a portion of the aerogel is less than or equal to 5%, less than or equal to 4.75%, less than or equal to 4.5%, less than or equal to 4%, less than or equal to 3.5%, less than or equal to 3%, or less than or equal to 2%. In some embodiments, the haze of at least a portion of the aerogel is greater than or equal to 2%, greater than or equal to 3%, greater than or equal to 3.5%, greater than or equal to 4%, greater than or equal to 4.5%, greater than or equal to 4.75%, or greater than or equal to 5%. Combinations of these ranges are possible (e.g., less than or equal to 5% and greater than or equal to 3%). Other ranges are possible. As described elsewhere in this disclosure, the haze of the aerogel can be measured as calculated in accordance with ASTM standard D1003-13.

In some embodiments, the aerogel haze through the aerogel does not substantially vary across the aerogel. In some embodiments, the aerogel has a surface, and a continuous substantially transparent area (e.g., an area having a transmittance, measured perpendicular to the surface and through the aerogel, greater than or equal to 85% at at least one wavelength between 360 nm and 780 nm) of at least 900 cm² (e.g., at least 1000 cm², at least 1500 cm², at least 1800 cm², at least 1900 cm², at least 2000 cm², and/or up to 5000 cm², up to 10000 cm², or up to 50000 cm²) wherein the entire continuous substantially transparent area of the aerogel is defined by a plurality of 1 cm² (or 2 cm², 5 cm², 10 cm², 25 cm², or 50 cm²) geometric areas, and haze measured through the aerogel perpendicular to the surface through at least one location within each of the 1 cm² (or 2 cm², 5 cm², 10 cm², 25 cm², or 50 cm²) geometric areas of the continuous substantially transparent area is less than or equal to 5% (e.g., less than or equal to 4.75%, less than or equal to 4.5%, less than or equal to 4%, less than or equal to 3.5%, less than or equal to 3%, and/or greater than or equal to 0.1%, greater than or equal to 0.25%, or greater than or equal to 0.5%), when measured at an aerogel thickness of at least 0.5 mm (e.g., at least 1 mm, at least 2 mm, at least 3 mm, at least 4 mm, at least 5 mm, at least 6 mm, at least 7 mm, and/or up to 10 mm, up to 20 mm, or up to 50 mm). For example, as shown in FIG. 1C, aerogel 105 comprising silica and having surface 107 with continuous substantially transparent area 115, wherein continuous substantially transparent area 115 of the aerogel is defined by a plurality of geometric areas comprising first area 120A, second area 120B, third area 120C, and fourth area 120D, and haze measured through aerogel 105 perpendicular to surface 107 through at least one location within first area 120A, second area 120B, third area 120C, and fourth area 120D of continuous substantially transparent area 115 is less than or equal to 5% when measured at a thickness of at least 0.5 mm.

In some embodiments, the aerogel comprises a continuous volume of at least 400 cm³ (e.g., at least 500 cm³, at least 600 cm³, at least 700 cm³, at least 800 cm³, at least 900 cm³, at least 1000 cm³, at least 2000 cm³, at least 3000 cm³, at least 4000 cm³, and/or up to 20,000 cm³, up to 50,000 cm³, or up to 100,000 cm³), wherein the entire continuous volume of the aerogel is defined by a plurality of 40 cm³ (or 50 cm³, 75 cm³, 100 cm³, 125 cm³, or 150 cm³) geometric volumes, and thermal conductivity of each of the 40 cm³ (or 50 cm³, 75 cm³, 100 cm³, 125 cm³, or 150 cm³) geometric volumes of the continuous volume is less than or equal to 25 mW/mK (e.g., less than or equal to 20 mW/mk, less than or equal to 15 mW/mk, less than or equal to 10 mW/mk, less than or equal to 5 mW/mk, and/or greater than or equal to 0.1 mW/mK, greater than or equal to 0.2 mW/mK, or greater than or equal to 0.5 mW/mK). For example, as shown in in FIG. 1D, aerogel 105 has a continuous volume 125, where the entire continuous volume 125 of aerogel 105 is defined by first geometric volume 130A, second geometric volume 130B, third geometric volume 130C, and fourth geometric volume 130D, and the thermal conductivity of each of the first, second, third, and fourth geometric volumes is less than or equal to 25 mW/mK (any number of volumes can be defined for purposes of this evaluation/characterization).

In some embodiments, the aerogel comprises a continuous volume of at least 400 cm³ (e.g., at least 500 cm³, at least 600 cm³, at least 700 cm³, at least 800 cm³, at least 900 cm³, at least 1000 cm³, at least 2000 cm³, at least 3000 cm³, at least 4000 cm³, and/or up to 20,000 cm³, up to 50,000 cm³, or up to 100,000 cm³), wherein the entire continuous volume of the aerogel is defined by a plurality of 40 cm³ (or 50 cm³, 75 cm³, 100 cm³, 125 cm³, or 150 cm³) geometric volumes, and the density of each of the 40 cm³ (or 50 cm³, 75 cm³, 100 cm³, 125 cm³, or 150 cm³) geometric volumes of the continuous volume is less than or equal to 350 kg/m3 (e.g., less than or equal to 300 kg/m³, less than or equal to 250 kg/m³, less than or equal to 200 kg/m³, less than or equal to 150 kg/m³, less than or equal to 110 kg/cm³. and/or greater than or equal to 10 kg/m³, greater than or equal to 20 kg/m³, or greater than or equal to 40 kg/m³). For example, as shown in in FIG. 1D, aerogel 100 comprises continuous volume 125, wherein entire continuous volume 125 of aerogel 105 is define by first geometric volume 130A, second geometric volume 130B, third geometric volume 130C, and fourth geometric volume 130D, and the density of each of the first, second, third, and fourth geometric volumes is less than or equal to 350 kg/m³.

In some embodiments, the aerogel comprises a continuous volume of at least 400 cm³ (e.g., at least 500 cm³, at least 600 cm³, at least 700 cm³, at least 800 cm³, at least 900 cm³, at least 1000 cm³, at least 2000 cm³, at least 3000 cm³, at least 4000 cm³, and/or up to 20,000 cm³, up to 50,000 cm³, or up to 100,000 cm³), wherein the entire continuous volume of the aerogel is defined by a plurality of 40 cm³ (or 50 cm³, 75 cm³, 100 cm³, 125 cm³, or 150 cm³) geometric volumes, and the average pore radius of each of the 40 cm³ (or 50 cm³, 75 cm³, 100 cm³, 125 cm³, or 150 cm³) geometric volumes of the continuous volume is less than or equal to 10 nm (e.g., less than or equal to 9 nm, less than or equal to 8 nm, less than or equal to 7 nm, less than or equal to 5 nm, and/or greater than or equal to 0.1 nm, greater than or equal to 0.2 nm, or greater than or equal to 0.5 nm). For example, as shown in in FIG. 1D, aerogel 100 comprises continuous volume 125, wherein entire continuous volume 125 of aerogel 105 is define by first geometric volume 130A, second geometric volume 130B, third geometric volume 130C, and fourth geometric volume 130D, and the average pore radius of each of the first, second, third, and fourth geometric volumes is less than or equal to 10 nm.

The aerogel described herein may have any of a variety of advantageous properties. In some embodiments, the aerogel has a relatively large volume. Aerogels having relatively large volumes may be suited applications where transparent insulation materials are desirable, such as in window applications. It should be understood that the volume of the aerogel refers to the continuous volume of the aerogel (e.g., a monolithic aerogel and/or a monolithic portion of an aerogel) rather than the cumulative volume of the one or more disconnected aerogel portions (e.g., aerogel particulates, fractured aerogel slabs). In some embodiments, the aerogel has a volume greater than or equal to 800 cm³, greater than or equal to 1000 cm³, greater than or equal to 1500 cm³, greater than or equal to 2000 cm³, greater than or equal to 2500 cm³, greater than or equal to 3000 cm³, greater than or equal to 4000 cm³, greater than or equal to 5000 cm³, greater than or equal to 7500 cm³, and/or greater than or equal to 10000 cm³. In some embodiments, the aerogel has a volume less than or equal to 100000 cm³, less than or equal to 50000 cm³, less than or equal to 10000 cm³, less than or equal to 7500 cm³, less than or equal to 5000 cm³, less than or equal to 4000 cm³, less than or equal to 3000 cm³, less than or equal to 2500 cm³, less than or equal to 2000 cm³, less than or equal to 1500 cm³, less than or equal to 1000 cm³, and/or less than or equal to 800 cm³. Combinations of these ranges are also possible (e.g., greater than or equal to 800 cm³ and less than or equal to 100000 cm³). Other ranges are also possible.

In some embodiments, the aerogel has a relatively large geometric surface area. In some embodiments, the aerogel has a geometric surface area of greater than or equal to 1800 cm², greater than or equal to 2000 cm², greater than or equal to 3000 cm², greater than or equal to 5000 cm², greater than or equal to 7500 cm², greater than or equal to 10000 cm², greater than or equal to 20000 cm², or greater than or equal to 50000 cm². In some embodiments, the aerogel has a geometric surface area of less than or equal to 100000 cm², less than or equal to 50000 cm², less than or equal to 20000 cm², less than or equal to 10000 cm², less than or equal to 7500 cm², less than or equal to 5000 cm², less than or equal to 3000 cm², less than or equal to 2000 cm², or less than or equal to 1800 cm². Combinations of these ranges are possible (e.g., greater than or equal to 1800 cm² and less than or equal to 100000 cm². Other ranges are also possible.

In some embodiments, the aerogel has a relatively large maximum transverse dimension. In some embodiments, the aerogel has a maximum transverse dimension greater than or equal to 25 cm, greater than or equal to 50 cm, greater than or equal to 100 cm, greater than or equal to 150 cm, greater than or equal to 200 cm, greater than or equal to 250 cm, greater than or equal to 500 cm, greater than or equal to 1000 cm, greater than or equal to 2000 cm, and/or greater than or equal to 5000 cm. In some embodiments, the aerogel has a maximum transverse dimension less than or equal to 10000 cm, less than or equal to 5000 cm, less than or equal to 2000 cm, less than or equal to 1000 cm, less than or equal to 500 cm, less than or equal to 250 cm, less than or equal to 200 cm, less than or equal to 150 cm, less than or equal to 100 cm, less than or equal to 50 cm, or less than or equal to 25 cm. Combinations of these ranges are also possible (e.g., greater than or equal to 25 cm and less than or equal to 10000 cm). Other ranges are also possible.

In some embodiments, the aerogel has a relatively large volume and/or a surface having a relatively large area calculated by a length, a width, and/or a thickness of the aerogel. For example, as shown in FIG. 1A, aerogel 105 has length L1, width W1, and thickness T1. In FIG. 1A, aerogel 105 has a relatively large volume equivalent to the product of the multiplication of width W1, length L1, and thickness T1. In FIG. 1A, aerogel 105 has surface 107 having a relatively large area equivalent to the production of the multiplication of width W1 and length L1. In some embodiments, the length and/or the width of the aerogel is greater than or equal to 12 in, greater than or equal to 18 in, greater than or equal to 24 in, greater than or equal to 36 in, greater than or equal to 48 in, greater than or equal to 60 in, greater than or equal to 72 in, or greater than or equal to 100 in. In some embodiments, the length and/or the width of the aerogel is less than or equal to 1000 in, less than or equal to 500 in, less than or equal to 250 in, less than or equal to 100 in, less than or equal to 72 in, less than or equal to 60 in, or less than or equal to 48 in. Combinations of these ranges are possible (e.g., greater than or equal to 12 in and less than or equal to 1000 in). Other ranges are possible. It should be understood that the dimensions described above generally refer to dimensions of a monolithic portion of the aerogel rather than the sum of dimensions of two or more portions of aerogel (e.g., aerogel particles). For example, turning once again to FIG. 1A, aerogel 105, being monolithic, has length L1, width W1, and thickness T1.

In some embodiments, the aerogel described herein may have any of a variety of suitable densities. In some embodiments, the aerogel has a density of less than or equal to 350 kg/m³, less than or equal to 300 kg/m³, less than or equal to 250 kg/m³, less than or equal to 200 kg/m³, less than or equal to 150 kg/m³, less than or equal to 100 kg/m³, or less than or equal to 50 kg/m³. In some embodiments, the aerogel has a density of greater than or equal to 50 kg/m³, greater than or equal to 100 kg/m³, greater than or equal to 150 kg/m³, greater than or equal to 200 kg/m³, greater than or equal to 250 kg/m³, greater than or equal to 300 kg/m³, or greater than or equal to 350 kg/m³. Combinations of these ranges are possible (e.g., less than or equal to 350 kg/m³ and greater than or equal to 50 kg/m³). Other ranges are also possible.

In some embodiments, the aerogel has a relatively low thermal conductivity. In some embodiments, the aerogel has a thermal conductivity that is sufficiently low such that the aerogel may serve as a transparent insulation material. In some embodiments, the thermal conductivity of the aerogel is less than or equal to 25 mW/mK, less than or equal to 22.5 mW/mK, less than or equal to 20 mW/mK, less than or equal to 17.5 mW/mK, less than or equal to 15 mW/mK, less than or equal to 10 mW/mK, or less than or equal to 5 mW/mK. In some embodiments, the thermal conductivity of the aerogel is greater than or equal to 0.1 mW/mK, greater than or equal to 1 mW/mK, greater than or equal to 5 mW/mK, greater than or equal to 10 mW/mK, greater than or equal to 15 mW/mK, greater than or equal to 17.5 mW/mK, greater than or equal to 20 mW/mK, greater than or equal to 22.5 mW/mK, or greater than or equal to 25 mW/mK. Combinations of these ranges are possible (e.g., less than or equal to 25 mW/mK and greater than or equal to 0.1 mW/mK). Other ranges are possible.

In some embodiments, the aerogel has a relatively small mean pore radius. Without wishing to be bound by any particular theory, aerogels having a relatively small mean pore radius may be advantageously transparent to light and/or have a surprisingly low thermal conductivity. In some embodiments, the aerogel has a mean pore radius of less than or equal to 10 nm, less than or equal to 8 nm, less than or equal to 6 nm, less than or equal to 5 nm, or less than or equal to 4 nm. In some embodiments, the aerogel has a mean pore radius of greater than or equal to 1 nm, greater than or equal to 2 nm, greater than or equal to 3 nm, greater than or equal to 4 nm, greater than or equal to 5 nm, greater than or equal to 6 nm, greater than or equal to 8 nm, or greater than or equal to 10 nm. Combinations of these ranges are possible (e.g., less than or equal to 10 nm and/or greater than or equal to 1 nm). Other ranges are possible.

In some embodiments, the aerogel has a relatively small mean scattering radius. In some embodiments, the aerogel has a mean scattering radius of less than or equal to 5 nm, less than or equal to 4 nm, less than or equal to 3 nm, less than or equal to 2 nm, or less than or equal to 1 nm. In some embodiments, the aerogel has a mean scattering radius of greater than or equal to 0.1 nm, greater than or equal to 1 nm, greater than or equal to 2 nm, greater than or equal to 3 nm, greater than or equal to 4 nm, or greater than or equal to 5 nm. Combinations of these ranges are possible (e.g., less than or equal to 5 nm and greater than or equal to 0.1 nm). Other ranges are also possible.

In some embodiments, the mean scattering radius and/or the pore size of the aerogel may be measured by using small angle x-ray scattering (SAXS) and/or by Brunauer-Emmett-Teller analysis (BET).

In some embodiments, the aerogel has a relatively low mean particle radius. In some embodiments, the aerogel has a mean particle radius of less than or equal to 2 nm, less than or equal to 1.75 nm, less than or equal to 1.5 nm, less than or equal to 1.25 nm, less than or equal to 1 nm, less than or equal to 0.75 nm, or less than or equal to 0.5 nm. In some embodiments, the aerogel has a mean particle radius of greater than or equal to 0.1 nm, greater than or equal to 0.5 nm, greater than or equal to 0.75 nm, greater than or equal to 1 nm, greater than or equal to 1.25 nm, greater than or equal to 1.5 nm, greater than or equal to 1.75 nm, or greater than or equal to 2 nm. Combinations of these ranges are possible (e.g., less than or equal to 2 nm and greater than or equal to 0.1 nm). Other ranges are also possible.

In some embodiments, the mean particle radius of the aerogel may be measured by using small angle x-ray scattering (SAXS) and/or by Brunauer-Emmett-Teller analysis (BET).

In some embodiments, the aerogel has a relatively high porosity. The relatively high porosity of the aerogel, in some embodiments, may allow the aerogel to have an advantageously low thermal conductivity such that it may serve as a thermal and/or acoustic insulator. In some embodiments, the aerogel has a porosity greater than or equal to 90%, greater than or equal to 92%, greater than or equal to 94%, greater than or equal to 96%, greater than or equal to 98%, or greater than or equal to 99%. In some embodiments, the aerogel has a porosity less than or equal to 99%, less than or equal to 98%, less than or equal to 96%, less than or equal to 94%, less than or equal to 92%, or less than or equal to 90%. Combinations of these ranges are possible (e.g., greater than or equal to 90% and less than or equal to 99%). Other ranges are possible.

In some embodiments, the aerogel has mechanical properties suitable for any of a variety of applications including but not limited to applications related to windows and insulated glass units. The presence of the defects in the aerogel may lead to variation in the mechanical properties of the aerogel. Accordingly, in some embodiments, it may be advantageous to reduce and/or eliminate defects within the aerogel to reduce the variation of mechanical properties within the aerogel. In some embodiments, the Weibull modulus, the flexure strength, and/or the formation of cracks (e.g., the spontaneous formation of cracks) may altered by the presence of defects in the aerogel.

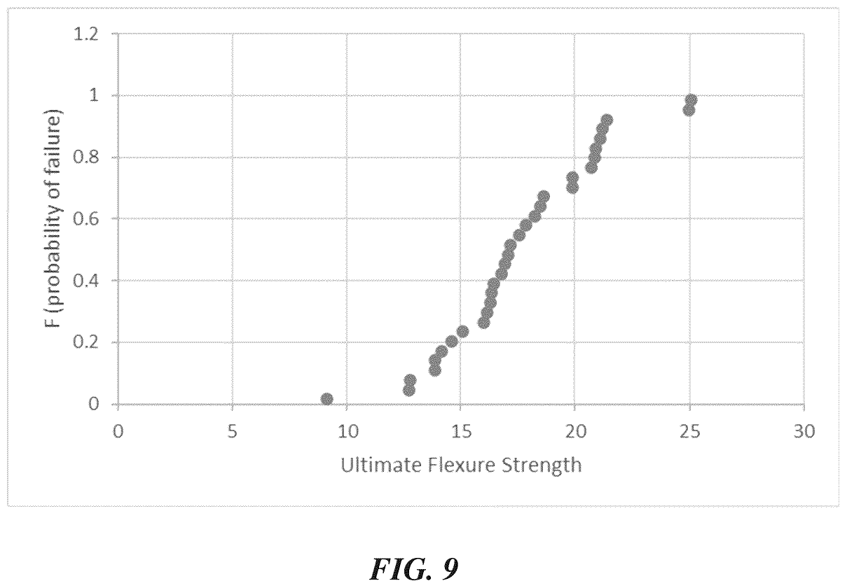

For materials that are typically considered brittle, a broad scattering of the ultimate strength of the material may be observed. This may be due, at least in part, because of the statistical nature of defects (e.g., flaws). Defects are generally randomly distributed throughout a material (e.g., an aerogel) and any given increase in load can cause failure if a defect is in-line with the stress. In FIG. 9, the distribution of ultimate strength is shown versus a probability of failure, P, which is a function of the order of the sample, j, and the sample size, n, as shown in Equation 1.

$${P}_{j} = [ j - 0.5 ] * \frac{1}{N} \qquad Equation 1$$

As an example, if 100 samples comprising the aerogel are evaluated to determine the ultimate strength of each sample, it could assumed that for the whole sheet of material (e.g., the aerogel) the failure stress (e.g., the ultimate strength at failure) of the weakest sample would translate to 1% chance of failure for any given sample, and the failure stress of the strongest sample would translate to a 99% chance of failure for any given sample. Such a probability relates to the Weibull modulus, m, which is generally a shape parameter that characterizes the breadth of the strength distribution (e.g., of the aerogel and/or composites or devices comprising the aerogel). The probability also relates to σ_{c} which is the average strength of the material, as described by Equation 2:

$$P ( σ ) = 1 - {e}^{- {( \frac{σ}{{σ}_{0}} )}^{m}} = {P}_{j} \qquad Equation 2$$

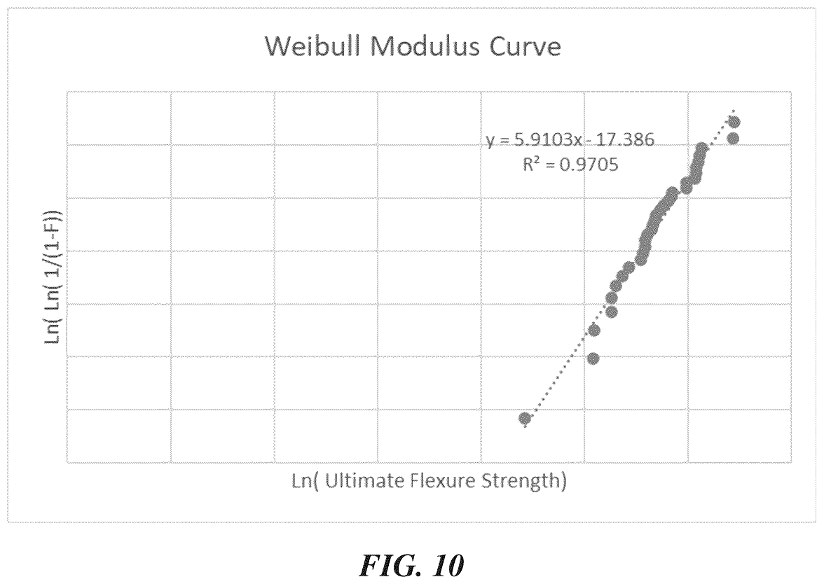

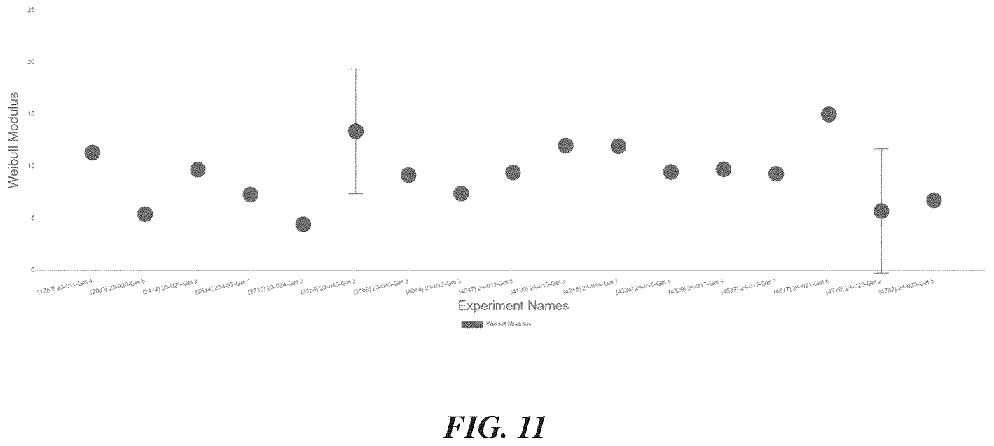

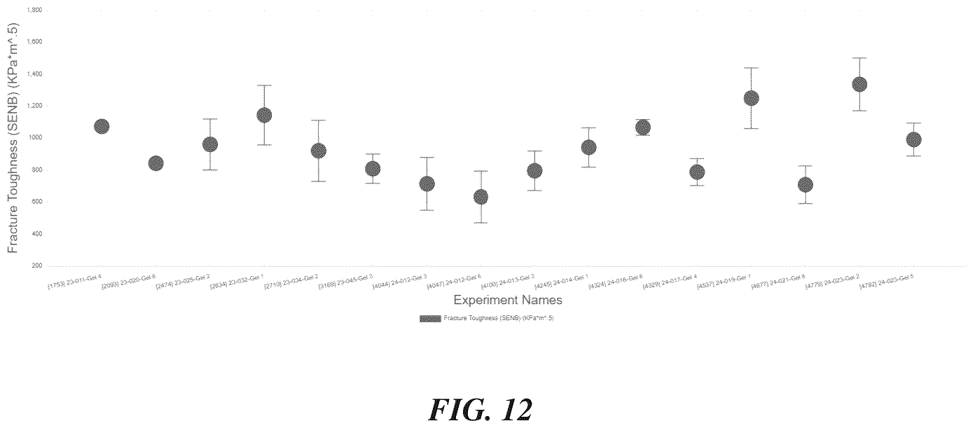

As shown in FIG. 10, Equation 2 can be plotted as a function of ln (ln(P(σ)), and the slope of the resulting curve is equal to m and the intercept is a function of the average strength. A change in the distribution of the defects in the material could alter the scattering of failure that is observed as well as the average value of the material's strength. Additional details regarding the Weibull modulus and ultimate strength of aerogels, as well as the characterization thereof, can be found in “Techniques for Characterizing the Mechanical Properties of Aerogels” by Woignier, T., et al, published Nov. 14, 2019 which is hereby incorporated by reference in its entirety for all purposes. Experimental data describing the Weibull Modulus and the fracture toughness of the aerogels described herein, according to some embodiments, are shown in FIGS. 11-12.

In some embodiments, the fracture toughness of the aerogel may relate to the aerogel's ability to resist crack growth. As shown in Equation 3 below, K is fracture toughness, a_{c} is critical crack size, σ is the stress applied to the material, and Y is a geometric factor based on the sample configuration.

$$K = Y * σ * {( π * a )}^{\frac{1}{2}}$$

Failure occurs at a given strength which provides the K_{c} and a_{c} numbers. When defects, in this case cracks, reach a critical size, the defects may propagate spontaneously and relatively quickly possibly resulting in catastrophic failure of the aerogel. In some cases, cracks may be several centimeters along or, in certain instances, up to the entire length of the aerogel. Cracks may continue to propagate at relatively slow rates due, at least in part, to a variety of factors (e.g., environmental conditions, sub-critical stresses, cyclic loading). By increasing the number of flaws in the system, there is a likelihood that at least one of the cracks will reach this critical threshold and cause catastrophic failure. The following equation (Equation 4) may be used to determine a minimum defect size that may be suitable for the aerogel and/or articles comprising the aerogel as a function of the fracture constants, C₂ and n, and the number of cycles, N. It should be noted this initial crack is typically in the micrometer-scale.

$${a}_{c}^{\frac{2 - n}{2}} - {a}_{i}^{\frac{2 - n}{2}} = \frac{{c}_{2}}{2} {N ( Δ σ )}^{n} {π}^{\frac{n}{2}} ( 2 - n ) \qquad Equation 4$$

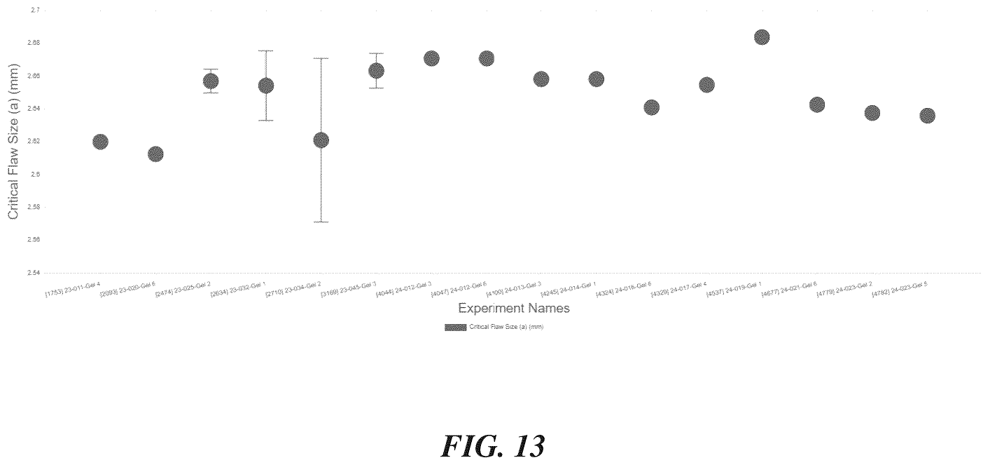

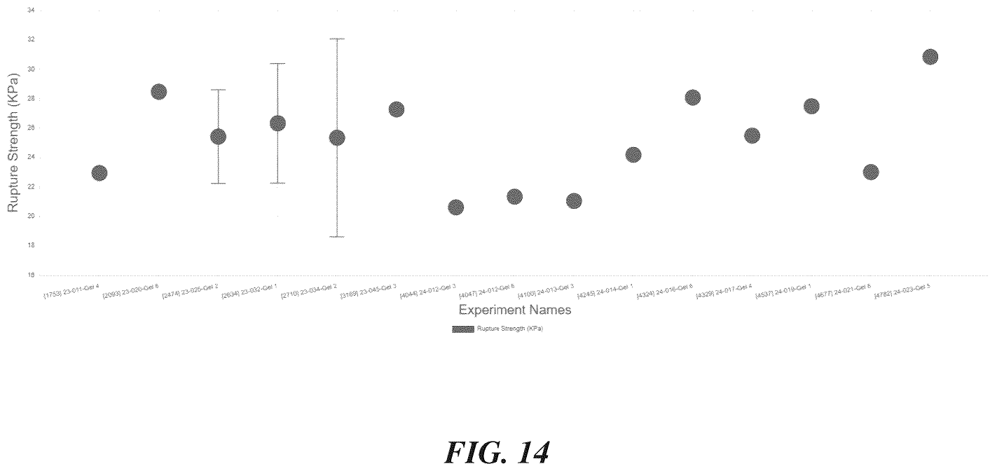

Experimental data describing the critical defect size and the ultimate strength of the aerogels described herein, according to some embodiments, are shown in FIGS. 13-14.

In some embodiments, the aerogel has a relatively suitable Weibull moduli. In some embodiments, the Weibull modulus of the aerogel is greater than or equal to 3, greater than or equal to 6, greater than or equal to 9, greater than or equal to 12, greater than or equal to 15, and/or greater than or equal to 20. In some embodiments, the Weibull modulus of the aerogel is less than or equal to 20, less than or equal to 15, less than or equal to 12, less than or equal to 9, greater than or equal to 6, and/or greater than or equal to 3. Combinations of these ranges are possible (e.g., greater than or equal to 3 and less than or equal to 20). Other ranges are also possible.

In some embodiments, the aerogel has a relatively suitable fracture toughness. In some embodiments, the fracture toughness of the aerogel is greater than or equal to 500 KPa*m^{1/2}, greater than or equal to 500 KPa*m^{1/2}, greater than or equal to 1000 KPa*m^{1/2}, greater than or equal to 1250 KPa*m^{1/2}, and/or greater than or equal to 1500 KPa*m^{1/2}. In some embodiments, the fracture toughness of the aerogel is less than or equal to 1500 KPa*m^{1/2}, less than or equal to 1250 KPa*m^{1/2}, less than or equal to 1000 KPa*m^{1/2}, less than or equal to 750 KPa*m^{1/2}, and/or less than or equal to 500 KPa*m^{1/2}. Combinations of these ranges are possible (e.g., greater than or equal to 500 KPa*m^{1/2} and less than or equal to less than or equal to 1500 KPa*m^{1/2}. Other ranges are also possible.

In some embodiments, the aerogel may have a variety of critical flaw sizes. In some embodiments, the critical flaw size of the aerogel is greater than or equal to 1 mm, greater than or equal to 1.5 mm, greater than or equal to 2 mm, greater than or equal to 2.5 mm, greater than or equal to 3 mm, greater than or equal to 3.5 mm, and/or greater than or equal to 4 mm. In some embodiments, the critical flaw size of the aerogel is less than or equal to 1 mm, less than or equal to 1.5 mm, less than or equal to 2 mm, less than or equal to 2.5 mm, less than or equal to 3 mm, less than or equal to 3.5 mm, and/or less than or equal to 4 mm. Combinations of these ranges are also possible (e.g., greater than or equal to 1 mm and less than or equal to 4 mm). Other ranges are also possible.

In some embodiments, the aerogel may have a relatively suitable ultimate strength. In some embodiments, the aerogel has an ultimate strength greater than or equal to 15 kPa, greater than or equal to 20 kPa, greater than or equal to 25 kPa, greater than or equal to 30 kPa, greater than or equal to 35 kPa, greater than or equal to 40 kPa, greater than or equal to 45 kPa, and/or greater than or equal to 50 kPa. In some embodiments, the aerogel has an ultimate strength less than or equal to 50 kPa, less than or equal to 45 kPa, less than or equal to 40 kPa, less than or equal to 35 kPa, less than or equal to 30 kPa, less than or equal to 25 kPa, less than or equal to 20 kPa, and/or less than or equal to 15 kPa. Combinations of these ranges are possible (e.g., greater than or equal to 15 kPa and less than or equal to 50 kPa). Other ranges are also possible.

In some embodiments, the aerogel comprises silica. In some embodiments, the aerogel comprises at least 10 wt % (e.g., at least 20 wt %, at least 30 wt %, at least 40 wt %, at least 50 wt %, at least 60 wt %, at least 70 wt %, at least 80 wt %, at least 90 wt %, at least 95 wt %) silica. Silica, in some embodiments, comprises silicon dioxide (SiO₂). Aerogel comprising silica may have relatively high transparency, in some cases, which makes desirable for use as a transparent insulator in windows. In some embodiments, the aerogel is a silica aerogel.

In some embodiments, the aerogel comprises one or more additives that may improve one or more properties (e.g., haze, transparency, mechanical properties such as rupture strength, etc.). In some embodiments, the one or more additives comprises particles (e.g., fiber, macroscale particles, microparticles, nanoparticles, etc.) capable of altering one or more properties of the aerogel.

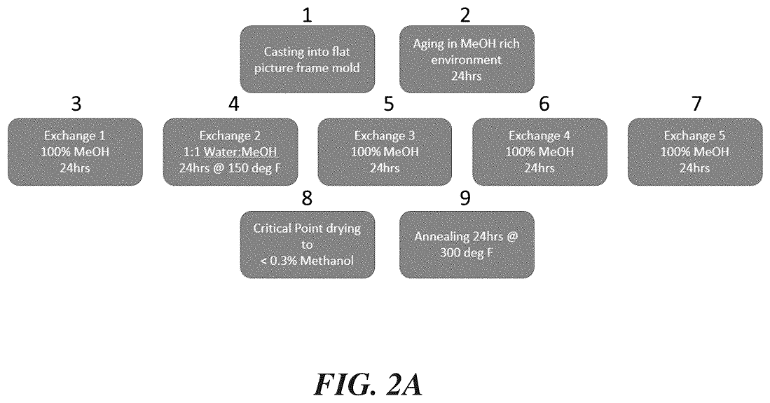

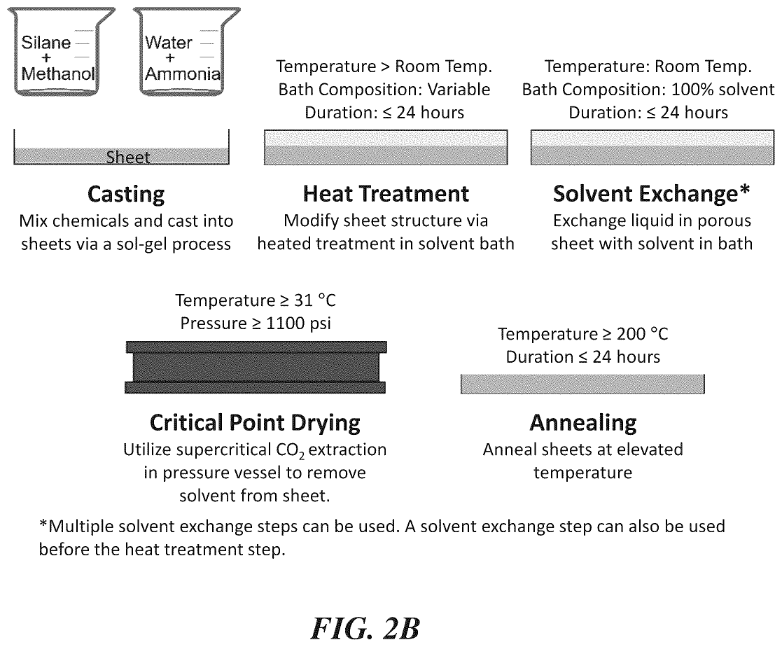

The aerogels described herein may be formed using any of a variety of processes. In some embodiments, the aerogels are formed such that the aerogels have a relatively high transmittance of light (e.g., visible light) and/or relatively high thermal conductivity. In some embodiments, the aerogels are formed using processes that are suitable for commercial scales. That is, the formation process, in certain embodiments, may have a relatively high throughput and/or is capable of producing relatively large aerogels. An example of such process is shown in FIGS. 2A-2B. In some embodiments, a precursor solution comprising a solvent (e.g., methanol) and an aerogel precursor (e.g., tetramethyl orthosilicate) is cast into a mold that may generally shape the aerogel. In some embodiments, the precursor solution comprises ammonium hydroxide. After the aerogel is cast into the mold, it may undergo an aging process that generally allows for at least a portion of the solution to undergo gelation to form a gel. In some embodiments, after gelation, the gel is exposed to one or more solvent exchanges. The gel then undergoes, in certain embodiments, critical point drying following by an annealing process.

In some embodiments, the gel is exposed to one or more solvent exchanges for any of a variety of durations. In some embodiments, aerogel is exposed to one or more solvent exchanges for durations greater than or equal to 1 hour, greater than or equal to 2 hours, greater than or equal to 4 hours, greater than or equal to 6 hours, greater than or equal to 10 hours, greater than or equal to 12 hours, greater than or equal to 24 hours, or greater than or equal to 48 hours. In some embodiments, aerogel is exposed to one or more solvent exchanges for durations less than or equal to 48 hours, less than or equal to 24 hours, less than or equal to 12 hours, less than or equal to 10 hours, less than or equal to 6 hours, less than or equal to 4 hours, less than or equal to 2 hours, or less than or equal to 1 hour. Combinations of these ranges are possible (e.g., greater than or equal to 1 hour and less than or equal to 48 hours). Other ranges are also possible.

In some embodiments, the gel is exposed to one or more solvent exchanges at any of a variety of suitable temperatures. In some embodiments, the gel is exposed to one or more solvent exchanges at ambient temperatures (e.g., the temperature of the environment external to the gel, room temperature, and/or temperatures greater than or equal to 20 degrees Celsius and less than or equal to 25 degrees Celsius). In some embodiments, the gel is exposed to one or more solvent exchanges at elevated temperatures. In some embodiments, the gel is exposed to one or more solvent exchanges at temperatures greater than or equal to 25 degrees Celsius, greater than or equal to 30 degrees Celsius, greater than or equal to 40 degrees Celsius, greater than or equal to 50 degrees Celsius, greater than or equal to 75 degrees Celsius, greater than or equal to 100 degrees Celsius, greater than or equal to 125 degrees Celsius, or greater than or equal to 150 degrees Celsius. In some embodiments, the gel is exposed to one or more solvent exchanges at temperatures less than or equal to 200 degrees Celsius, less than or equal to 175 degrees Celsius, less than or equal to 150 degrees Celsius, less than or equal to 125 degrees Celsius, less than or equal to 100 degrees Celsius, less than or equal to 75 degrees Celsius, less than or equal to 50 degrees Celsius, less than or equal to 40 degrees Celsius, or less than or equal to 30 degrees Celsius. Combinations of these ranges are also possible (e.g., greater than or equal to 30 degrees Celsius and less than or equal to 200 degrees Celsius). Other ranges are also possible.

In some embodiments, the one or more solvent exchanges may be conducted at temperatures that facilitates condensation reactions (e.g., Si—OH+HO-Si→Si—O—Si+H₂O) such that the condensation are driven to completion. Without wishing to be bound by any particular theory, it may advantageous to reduce methoxy and/or hydroxyl groups within the aerogel to improve the stability (e.g., dimensional stability) of the aerogel throughout the fabrication process.

In some embodiments, the gel is exposed to the one or more solvent exchanges at any of a variety of suitable pressures. In some embodiments, the gel is exposed to one or solvent exchanges at pressures less than or equal to 100 PSI, less than or equal to 80 PSI, less than or equal to 60 PSI, less than or equal to 50 PSI, less than or equal to 25 PSI, less than or equal to 10 PSI, or less than or equal to 5 PSI. In some embodiments, the gel is exposed to one or more solvent exchanges at pressures greater than or equal to 1 PSI, greater than or equal to 5 PSI, greater than or equal to 10 PSI, greater than or equal to 25 PSI, greater than or equal to 50 PSI, greater than or equal to 60 PSI, greater than or equal to 80 PSI, or greater than or equal to 100 PSI. Combinations of these ranges are also possible (e.g., less than or equal to 100 PSI and greater than or equal to 1 PSI). Other ranges are also possible.

In some embodiments, the one or more solvent exchanges involve exposing the gel to any of a variety of compositions. In some embodiments, the one or more solvent exchanges comprise exposing the gel to a fluid comprising methanol. In some embodiments, the one or more solvent exchanges comprise exposing the gel to a fluid comprising methanol and/or water. In some embodiments, the one or more solvent exchanges comprise exposing the gel to a fluid comprising methanol, water, and/or ammonium hydroxide. In some embodiments, the one or more solvent exchanges comprise exposing the gel to the presence of water. It should be understood that the one or more solvent exchanges do not have to involve identical conditions. In some embodiments, the solvents in any of the one or more solvent exchanges may vary. Accordingly, in some embodiments, a first solvent exchange may comprise exposing the gel to methanol while a second solvent exchange may comprise exposing the gel to a mixture of methanol and water. Similarly, the first solvent exchange and the second solvent change may involve different conditions (e.g., temperature and/or duration). In some embodiments, a first solvent exchange may involve exposing the gel to a first temperature for a first duration while a second solvent exchange (e.g., a heat treatment) may involve exposing the gel to a second temperature for a second duration. In some embodiments, the second solvent exchange (e.g., the heat treatment, may immediately follow after casting. It should be noted that while the heat treatment generally precedes the one or more solvent exchanges when fabricating the aerogel, the heat treatment itself may be considered a solvent exchange. Accordingly, any of the properties and/or conditions described herein regarding the one or more solvent exchanges may also describe conditions related to the heat treatment.

In some embodiments, the gel undergoes a drying step. In some embodiments, the aerogel undergoes critical point drying such that at least a portion of the solvent is removed from the pores of the gel. In some embodiments, the drying step comprises exposing the gel to supercritical carbon dioxide such that at least a portion of the solvent is removed. The gel, after the solvent is removed, may be referred to an aerogel as the liquid within the pores of the gel is replaced by a gas (e.g., air) or, under certain conditions, a vacuum. In some embodiments, introduction of the defects in the aerogel after the drying step is generally limited. Without wishing to be bound by any particular theory, the dry step typically introduces a large number of defects into aerogels, but using the methods and processes described herein (see Example 1), the introduction of defects into the aerogel, in some embodiments, is at least partially mitigated. In some embodiments, it may be advantageous to implement steps prior to the drying step (e.g., solvent exchanges) in a manner that limits any structural changes to the porous network that may occurs during the drying step. The drying step may alter the structure of the porous network of the aerogel, such as by at least reducing, in size or quantity, pores having relatively large sizes (e.g., pores having maximum dimension greater than 100 nm). However, in some embodiments, such changes can be mitigated by using critical point drying (using carbon dioxide as a solvent) and relatively low temperature and/or ramp rates.

In some embodiments, the gel undergoes an annealing step. In some embodiments, the annealing step comprises exposing the aerogel to a relatively high temperature for a duration of time to facilitate the reduction of the average pore size within the aerogel. In some embodiments, the annealing step allows the aerogel to have a relatively high transparency. Without wishing to be bound by any particular theory, during annealing, the viscosity of particles in the aerogel (e.g., nanoparticles or aggregated nanoparticles) to decrease such that relative movement may be possible. Moreover, the porous network may undergo structural relaxation and/or thermally driven condensation (Si—OH+HO-Si→Si—O—Si+H₂O) thereby changing the size of the particles and pores of the network. A decrease effective scattering size and volume of the gel may result. Additionally, it is possible for aerogel to uptake water (e.g., absorb, adsorb) in an amount of 5 wt % to 15 wt. % water in ambient conditions. Annealing the aerogels, in some embodiments, at relatively high temperatures may drive out water from the aerogel thereby decreasing water absorption and overall density. In some instances, the properties of the aerogel that are related to annealing may be irreversible because OH bonds undergo a condensation reaction to create an Si—O—Si bond. However, in some cases, the aerogel may also continue to uptake water after exiting the high-temperature environment.

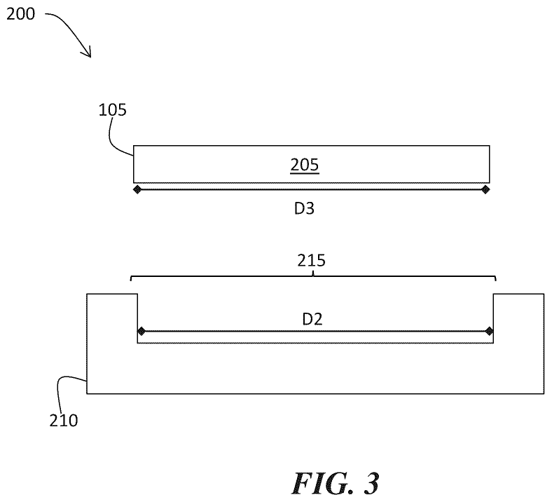

As described previously, aerogels, during typical fabrication processes, may undergo shrinkage. Such shrinkage may, in addition to introducing defects into the aerogel, result in the aerogel having dimensions that have deviated from the desired dimensions, possibly in a manner that may be difficult to predict. Such dimensional deviations may pose challenges when incorporating aerogels in practical applications such as window applications (e.g., in an insulated glass unit (IGU)), and the defects that are introduced may increase the variability of the optical and/or the mechanical properties along a surface of the aerogel or throughout the bulk of the aerogel. Accordingly, it is advantageous to fabricate aerogels that have relatively high dimensional stability through at least a portion of the fabrication process (e.g., from casting through annealing). In some embodiments, the aerogel has relatively high dimensional stability. In some embodiments, an aerogel, including a free-standing portion (or at least a portion thereof) formed in a mold having a mold portion corresponding to the free-standing portion of the article, wherein a first dimension in the mold portion is reproduced in the article (e.g., transferred to the article within a geometric tolerance) as a second dimension with less than or equal to 10% (e.g., less than or equal to 9%, less than or equal to 8%, less than or equal to 7%, less than or equal to 6%, and/or less than or equal to 5%) geometric deviation from the first dimension. For example, as shown in FIG. 3, article 200 comprises aerogel 105, including free-standing portion 205 formed in mold 210 having mold portion 215 corresponding to free-standing portion 205 of aerogel 105, wherein first dimension D2 in mold portion 215 is reproduced in aerogel 105 as second dimension D3 with substantially no deviation from first dimension D2. It should be understood that the second dimension, as described above, may be any dimension that can be obtained throughout the formation of the aerogel. Accordingly, in some embodiments, the second dimension may be the dimension of the gel after one or more solvent exchanges. In certain embodiments, the second dimension may be the dimension of the aerogel after critical point drying. In some embodiments, the second dimension in the final dimension of the aerogel (e.g., prior to incorporation into an insulated glass unit and/or window retrofit).

The aerogel described in the present disclosure may be desirable in any of a variety of devices. In some embodiments, the aerogel is a transparent insulation layer. That is, in some embodiments, the aerogel may serve as a form of transparent insulation for various applications including but not limited to windows. As an example, the aerogel may be positioned onto a window (e.g., a window prior to installation in a structure and/or after installation in a structure) to provide thermal and/or acoustic insulation to the window such that the window remains at least partially transparent to visible light.

In some embodiments, the aerogel is proximate and/or adjacent to a first layer. In some embodiments, the first layer comprises a transparent material (e.g., glass and/or a transparent polymer such as acrylic). In some embodiments, the aerogel is bonded to the first layer to form an insulated first layer such that the insulated first layer is substantially transparent (e.g., has a transmission of at least 50%, at least 75%, at least 90%, at least 95%, or at least 99%) at at least one wavelength between 360 nm and 780 nm. The insulated layer may be applied to (e.g., bonded, mounted, or otherwise proximate to) a second layer (e.g., a freestanding window and/or a window installed on a structure) such that the second layer has greater thermal and/or acoustic insulative properties compared to an otherwise identical second layer not proximate to the insulated layer.

In some embodiments, the aerogel may serve as an insulated layer in an insulated glass unit (IGU). The aerogel, having a relatively large area and relatively low defects, may serve as an insulation material in IGUs as it does not compromise the visible transmission of the IGU while providing thermal and/or acoustic insulation to the IGU. In some embodiments, the IGU comprises the aerogel positioned between a first layer and a second layer such that a gap exists between the aerogel and the first layer and/or the aerogel and the second layer. In some embodiments, the gap between the aerogel and the first and/or second layer is not present. In some embodiments, the insulated glass unit has advantageous insulative properties (e.g., thermal and/or acoustic) and relatively high transmission of visible light.

In some embodiments, the aerogel serves as a transparent insulation material in a solar thermal receiver. Solar thermal receivers, in some embodiments, generally receive solar radiation and transfer heat generated by the solar radiation in a useful manner (e.g., via steam and/or heated fluids). In some embodiments, incoming solar radiation (e.g., visible and/or infrared electromagnetic radiation) is transmitted through the aerogel such that a black body absorber proximate to the aerogel absorbs at least a portion of the solar radiation transmitted through the aerogel in the form of heat. The heat stored within the black body absorber, in some embodiments, is insulated by the aerogel such that a relatively low amount of heat stored within the black body absorber is released through the aerogel.

As described above, the aerogel may have any of a variety of properties, and such properties may have limited variation across the aerogel. In some embodiments, the thickness of a monolithic aerogel may have limited variation across the monolith. For example, in some embodiments, a 10 square foot aerogel sheet may have an average thickness of 5.04 mm with a standard deviation of 0.4 mm. In such aerogels, the average thickness may be determined by measuring the thickness of select 2 inch by 2 inch regions of the aerogel and averaging the resulting measurements.

In some embodiments, the density of a monolithic aerogel may have limited variation across the monolith. For example, in some embodiments, a 10 square foot aerogel sheet may have an average density of 106.9 g/L and a standard deviation of 3.8 g/L. In such aerogels, the average density may be determined by obtaining the mass of select 2 inch by 2 inch regions of the aerogel, determining the volume of the regions, dividing the respective masses by the respective volumes, and averaging the resulting quotients.

In some embodiments, the thermal conductivity of a monolithic aerogel may have limited variation across the monolith. For example, in some embodiments, a 10 square foot aerogel sheet may have an average thermal conductivity of 13.3 W/m²-K and a standard deviation of 0.64 W/m²-L. In such aerogels, the average thermal conductivity may be determined using a calibrated hot plate method. For example, one of several 4 inch by 4 inch regions of the aerogel, each having a known thickness, may be placed on a hot plate with a reference material, having a known thermal conductivity and disposed on top of the aerogel sample. The hot plate may then be turned on to a setpoint of 40 degrees Celsius, and a container of ice may be placed on the reference material. Thermocouples may be used to monitor the temperature of the container of ice, the reference material, the aerogel, and the hotplate. The thermal conductivity of the sample may then be calculated using Equation 6 shown below, where T₁ is the temperature at the interface of the hotplate and the aerogel sample, T₂ is the temperature at the interface between the aerogel and the reference material, T₃ is the temperature at the interface of the reference material and the container of ice, T₄ is the temperature of the container of ice, k₁ is the thermal conductivity of the aerogel sample, k₂ is the thermal conductivity of the reference material, t₁ is the thickness of the aerogel sample, and t₂ is the thickness of the reference material.

$${k}_{1} = \frac{{k}_{2} ( {T}_{2} - {T}_{3} )}{{T}_{1} - {T}_{2}} * \frac{{t}_{1}}{{t}_{2}} \qquad Equation 6$$

The above measurement can be carried out for each aerogel sample and can then be averaged accordingly.

In some embodiments, the visible transmittance of a monolithic aerogel coupled to a substrate may have limited variation across the monolith. For example, in some embodiments, a 10 square foot aerogel sheet may have an average visible transmittance of 88.74% and a standard deviation of 0.3%. In such aerogels, the average visible transmittance may be determined by measuring the visible transmittance of select 2 inch by 2 inch regions of the aerogel using a UV Vis spectrophotometer.

In some embodiments, haze of the monolithic aerogel coupled to a substrate is advantageously low and may have limited variation across the monolith. For example, in some embodiments, a 10 square foot aerogel sheet (e.g., or an aerogel sheet coupled to a substrate) may have an average haze of 3.8% and a standard deviation of 1.58%. As described above, haze of aerogels and/or samples thereof may be measured in accordance with ASTM standard D1003-13 or using a UV Vis spectrophotometer.

In some embodiments, ΔE_{ab}*, of an article comprising monolithic aerogel coupled to a substrate, as described below, may have limited variation across the article. For example, the article, having a 10 square foot area, may have an average ΔE_{ab}*, of 1.33 and a standard deviation of 0.26. The average ΔE_{ab}*, of an article may be determined by measuring the ΔE_{ab}*, of select 2 inch by 2 inch regions of the article using a UV Vis spectrophotometer.

In some embodiments, the solar heat gain coefficient (SHGC) of articles, such as monolithic aerogel, an aerogel coupled to a substrate, and/or an insulated unit, as described below, has limited variation across the article. For example, in some embodiments, the articles, having a 10 square foot area, may have an average SHGC of 0.735 and a standard deviation of 0.006. In some embodiments, an insulated unit, having a 4 mm thick aerogel positioned between a first 3 mm transparent substrate having a low-emissivity coating layer thereon (e.g., 270 Low-E manufactured by Cardinal Glass) and a second 3 mm transparent substrate, may have an SHGC of 0.418. In some embodiments, an insulated unit, having a 4 mm thick aerogel positioned between a first 3 mm transparent substrate and a second 3 mm transparent substrate, may have an SHGC of 0.730. In some embodiments, an insulated unit, having a 4 mm thick aerogel positioned between a first transparent substrate (e.g., Energy Advantage manufactured by Pilkington) and a second transparent substrate having a thickness of 3 mm, may have an SHGC of 0.689. In some embodiments, an insulated unit, having a first transparent substrate having a thickness of 3 mm, a 4 mm thick aerogel, and a second transparent substrate of Cardinal 270 glass, may have an SHGC of 0.414. In such embodiments, the insulated unit may have a gap of 8 mm filled with krypton gas. More information about insulated units can be found below. The average SHGC of articles may be determined by measuring select 47 mm by 91 mm regions of the articles using a LS182 Spectrum Transmission Meter when operated in accordance with Spectrum Transmission Meter Model: LS182 User Manual V6.13.

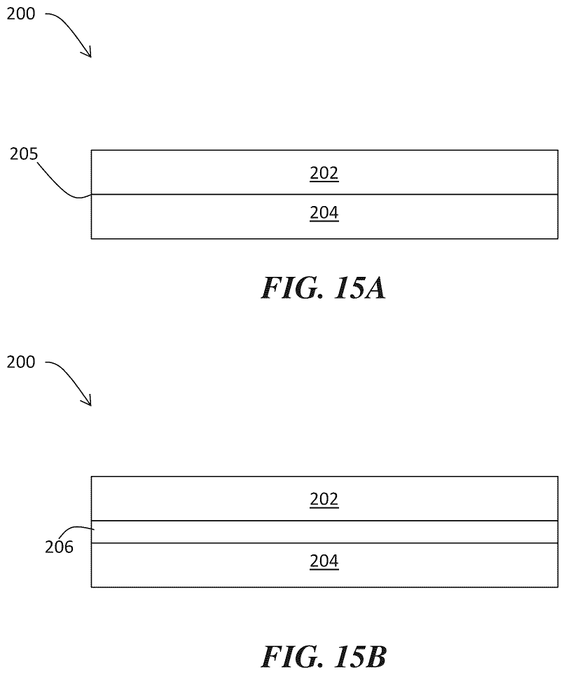

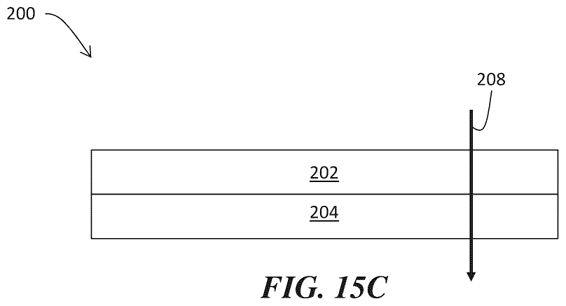

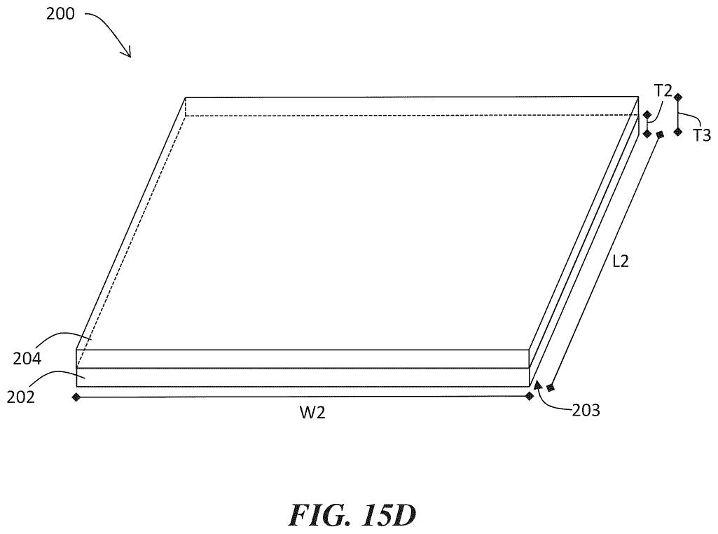

Aerogels and substrates coupled to aerogels are generally described. In one set of embodiments, a first layer comprising an aerogel is disposed on a second layer comprising a substrate. As used herein, when a layer is referred to as being “on” or “disposed on” another layer, it can be directly disposed on the layer, or one or more intervening layers also may be present. A layer that is “directly on” or “directly disposed on” another layer is positioned with respect to the layer such that no intervening layer is present. For example, as shown in FIG. 15A, article 200 comprises aerogel 202 directly disposed on substrate 204 without any intervening layers. In certain embodiments, the aerogel is disposed on the substrate such that an intervening layer is present between the aerogel and the substrate. For example, as shown in FIG. 15B, aerogel 202 is disposed on substrate 204 such that intervening layer 206 is between aerogel 202 and substrate 204. The intervening layer may be an adhesive layer, in accordance with some embodiments.

In some embodiments, the first layer comprising the aerogel is coupled to the second layer comprising the substrate. For example, again turning to FIG. 15A, aerogel 202 is disposed on and coupled to substrate 204. An aerogel may be considered coupled to the substrate when the aerogel is physically and/or chemically joined to the substrate such that application of force to the aerogel and/or the substrate may be needed to separate the aerogel from the substrate. Accordingly, in some instances, an aerogel that is coupled to a substrate may be considered to be bonded, adhered, affixed, immobilized, joined, stuck, laminated, attached, and/or interlinked to the substrate. It should be noted that, while in some embodiments the aerogel is coupled to the substrate, an adhesive (e.g., a glue, adhesive promoter, or other compound) is not necessarily present between the aerogel and the substrate. In some embodiments, the aerogel and the substrate may be coupled without the use of an adhesive. However, in other embodiments, an adhesive may be used to couple the aerogel to the substrate. Accordingly, while in some embodiments, the aerogel and the substrate are coupled together using secondary bonds and/or via physical means, in certain embodiments, the aerogel is coupled to the substrate via primary bonds such covalent bonds.

Any of a variety of adhesives may be used to couple the aerogel to the substrate. In some embodiments, liquid adhesives, solid adhesives, functional coatings, thermosets, and/or thermoplastic compounds may be used to couple the aerogel to the substrate. In some embodiments, the adhesive is an optically clear adhesive (OCA) such as OCA 8211 and/or OCA 8213. In some embodiments, the adhesive comprises polyvinyl butyral and/or ethylene-vinyl acetate. In some embodiments, the adhesive comprises a bifunctional organosilane such as Evonik Dynasylan Hydrosil 1151, Evonik Dynasylan Silbond H5, Evonik Dynasylan VPS 4721, and/or Evonik Dynasylan VPS SIVO 180. Other bifunctional organosilanes may also be used. In some embodiments, methoxy groups of the bifunctional organosilane may react (e.g., hydrolyze) with water and/or residual water to form reactive silanol groups that are capable of coupling (e.g., chemically bonding) the aerogel to glass. Accordingly, in some embodiments, additional compounds, such as water, may also be disposed on the aerogel and/or the substrate to facilitate the coupling between the aerogel and the substrate using an intervening adhesive layer. In some embodiments, the adhesive does not significantly increase the haze and/or decrease the transmittance through the substrate and the aerogel but does increase the bonding strength between the substrate and the aerogel.

In some embodiments, a mixture comprising the adhesive is applied to the substrate and/or the aerogel. In some embodiments, the mixture comprises the adhesive, water, and/or a solvent. In some embodiments, the solvent may dilute the mixture such that the adhesive is present within the mixture at a relatively low concentration. The solvent may serve as a medium for deposition of the adhesive. Accordingly, the amount of adhesive applied to the substrate and/or the aerogel may be at least partially controlled by the amount of the mixture that is deposited. After deposition of the mixture on the substrate and/or the aerogel, the solvent may evaporate leaving behind a relatively thin layer of the adhesive (e.g., the adhesive promoter) on the substrate and/or the aerogel. In some embodiments, the solvent is volatile. In some embodiments, the solvent comprises methanol, isopropyl alcohol, ethanol and/or combinations thereof. Other solvents may also be used.

In some embodiments, the mixture comprises a relatively large amount of solvent. In some embodiments, the mixture comprises at least 75 parts by weight of solvent, at least 80 parts by weight of solvent, at least 85 parts by weight of solvent, at least 90 parts by weight of solvent, at least 95 parts by weight of solvent, and/or at least 99 parts by weight of solvent. In some embodiments, the mixture comprises less than or equal to 99 parts by weight of solvent, less than or equal to 95 parts by weight of solvent, less than or equal to 90 parts by weight of solvent, less than or equal to 85 parts by weight of solvent, less than or equal to 80 parts by weight of solvent, less than or equal to 75 parts by weight of solvent. Combinations of these ranges are also possible (e.g., greater than or equal to 75 parts by weight and less than or equal to 99 parts by weight of solvent). Other ranges are also possible.

In some embodiments, the mixture comprises water. In some embodiments, the mixture comprises greater than or equal to 0.1 parts by weight of water, greater than or equal to 2.5 parts by weight of water, greater than or equal to 5 parts by weight of water, greater than or equal to 7.5 parts by weight of water, greater than or equal to 10 parts by weight of water, and/or greater than or equal to 15 parts by weight of water. In some embodiments, the mixture comprises less than or equal to 15 parts by weight of water, less than or equal to 10 parts by weight of water, less than or equal to 7.5 parts by weight of water, less than or equal to 5 parts by weight of water, less than or equal to 2.5 parts by weight of water, and/or less than or equal to 0.1 parts by weight of water. Combinations of these ranges are also possible (e.g., greater than 0.1 parts by weight of water and less than or equal to 15 parts by weight of water). Other ranges are also possible.

In some embodiments, as described above, the concentration of the adhesive in the mixture is relatively low. In some embodiments, the mixture comprises greater than or equal to 0.1 parts by weight of adhesive, greater than or equal to 0.5 parts by weight of adhesive, greater than or equal to 1 parts by weight of adhesive, greater than or equal to 1.5 parts by weight of adhesive, greater than or equal to 2 parts by weight of adhesive, greater than or equal to 2.5 parts by weight of adhesive, and/or greater than or equal to 5 parts by weight of adhesive. In some embodiments, the mixture comprises less than or equal to 5 parts by weight of adhesive, less than or equal to 2.5 parts by weight of adhesive, less than or equal to 2 parts by weight of adhesive, less than or equal to 1.5 parts by weight of adhesive, less than or equal to 1 parts by weight of adhesive, less than or equal to 0.5 parts by weight of adhesive, and/or less than or equal to 0.1 parts by weight of adhesive. Combinations of these ranges are possible (e.g., greater than or equal to 0.1 parts by weight of adhesive and less than or equal to 5 parts by weight of adhesive). Other ranges are also possible.

In some embodiments, the adhesive is not visually detectable. However, the presence of the adhesive between the aerogel and the substrate may, in some embodiments, be detectable via other characterization regimes (e.g., characterization regimes configured evaluate compositions of a material). The adhesive may be applied to the aerogel and/or to the substrate in any of a variety of suitable methods. In some embodiments, the adhesive may be applied using spray deposition. In some embodiments, spray deposition involves atomizing the adhesive such that the adhesive may be applied substantially uniformly (e.g., in thickness and/or coverage) on the substrate and/or aerogel. In some cases, the mixture comprising the adhesive is applied to the substrate and/or the aerogel via spray deposition. In some embodiments, the adhesive is applied to the aerogel and/or the substrate using other deposition techniques known in the art, including but not limited to blade coating, bar coating, and/or drop coating.

In some embodiments, the adhesive may be cured via exposure to heat. In some embodiments, the adhesive is cured at a temperature greater than or equal to 100 degrees Celsius, greater than or equal to 120 degrees Celsius, greater than or equal to 140 degrees Celsius, greater than or equal to 160 degrees Celsius, greater than or equal to 180 degrees Celsius, greater than or equal to 200 degrees Celsius, greater than or equal to 220 degrees Celsius, greater than or equal to 240 degrees Celsius, and/or greater than or equal to 260 degrees Celsius. In some embodiments, the adhesive is cured at a temperature less than or equal to 260 degrees Celsius, less than or equal to 240 degrees Celsius, less than or equal to 220 degrees Celsius, less than or equal to 200 degrees Celsius, less than or equal to 180 degrees Celsius, less than or equal to 160 degrees Celsius, less than or equal to 140 degrees Celsius, less than or equal to 120 degrees Celsius, and/or less than or equal to 100 degrees Celsius. Combinations of these ranges are possible (e.g., greater than or equal to 100 degrees Celsius and less than or equal to 240 degrees Celsius). Other ranges are also possible.

In some embodiments, as described above, an adhesive is not present between the aerogel and the substrate. In some embodiments, the aerogel and/or the substrate may be treated (e.g., cleaned and/or chemically functionalized) such that, when the aerogel is disposed on the substrate, the aerogel is coupled to the substrate. For example, in some embodiments, the substrate is cleaned with a solvent, such as isopropyl alcohol, so that the affinity between the aerogel and the substrate when disposed on the aerogel, is sufficient to couple the substrate to the aerogel.

In some embodiments, the aerogel is coupled to the substrate using any of the methods and/or materials described herein to form an article such as a composite. In some embodiments, the composite comprises the aerogel and the substrate, and may be used to create a insulated glass unit (e.g., by disposing the composite onto a third layer comprising glass or another substantially transparent material). The composite, in some embodiments, may be capable of retrofitting existing single-pane or multi-pane windows by disposing the composite onto the single and/or multi-pane windows. The existing windows after retrofitted with the composite may therefore have improved thermal and/or acoustic insulation properties.

In some embodiments, the article has a relatively low haze that is suitable for window applications. Articles comprising aerogels and having relatively low haze may be particularly advantageous in window applications. In some embodiments, the haze along an electromagnetic radiation pathway traversing at least a portion of the aerogel and the substrate is relatively low.

In some embodiments, the electromagnetic radiation pathway may be a path for the transmission of electromagnetic radiation through at least a portion of the aerogel and at least a portion of the substrate. In some embodiments, the electromagnetic radiation pathway is orthogonal to one or more surfaces of the aerogel and/or the substrate. For example, as shown in FIG. 15C, electromagnetic radiation pathway 208 traverses a portion of aerogel 202 and substrate 204.

Accordingly, the haze of article 200 along electromagnetic radiation pathway 208 may be relatively low. In some embodiments, the electromagnetic radiation pathway is parallel to the thickness direction of the aerogel. For example, as shown in FIGS. 15C-15D, electromagnetic radiation pathway 208 is parallel to thickness T2 of aerogel 202. In some embodiments, the haze along the electromagnetic radiation pathway is less than or equal to 15%, less than or equal to 12.5%, less than or equal to 10%, less than or equal to 9%, less than or equal to 8%, less than or equal to 7%, less than or equal to 6%, less than or equal to 5%, less than or equal to 4%, less than or equal to 3%, less than or equal to 2%, and/or less than or equal to 1%. In some embodiments, the haze along the electromagnetic radiation pathway is greater than or equal to 1%, greater than or equal to 2%, greater than or equal to 3%, greater than or equal to 4%, greater than or equal to 5%, greater than or equal to 6%, greater than or equal to 7%, greater than or equal to 8%, greater than or equal to 9%, greater than or equal to 10%, greater than or equal to 12.5%, and/or greater than or equal to 15%. Combinations of these ranges are possible (e.g., less than or equal to 15% and greater than or equal to 1%). Other ranges are also possible. In some embodiments, the haze of the aerogel can be measured as calculated in accordance with ASTM standard D1003-13 which is hereby incorporated by reference in its entirety for all purposes. In some embodiments, the haze of the article is measured through the shortest pathway through the article (e.g., the aerogel and the substrate). In some embodiments, the haze of the article may be determined by measuring the haze, in accordance with ASTM standard D1003-13, through the thickness direction of the article wherein the thickness direction of the aerogel is the shortest pathway through the article. For example, as shown in FIG. 15D, article 200 has thickness T3 wherein thickness T3 is the shortest pathway through article 200. Accordingly, in some embodiments, the shortest pathway through the article may also be an electromagnetic radiation pathway.

In some embodiments, the article has a relatively high transmittance. In some embodiments, the article has a transmittance greater than or equal to 50%, greater than or equal to 55%, greater than or equal to 60%, greater than or equal to 65%, greater than or equal to 70%, greater than or equal to 75%, greater than or equal to 80%, greater than or equal to 85%, greater than or equal to 90%, and/or greater than or equal to 95% at at least one wavelength greater than or equal to 360 nm and less than or equal to 780 nm. In some embodiments, the article has a transmittance less than or equal to 95%, less than or equal to 90%, less than or equal to 85%, less than or equal to 80%, less than or equal to 75%, less than or equal to 70%, less than or equal to 65%, less than or equal to 60%, less than or equal to 55%, and/or less than or equal to 50% at at least one wavelength greater than or equal to 360 nm and less than or equal to 780 nm. Combinations of these ranges are possible (e.g., greater than or equal to 50% and less than or equal to 95%). Other ranges are also possible.

In some embodiments, the ultimate shear strength between the aerogel and the substrate is relatively high. A relatively high ultimate shear strength may be advantageous for window applications as it may allow the article (e.g., the composite comprising the aerogel and the substrate) to withstand and maintain its performance through harsh conditions. For example, windows, especially those integrated into doors or other movable structures, may undergo high loads when being moved, closed, or slammed during use. Moreover, windows, such as those exposed to environment external to buildings (e.g., residential or commercial buildings), may be subjected to high forces from weather events, including wind or impacts from debris. Accordingly, a relatively high ultimate shear strength between the aerogel and the substrate may allow for the article withstand such environments with no substantial decoupling between the aerogel and the substrate. In some embodiments, the ultimate shear strength between the aerogel and the substrate is greater than or equal to 0.1 kPa, greater than or equal to 0.5 kPa, greater than or equal to 1 kPa, greater than or equal to 2 kPa, greater than or equal to 5 kPa, greater than or equal to 10 kPa, greater than or equal to 15 kPa, greater than or equal to 20 kPa, greater than or equal to 30 kPa, greater than or equal to 40 kPa, greater than or equal to 50 kPa, greater than or equal to 100 kPa, and/or greater than or equal to 500 kPa. In some embodiments, the ultimate shear strength between the aerogel and the substrate is less than or equal to 500 kPa, less than or equal to 100 kPa, less than or equal to 50 kPa, less than or equal to 40 kPa, less than or equal to 30 kPa, less than or equal to 20 kPa, less than or equal to 15 kPa, less than or equal to 10 kPa, less than or equal to 5 kPa, less than or equal to 2 kPa, less than or equal to 1 kPa, less than or equal to 0.5 kPa, and/or less than or equal to 0.1 kPa. Combinations of these ranges are possible (e.g., greater than or equal to 0.1 kPa and less than or equal to 50 kPa). Other ranges are also possible.

In some embodiments, the article comprising the aerogel coupled to the substrate has a relatively high durability. As described above, it may be advantageous for the article with withstand harsh conditions, and in some cases, it may be desirable to withstand such conditions for relatively large numbers of cycles (e.g., opening and closing of a door/window or impacts). The durability of the article may be characterized in accordance with the WDMA TM-7 testing standard, which is incorporated herein by reference in its entirety for all purposes. In some embodiments, the article does not exhibit a greater number of cracks or other defects after exposure to such conditions described in the above testing standard. In some embodiments, the article is capable of undergoing greater than or equal to 1,000 cycles, greater than or equal to 5,000 cycles, greater than or equal to 10,000 cycles, greater than or equal to 15,000 cycles, greater than or equal to 20,000 cycles, and/or greater than or equal to 25,000 cycles, in accordance with the WDMA TM-7 testing standard without exhibiting a greater number of cracks than the number of cracks present in the article prior to the cycling. In some embodiments, the article is capable of undergoing less than or equal to 25,000 cycles, less than or equal to 20,000 cycles, less than or equal to 15,000 cycles, less than or equal to 10,000 cycles, less than or equal to 5,000 cycles, and/or less than or equal to 1,000 cycles, in accordance with the WDMA TM-7 testing standard without exhibiting a greater number of cracks than the number of cracks present in the article prior to the cycling. Other ranges are also possible. In some embodiments, each cycle comprises a closing phase where at least 200 g is exerted on at least a portion of the article (e.g., via closing of a structure such as a door or window) and a reset phase where the article is repositioned in preparation for a subsequent closing phase.

In some embodiments, the article is capable of undergoing greater than or equal to 25,000 slams at 200 g per slam, in accordance with the WDMA TM-7 testing standard, without exhibiting a greater number of delamination regions than the number of delamination regions present in the article prior to the 25,000 slams. In some embodiments, the delamination region is an area between the aerogel and the substrate that does not couple the aerogel to the substrate. Such an area may be present at the interface between the aerogel and the substrate. For example, as shown in FIG. 15A, interface 205 is present between aerogel 202 and substrate 204. The delamination region may exist at and/or within that interface. In some embodiments, the delamination region may be present on a surface of the adhesive layer most proximate to the substrate and/or most proximate to the aerogel.

The article, when included in an insulated glass unit, may provide advantageous thermal insulation and/or sound insulation without significantly compromising the optical clarity associated with the insulated glass unit. In some cases, the substrate may having any of a variety of coatings, such as a low emissivity coating, that may alter the transmittance through the substrate. The transmittance of the article, despite having an aerogel having a higher optical transmittance, may be predominantly affected by the transmittance of the substrate. Accordingly, the aerogel may have sufficient optical properties, such has a relatively low haze and/or a relatively high optical transmittance, such that, when incorporated into the article, the optical properties of the article are not significantly impacted by the presence of the aerogel. In some embodiments, an essentially identical article, absent the aerogel, has a haze within (e.g., differing by less than or equal to) at least 5%, within at least 10%, within at least 15%, within at least 20%, and/or within at least 25% of the haze of the article. In some embodiments, an essentially identical article, absent the aerogel, has a transmittance within at least 20%, within at least 25%, within at least 30%, within at least 35%, within at least 40%, and/or within at least 50% of the transmittance along the electromagnetic radiation pathway of the article at at least one wavelength greater than or equal to 360 nm and less than or equal to 780 nm.

In some embodiments, the color through at least a portion of the substrate does not substantially change after coupling of the aerogel to the substrate. In some embodiments, color of the article, the aerogel, and/or the substrate may be quantified using the total color difference, ΔE_{ab}*, Equation 5:

$$Δ {E}_{ab}^{*} = \sqrt{( {( {L}_{2}^{*} - {L}_{1}^{*} )}^{2} + {( {a}_{2}^{*} - {a}_{1}^{*} )}^{2} + {( {b}_{2}^{*} - {b}_{1}^{*} )}^{2} )} \qquad Equation 5$$

where a₁* and a₂* represents, respectively, redness-greyness of the color of the article before and after the coupling of the aerogel to the substrate, b₁* and b₂* represents, respectively, yellow-blueness of the color of the article before and after the coupling of the aerogel to the substrate, and L₁* and L₂* represents, respectively, lightness of the article before and after the coupling of the aerogel to the substrate, with 0 being a perfect black, with 0% reflectance or transmission. With respect to L*, a rating of 50% indicates a middle gray, while a 100 rating indicates a perfect white. This indicates 100% reflectance and perfect clarity. With respect to a*, positive values of a* are red, while negative values are green. A a* level of 0 is neutral. With respect to b*, positive values of b* are yellow, while negative values are blue. 0 indicates neutrality. The total color difference quantifies the difference in color before and after the aerogel is coupled to the substrate. It may be undesirable to have a relatively large positive change in b* before and after the application of the aerogel, as it may lead to a yellowish hue. Accordingly, in some embodiments, the b₂*-b₁* of the article is less than or equal to 20, less than or equal to 15, less than or equal to 10, less than or equal to 8, less than or equal to 6, less than or equal to 4, less than or equal to 2, and/or less than or equal to 1. In some embodiments, the b₂*-b₁* of the article is greater than or equal to 1, greater than or equal to 2, greater than or equal to 4, greater than or equal to 6, greater than or equal to 8, greater than or equal to 10, greater than or equal to 15, and/or greater than or equal to 20. Combinations of these ranges are possible (e.g., less than or equal to 20 and greater than or equal to 1). Other ranges are also possible.

In some embodiments, it may be desirable to limit the overall change associated with b* (e.g., Δb*). In some embodiments, (b₂*-b₁*)² is less than or equal to 400, less than or equal to 225, less than or equal to 100, less than or equal to 64, less than or equal to 36, less than or equal to 16, less than or equal to 4, and/or less than or equal to 1. In some embodiments, (b₂*-b₁*)² is greater than or equal to 1, greater than or equal to 4, greater than or equal to 16, greater than or equal to 36, greater than or equal to 64, greater than or equal to 100, greater than or equal to 225, and/or greater than or equal to 400. Combinations of these ranges are possible (e.g., less than or equal to 400 and greater than or equal to 1). Other ranges are also possible.

In some embodiments, the total color difference is relatively low. In some embodiments, ΔE_{ab}*, is less than or equal to 20, less than or equal to 15, less than or equal to 10, less than or equal to 7, less than or equal to 5, less than or equal to 4, less than or equal to 3, less than or equal to 2, and/or less than or equal to 1. In some embodiments, ΔE_{ab}*, is greater than or equal to 1, greater than or equal to 2, greater than or equal to 3, greater than or equal to 4, greater than or equal to 5, greater than or equal to 7, greater than or equal to 10, greater than or equal to 15, greater than or equal to 20. Combinations of these ranges are possible (e.g., less than or equal to 20 and greater than or equal to 1). Other ranges are also possible.

As described elsewhere in the disclosure, the aerogel and the substrate may be coupled to form the article using, in some embodiments, an adhesive layer. In some embodiments, however, an adhesive layer is not present, and by treating (e.g., cleaning), the surface of the substrate and/or the aerogel, the affinity between the aerogel and the substrate is sufficient to render a glass-aerogel composite suitable for window applications. In either case, the aerogel and the substrate may be contacted such that a pressure may be applied for a duration of time that allows for the substrate and the aerogel to couple. The application of pressure may be carried out in a vacuum bag, but those of ordinary skill in the art would understand that such method is not limiting, and there may be other devices and/or methods (e.g., lamination) that may be capable of contacting the aerogel and the substrate in a manner that is sufficient to couple the aerogel and the substrate.

In some embodiments, coupling the aerogel to the substrate involves exposing the aerogel and the substrate to a pressure. That is, the aerogel may be disposed on the substrate, with or without an intervening adhesive layer, and exposed to a pressure that thereby couples the aerogel to the substrate. In some embodiments, the aerogel and the substrate are exposed to a pressure greater than or equal to 1 PSI, greater than or equal to 2 PSI, greater than or equal to PSI, greater than or equal to 5 PSI, greater than or equal to 10 PSI, greater than or equal to 15 PSI, greater than or equal to 20 PSI, and/or greater than or equal to 25 PSI. In some embodiments, the aerogel and the substrate are exposed to a pressure less than or equal to 25 PSI, less than or equal to 20 PSI, less than or equal to 15 PSI, less than or equal to 10 PSI, less than or equal to 5 PSI, less than or equal to 2 PSI, and/or less than or equal to 1 PSI. Combinations of these ranges are possible (e.g., greater than or equal to 1 PSI and less than or equal to 25 PSI). Other ranges are also possible.

In some embodiments, the aerogel and the substrate are exposed to the pressure any of a variety of durations. In some embodiments, the aerogel and the substrate are exposed to the pressure for a duration of greater than or equal to 30 seconds, greater than or equal to 1 minutes, greater than or equal to 5 minutes, greater than or equal to 10 minutes, greater than or equal to 20 minutes, greater than or equal to 30 minutes, greater than or equal to 40 minutes, greater than or equal to 50 minutes, greater than or equal to 60 minutes, greater than or equal to 2 hours, and/or greater than or equal to 5 hours. In some embodiments, the aerogel and the substrate are exposed to the pressure for a duration of less than or equal to 5 hours, less than or equal to 2 hours, less than or equal to 60 minutes, less than or equal to 50 minutes, less than or equal to 40 minutes, less than or equal to 30 minutes, less than or equal to 20 minutes, less than or equal to 10 minutes, less than or equal to 5 minutes, less than or equal to 1 minutes and/or less than or equal to 30 seconds. Combination of these ranges are possible (e.g., greater than or equal to 30 seconds and less than or equal to 5 hours). Other ranges are also possible.

In some embodiments, the aerogel has a relatively large volume and/or a surface having a relatively large area calculated by a length, a width, and/or a thickness of the aerogel. For example, as shown in FIG. 15D, aerogel 202 has length L2, width W2, and thickness T2. Aerogel 202 has a relatively large volume equivalent to the product of the multiplication of width W2, length L2, and thickness T2. Aerogel 202 also has surface 203 having a relatively large area equivalent to the production of the multiplication of width W2 and length L2. In some embodiments, the length and/or the width of the aerogel is greater than or equal to 12 in, greater than or equal to 18 in, greater than or equal to 24 in, greater than or equal to 36 in, greater than or equal to 48 in, greater than or equal to 60 in, greater than or equal to 72 in, or greater than or equal to 100 in. In some embodiments, the length and/or the width of the aerogel is less than or equal to 1000 in, less than or equal to 500 in, less than or equal to 250 in, less than or equal to 100 in, less than or equal to 72 in, less than or equal to 60 in, or less than or equal to 48 in. Combinations of these ranges are possible (e.g., greater than or equal to 12 in and less than or equal to 1000 in). Other ranges are possible. It should be understood that the dimensions described above generally refer to dimensions of a monolithic portion of the aerogel rather than the sum of dimensions of two or more portions of aerogel (e.g., aerogel particles). For example, turning once again to FIG. 15D, aerogel 202, being monolithic, has length L2, width W2, and thickness T2.

In some embodiments, the aerogel comprises silica. In some embodiments, the aerogel comprises at least 10 wt % (e.g., at least 20 wt %, at least 30 wt %, at least 40 wt %, at least 50 wt %, at least 60 wt %, at least 70 wt %, at least 80 wt %, at least 90 wt %, at least 95 wt %) silica. Silica, in some embodiments, comprises silicon dioxide (SiO₂). Aerogels comprising silica may have relatively high transparency, in some cases, making them desirable for use as a transparent insulator in windows. In some embodiments, the aerogel is a silica aerogel.

Any of a variety of suitable substrate may be used to form the article described herein. In some embodiments, the substrate is a transparent substrate. In some embodiments, the substrate comprises glass or a transparent polymer including but not limited to acrylic and/or polycarbonate. In some embodiments, the substrate comprises a glass sheet. In some embodiments, the glass sheet comprises ultra-thin glass (e.g., willow glass) or glass that is typically found in window applications (e.g., 6 mm thick glass sheets). While the substrate itself may be relatively transparent, one or more coatings may be deposited onto the substrate, before or after coupling of the aerogel to the substrate, such that the transparency of the substrate is reduced. For example, in some embodiments, the substrate may also have a low emissivity (low-E) coating. A low emissivity coating may reduce the transmittance of the substrate, but is still desirable in many window applications. In some embodiments, the substrate is a laminated substrate and/or a patterned substrate.

The substrate may have an appropriate size and thickness suitable for interior and/or exterior window applications. Accordingly, the substrate may be suitable in IGUs or the like. In some embodiments, the substrate has a size that is substantially the same as the size of the aerogel. In some embodiments, the substrate has any of a variety of suitable thicknesses. In some embodiments, the thickness of the substrate is greater than or equal to 0.1 mm, greater than or equal to 0.5 mm, greater than or equal to 1 mm, greater than or equal to 2 mm, greater than or equal to 3 mm, greater than or equal to 4 mm, greater than or equal to 5 mm, or greater than or equal to 6 mm. In some embodiments, the thickness of the substrate is less than or equal to 6 mm, less than or equal to 5 mm, less than or equal to 4 mm, less than or equal to 3 mm, less than or equal to 2 mm, less than or equal to 1 mm, less than or equal to 0.5 mm, and/or less than or equal to 0.1 mm. Combinations of these ranges are possible (e.g., greater than or equal to 0.1 mm and less than or equal to 6 mm). Other ranges are also possible.

The substrates described herein may undergo any of a variety of treatments and/or processes to render the substrates more desirable for window applications. In some embodiments, the substrate may be tempered, annealed, and/or heat treated. As one example, tempered glass when fractured creates fractured pieces that are typically not as sharp as fractured pieces derived from non-tempered glass. Tempered glass may be therefore desirable because it is safer after a fracture event than non-tempered glass.

In some embodiments, the article comprises two or more substrates. In some embodiments, the aerogel is coupled to a first substrate and positioned proximate to a second substrate, the second substrate having the same or different material as the first substrate, such that an IGU is formed. A gap may be present between the aerogel and at least one of the substrates. In some embodiments, the gap may be evacuated of any gas once present in the gap, or the gap may be filled with a gas including but not limited to air, argon, nitrogen, or the like. In some embodiments, the IGU comprises the aerogel-substrate composite.

Systems, articles, and methods regarding insulated units are also provided. The insulated units described herein may have any of a variety of configurations. In some embodiments, the insulated unit comprises two or more substrate layers. For example, the insulated may comprise an aerogel layer positioned between a first substrate layer and/or a second substrate layer each comprising a substrate (e.g., a transparent substrate). As another example, the insulated unit may comprise an aerogel layer positioned between a first and second substrate layer and/or a second and third layer, wherein the first, second and third substrate layers each comprises a transparent substrate. In some embodiments, a coating (e.g., a low emissivity coating) is disposed on one or more of the transparent substrates. The aerogel layer may comprise the aerogel described above and may provide advantageous insulative properties to the insulated unit and visual clarity (e.g., low haze, high visual transmittance) such that the insulated unit may be used as a window and/or a portion thereof. For instance, as described below, a ratio of the Rᵥₐₗ of the insulated unit to the weight of the insulated unit may be greater than or equal to 0.75 which may make the insulated unit desirable in window applications. In some embodiments, the insulated unit is an insulated glass unit. For instance, the insulated unit comprises a first substrate layer and a second substrate layer, wherein the first and/or the second substrate layer comprises a glass sheet.

### [“Sandwich Configuration”]

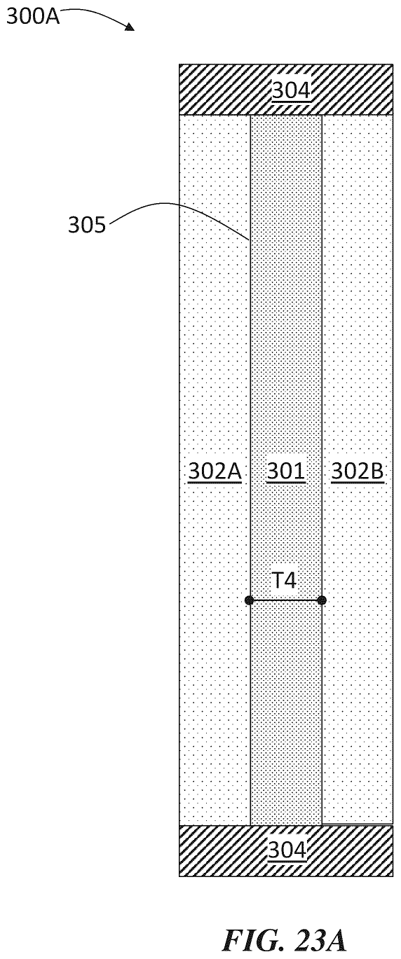

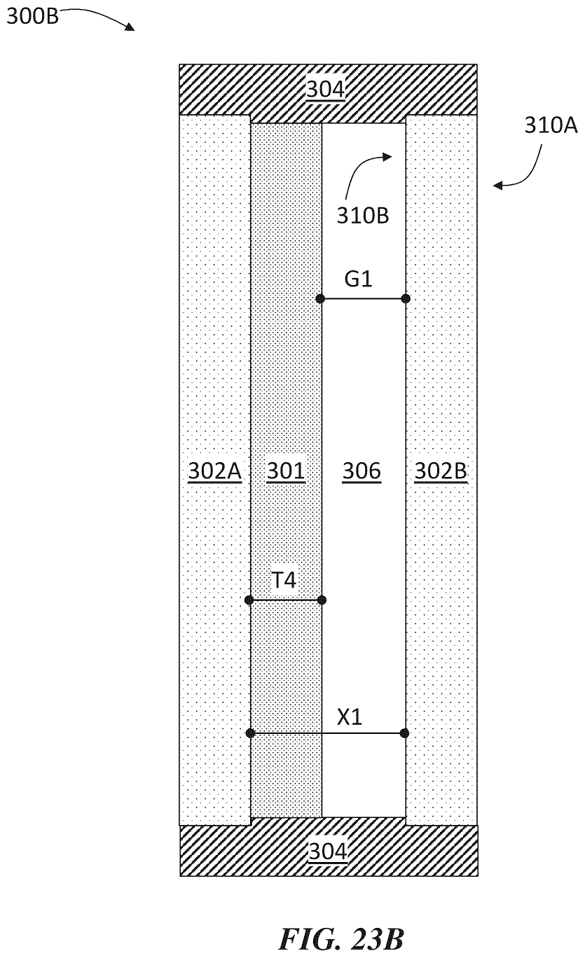

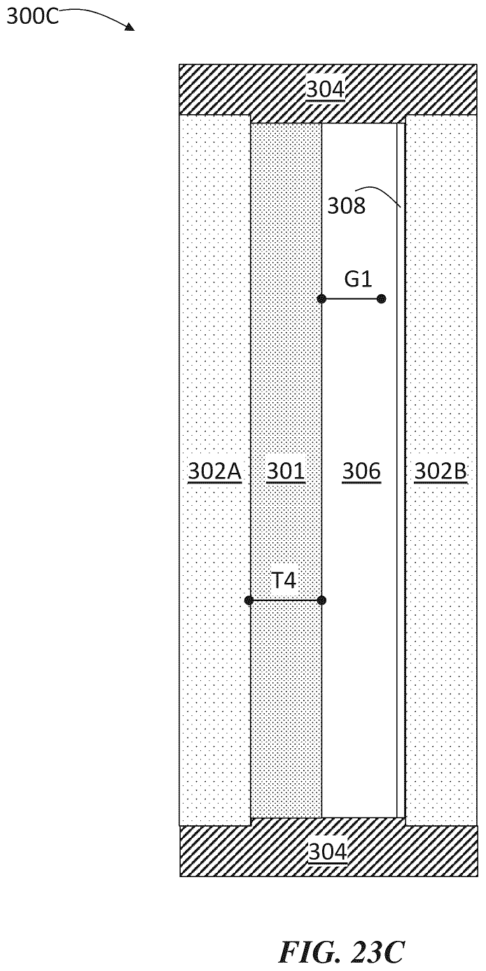

In some embodiments, the insulated unit is a double-pane insulated unit. In some embodiments, the insulated unit comprises an aerogel layer (e.g., a monolithic aerogel) positioned between a first substrate layer comprising a first transparent substrate and a second substrate layer comprising a second transparent substrate. For example, as shown in FIG. 23A, insulated unit 300A comprises aerogel 301 is positioned between first substrate layer 302A and second substrate layer 302B. First substrate layer 302A and/or second substrate layer 302B may be a substrate (e.g., a transparent substrate) that is coupled to aerogel 301. The coupling of aerogel 301 to first substrate layer 302A and/or second substrate layer 302B is further described elsewhere in this disclosure. While not shown in FIG. 23A, an intervening layer may be disposed between the aerogel and the first and/or second substrate layer. For example, an intervening layer, such as an adhesive layer, may be positioned between aerogel 300 and first and/or second substrate layers 302A and 302B. An example of such an intervening layer is shown in FIG. 15B. In some embodiments, the insulated unit is a vacuum insulated glass unit.

In some embodiments, insulated unit comprises a spacer that holds the layers of the insulated unit together. For example, aerogel layers and/or substrate layers may be held together by a spacer so that the insulated unit may be handled as a unit, rather than by its separate layers. For example, as shown in FIG. 23A, spacer 304 attaches to aerogel 301, first substrate layer 302A, and second substrate layer 302B. While the spacer may hold the layers of the insulated unit together, aerogel layers that are coupled to substrates may be coupled using the methods that are described elsewhere in this disclosure, such as using an adhesive and/or an adhesive promoter. Aerogel layers that are coupled to substrate layers may therefore remain coupled even when the spacer is not present. Therefore, the spacer may provide additional support to the aerogel layers and/or substrate layers allowing them to form a unit, but the spacer does not serve to provide interlayer adhesion. [Double-Pane Configurations]

In some embodiments, a gap may be positioned between the aerogel layer and other layers of the insulated unit. For example, insulated unit 300B shown in FIG. 23B is essentially identical to insulated unit 300A shown in FIG. 23A except that second substrate layer 102B is spaced apart from aerogel 300 such that gap 306 is positioned between second substrate layer 302B and aerogel 301. Second substrate layer 302B has outer surface 310A and inner surface 310B. In some embodiments, the aerogel layer may be coupled to the second substrate layer as described elsewhere in this disclosure. While FIG. 23B shows insulated unit 300B having gap 306 positioned between second substrate layer 302B and aerogel 301, gap 306 may instead be positioned between first substrate layer 302A and aerogel 301. In embodiments where a gap is positioned between the aerogel layer and the second substrate layer, the aerogel layer may be coupled to the second substrate layer as described elsewhere in this disclosure. Without wishing to be bound by any particular theory, the gap may provide desirable thermal and/or sound insulative properties to the insulated unit. The gap, in combination with the aerogel, may render the insulated unit desirable for window applications.

The gap may have any of a variety of thickness. For example, as shown in FIG. 23B, gap 306 has thickness G1. In some embodiments, the gap has a thickness of at least 1 mm, at least 2 mm, at least 3 mm, at least 4 mm, at least 5 mm, at least 6 mm, at least 7 mm, at least 8 mm, at least 9 mm, at least 10 mm, at least 15 mm, and/or up to 20 mm, up to 21 mm, or up to 22 mm. Combinations of the above ranges are possible (e.g., at least 1 mm and up to 30 mm). Other ranges are possible.

In some embodiments, the gap may comprises a gas or be under vacuum. In embodiments where the gap comprises a gas, the gas may be any of a variety of gases. For example, in some cases, the gap may be an gas (e.g., carbon dioxide), such as an inert gas (e.g., argon, krypton, xenon, and/or mixtures thereof). In some embodiments, the gas comprises argon, nitrogen, air, and/or mixtures thereof. In some embodiments, the spacer of insulated unit may be provide a seal (e.g., a hermetic seal) such that air from the surrounding environment may not transported into the gap. In some embodiments, the gap comprises the gas at a gauge pressure of greater than or equal to 0 psi and less than or equal to 1 psi. In some embodiments, the gap is under vacuum.

In some embodiments, the insulated unit may have any of a variety of distances between the substrates of the insulated unit. For example, as shown in FIG. 23B, the distance between first substrate layer 302A and second substrate layer 302B is X1. In some embodiments, the distance between substrate layers may be influenced by the presence of other layers (e.g., aerogel layers and/or coating layers) positioned between the substrates. In some embodiments, the distance between the first and second substrate layer of the insulated unit is at least 3 mm, at least 4 mm, at least 5 mm, at least 6 mm, at least 7 mm, at least 8 mm, at least 9 mm, at least 10 mm, at least 15 mm, at least 20 mm, at least 25 mm, at least 30, and/or up to 33 mm, up to 34 mm, or up to 35 mm. Combinations of these ranges are possible (e.g., at least 8 mm and up to 35 mm).

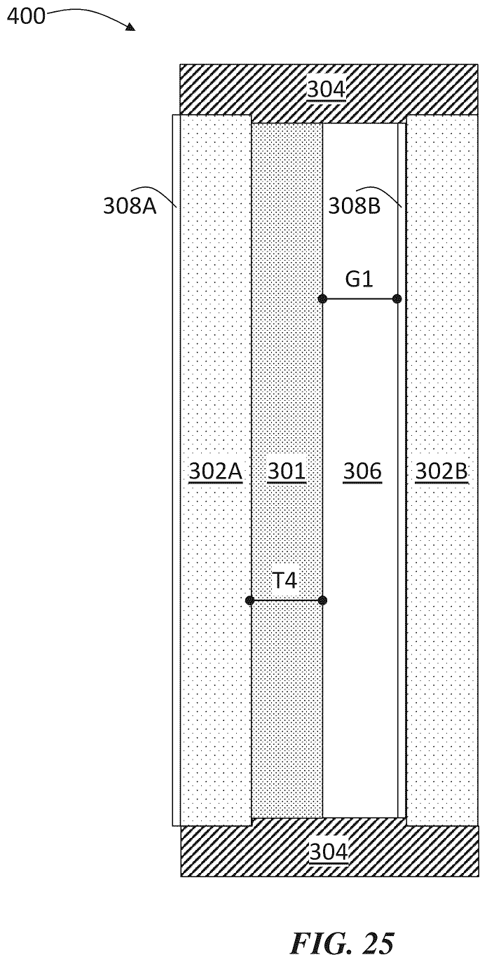

In some embodiments, the substrate layers (e.g., the first, second, and/or third substrate layers) of the insulated unit may comprise a one or more coating layers disposed thereon. In some embodiments, a coating layer may be disposed on any of the substrate layers of the insulated (e.g., on an inner surface and/or an outer surface). For example, insulated unit 300C shown in FIG. 23C is essentially identical to insulated unit 300B shown in FIG. 23B except that coating layer 308 is disposed on second substrate layer 302B. While coating layer 308 is shown disposed on an inner surface of second substrate layer 302B, coating layer 308 may be disposed on any surface of first substrate layer 302A and/or second substrate layer 302B. In some embodiments, the coating may be disposed on both an outer surface of the first and/or second substrate layer and an inner surface of the first and/or second substrate layers. In some embodiments, the coating may be disposed on the inner surfaces of the first and/or second substrate layers. In some embodiments, the coating layer may be disposed between the aerogel and a substrate layer (e.g., the first, second, and/or third substrate layers). In some, but not all, embodiments, the first and/or second substrate layer does not comprise the coating. In some embodiments, the coating layer (e.g., the first coating and/or the second substrate layer) comprises a low-emissivity coating. The low-emissivity coating may selectively reflect radiation based on the wavelength of the radiation. For example, the low-emissivity may reflect infrared radiation while allowing visible light to pass therethrough. Low-emissivity coatings may also reflect UV radiation while allowing visible light to pass therethrough. In some embodiments, the low-emissivity coating comprises metal-oxides, such as silver oxide, tin oxide, and/or zinc oxide. Example of substrate layers comprising coating layers that may be used in insulated units described herein include product lines manufactured by Cardinal Glass such as LoE 180, LoE 240, LoE 262, LoE 270, LoE 272, LoE 240, LoE 266, and/or LoE i89. Additional examples include COOL-LITE or PLANITHERM manufactured by Saint Gobain; Planibel, Stopray, and Stratobel manufactured by AGC; SUNGAURD AND CLIMAGAURD manufactured by Guardian Glass; Energy Advantage and Suncool manufactured by Pilkington; and/or Solarban manufactured by Vitro Glass. An example embodiment of an insulated unit having two coating layers is shown in FIG. 25. Insulated unit 400 is essentially identical to insulated unit 300C except the insulated unit 400 comprises coating layer 308A disposed on an outer surface of substrate layer 302A.

In some embodiments, the coating layer may have an emissivity of any of a variety of values. In some embodiments, the coating layer has an emissivity of less than or equal to 0.9, less than or equal to 0.8, less than or equal to 0.7, less than or equal to 0.6, less than or equal to 0.5, less than or equal to 0.4, less than or equal to 0.3, less than or equal to 0.2, less than or equal to 0.1, less than or equal to 0.05, and/or less than or equal to 0.01. In some embodiments, the coating layer has an emissivity of greater than or equal to 0.01, greater than or equal to 0.05, greater than or equal to 0.1, greater than or equal to 0.2, greater than or equal to 0.3, greater than or equal to 0.4, greater than or equal to 0.5, greater than or equal to 0.6, greater than or equal to 0.7, greater than or equal to 0.8, and/or greater than or equal to 0.9. Combinations of the above ranges are possible (e.g., less than or equal to 0.9 and greater than or equal to 0.01). Other ranges are possible.

Emissivity of a coating layer can measured using an emissometer or using Fourier-transform infrared spectroscopy (FTIR).

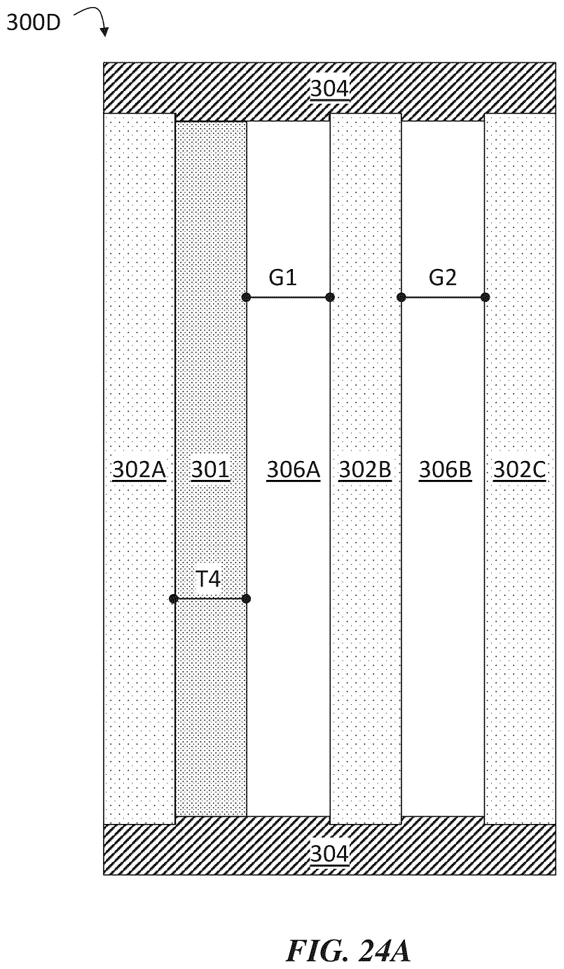

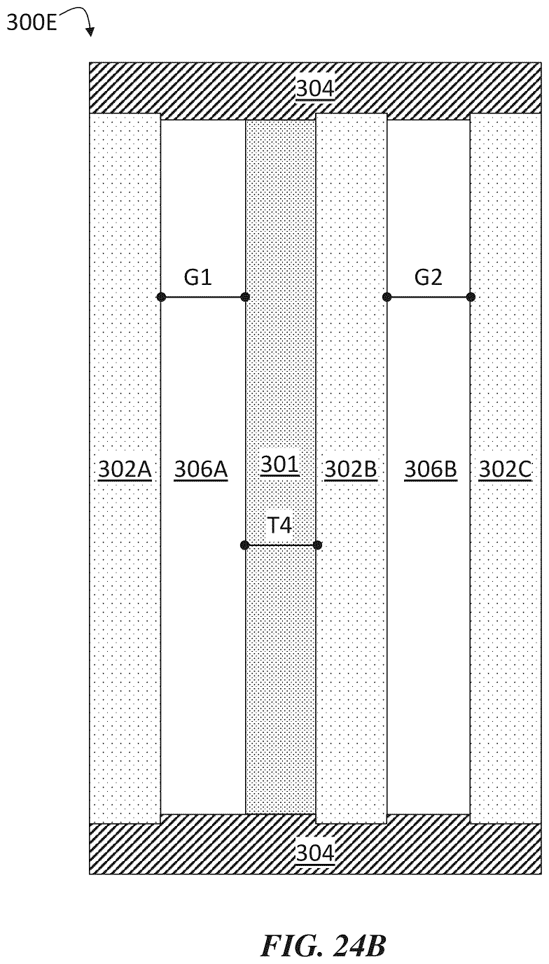

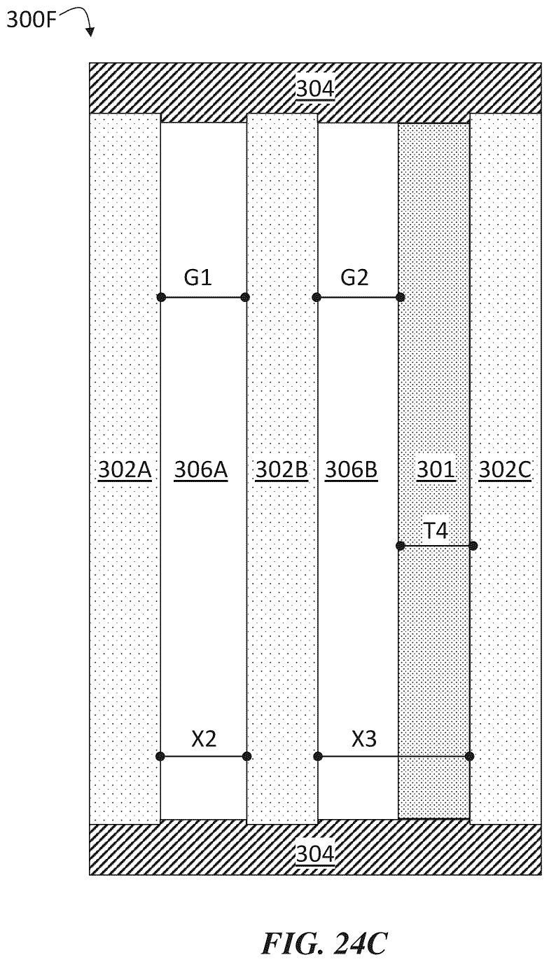

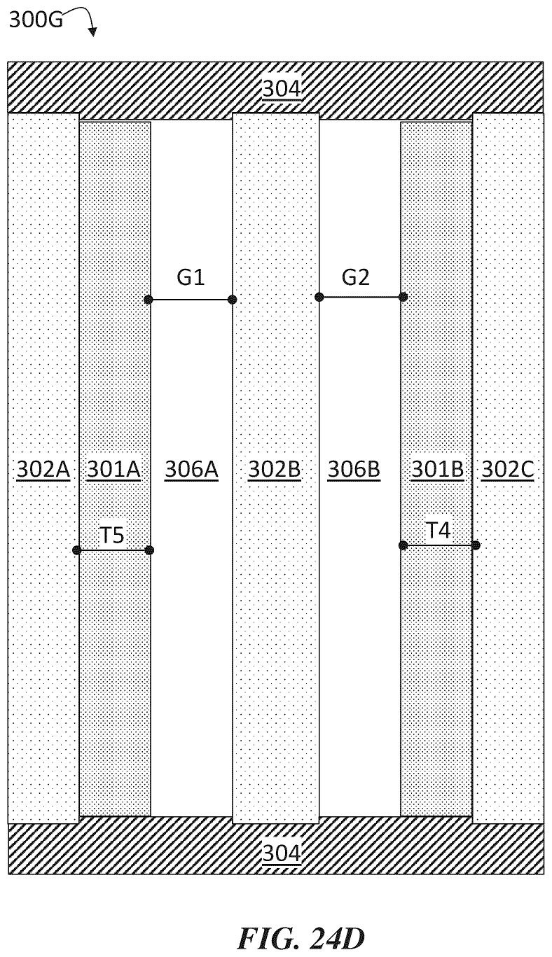

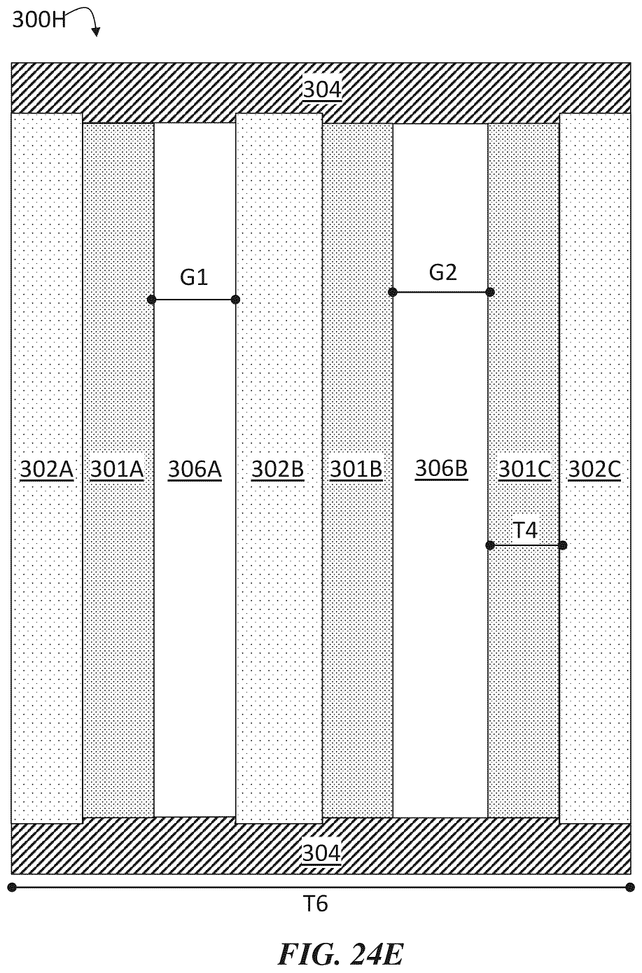

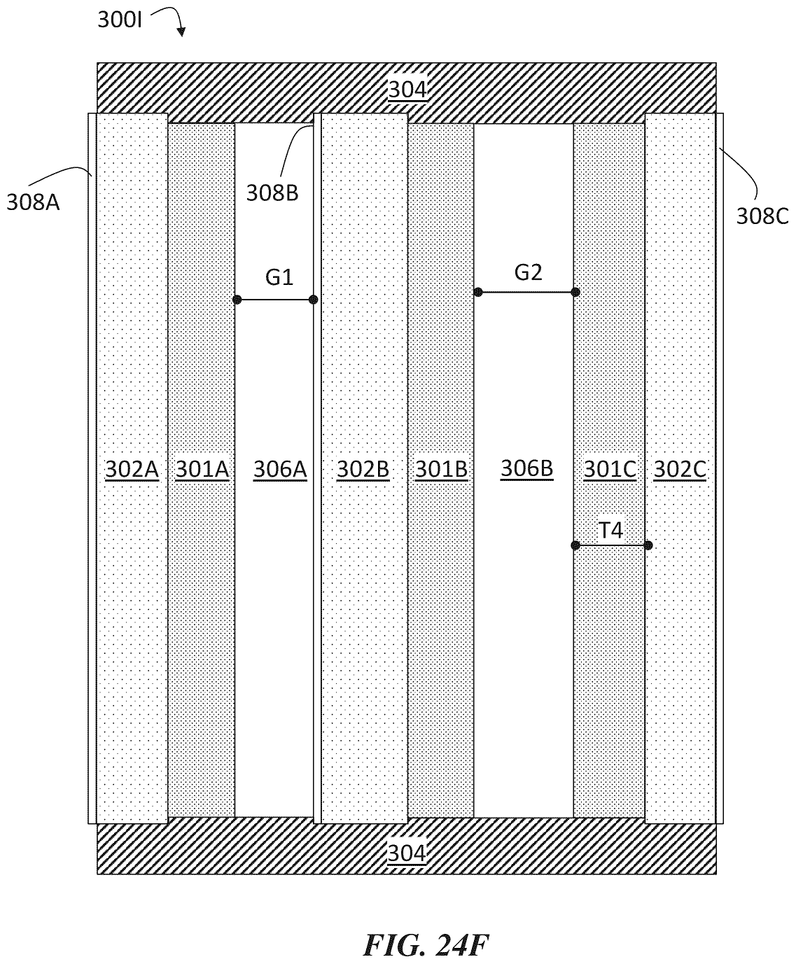

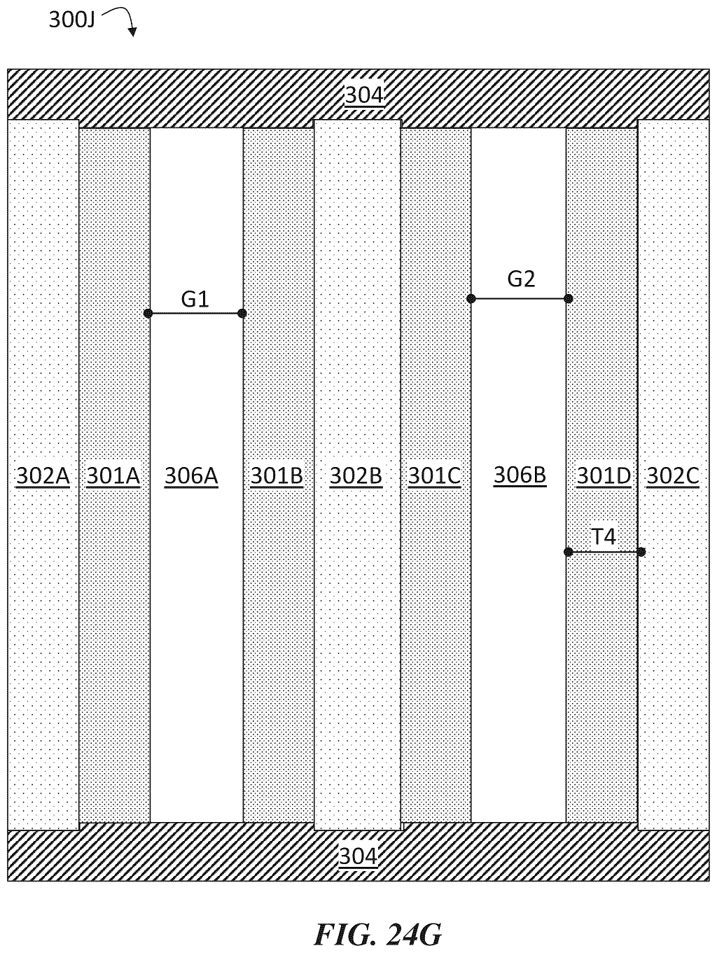

In some embodiments, at least a portion of the spacer may be disposed on the substrates of the insulated unit. For example, as shown in FIGS. 23B-24G, portions of spacer 304 are disposed on substrate layers 302A, 302B, and 302C. In some embodiments, the aerogel has an area that is smaller than the area of the transparent substrate. For instance, the length and/or width of the aerogel may be less than the length and/or the width of at least some of the substrate layers (e.g., the first, second, and/or third substrate layer). In such embodiments, a portion of the transparent substrate may be exposed such that the spacer, or a portion thereof, may be disposed, and in some cases, contact, the transparent substrate on an inner surface and/or outer surface of the transparent substrate. In some embodiments, the aerogel does not make contact with the spacer. Rather, the spacer may contact (e.g., directly or via one or more intervening layers) substrate layers. In some embodiments, the spacer bonds to the transparent substrate on the same surface of the substrate as the aerogel. It should be appreciated that, in some cases, the aerogel has an area that is substantially the same as the area of the transparent substrate, such as the embodiments shown in FIG. 23A.

In some embodiments, the insulated unit is a triple-pane insulated unit. In some embodiments, the insulated unit comprises an aerogel layer and a first substrate layer, a second substrate layer, and a third substrate layer each comprising a substrate (e.g., a transparent substrate). For example, insulated unit 300D shown in FIG. 24A is essentially identical to insulated unit 300B shown in FIG. 23B except that insulated unit 300D comprises third substrate layer 302C spaced apart from second substrate layer 302B such that second gap 306B is positioned between second substrate layer 102B and third substrate layer 102C. As in insulated unit 300B shown in FIG. 23B, first gap 306A is positioned between aerogel 301 and second substrate layer 302B. Without wishing to be bound by any particular theory, the third substrate layer, and the second gap when present, provides desirable insulative properties to the insulated unit, especially when compared to insulated units comprising two transparent substrates, such as those shown in FIG. 23B.

As shown in FIG. 24A, aerogel 301 is disposed on an inner surface (e.g., side) of first substrate layer 302A, which is an outer layer of insulated unit 300D. In some embodiments, the aerogel layer is disposed on and coupled to an inner layer of the insulated unit. For example, insulated unit 300E shown in FIG. 24B is essentially identical to insulated unit 300D shown in FIG. 24A except that aerogel 301 is disposed on and coupled to second substrate layer 302B, an inner layer of insulated unit 300E. First gap 306A is positioned between first substrate layer 302A and aerogel 301. While aerogel 301 is shown positioned on a surface (e.g., a first side) of second substrate layer 302B that is closest to first substrate layer 302A in FIG. 24B, this disclosure is not intended to be so limited. In some embodiments, the aerogel layer may be disposed and/or coupled a surface (e.g., a second side) of the third substrate layer that is closest to the third substrate layer.

In some embodiments, the aerogel layer is disposed on and/or couple to the third substrate layer. For example, insulated unit 300F shown in FIG. 24C is essentially identical to insulated unit 300E of FIG. 24B except that aerogel 301 is disposed on and couple to third substrate layer 302C. Second gap 306B is positioned between second substrate layer 302B and aerogel 301.

In some embodiments, the aerogel layer is positioned in the interior of the insulated unit. It may be desirable to protect the aerogel from conditions external to the insulated unit, such conditions may be relatively harsh. For example, the insulated unit may be exposed to extreme sunlight, temperatures, wind, and/or debris that may damage the aerogel if position on an external surface of the insulated unit. As shown in FIGS. 24A-24C, insulated unit 300D, 300E, and 300F comprise aerogel 301 that may be disposed on and/or coupled to first substrate layer 302A, second substrate layer 302B, or third substrate layer 302C on a surface that is in the interior of the insulated unit.

While FIGS. 23A-23C show insulated units 300A, 300B, and 300C having a single aerogel layer, the insulated units described herein may have any number of aerogels. In some embodiments, the insulated unit comprises at least one aerogel, at least two aerogels, at least three aerogels, at least four aerogels, at least five aerogels, or more. For example, insulated unit 300G shown in FIG. 24D comprises two aerogels layers: first aerogel 301A and second aerogel 301B. First aerogel 301A is disposed on and coupled to first substrate layer 302A. Second aerogel 301B is disposed on and coupled to third substrate layer 302C. First gap 306A is positioned between first aerogel 301A and second substrate layer 302B. Second gap 306B is positioned between second aerogel 301B and second substrate layer 302B. In some embodiments, the aerogels within an insulated unit may be the same or different as other aerogels within the insulated unit. For example, first aerogel 301A has thickness T4 and second aerogel 301B has thickness T5. In some embodiments, the thickness of the first aerogel layer may be the same or different than the thickness of other aerogel layers in the insulated unit (e.g., second aerogel 301B). As another example, insulated unit 300H shown in FIG. 24E comprises three aerogels: first aerogel 301A, second aerogel 301B, and third aerogel 301C. Insulated unit 300H shown in FIG. 24E is essentially identical to insulated unit 300G shown in FIG. 24D except that second aerogel 301B is disposed on and coupled to third substrate layer 302C and third aerogel 301C is disposed on and coupled to third substrate layer 302C. First gap is positioned between first aerogel 301A and second substrate layer 302B. Second gap is positioned between second aerogel 301B and third aerogel 301C.

While FIGS. 24A-24G include three substrate layer, additional substrate layers may also be included. For instance, the insulated unit may comprise a fourth substrate layer. One or more aerogel layers may be disposed on the fourth substrate layer. The fourth substrate layer may be spaced apart from the first, second, and/or third substrate layers such that a gap is formed.

As described above, the insulated unit may comprise a coating. The insulated unit may comprise any number of coatings layer. In some embodiments, the insulated unit comprises at least 1 coating layer, at least 2 coating layers, at least 3 coating layers, or more. For example, insulated unit 300I shown in FIG. 24F is essentially identical to insulated unit 300H of FIG. 24E except that insulated unit 300I comprises first coating layer 308A disposed on first substrate layer 302A, second coating layer 308B disposed on second substrate layer 302B, and third coating layer 308C disposed on third substrate layer 302C. Materials and properties associated with the coating layers are described elsewhere in this disclosure.

In some embodiments, an aerogel is disposed on all the interior surfaces of the substrates of the insulated unit. For example, insulated unit 300J shown in FIG. 24G is essentially identical to insulated unit 300H of FIG. 24E except that insulated unit 300J comprises four aerogels: first aerogel 301A, second aerogel 301B, third aerogel 301C, and fourth aerogel 301D. First gap 306A is positioned between first aerogel 301A and second aerogel 301B. Second gap 306B is positioned between third aerogel 301C and fourth aerogel 301D. Insulated units described herein may have additional aerogels (e.g., a fifth aerogel) in the form of additional layers (e.g., fourth layer, fifth layer, sixth layer, seventh layer, or more).

In some embodiments, the first gap may have any of a variety of thickness. For example, as shown in FIG. 24A, first gap 306A has thickness G1. In some embodiments, the first gap has a thickness of at least 1 mm, at least 2 mm, at least 3 mm, at least 4 mm, at least 5 mm, at least 6 mm, at least 7 mm, at least 8 mm, at least 9 mm, at least 10 mm, at least 15 mm, at least 20 mm, and/or up to 25 mm, up to 27 mm, or up to 30 mm. Combinations of the above ranges are possible (e.g., at least 1 mm and up to 60 mm). Other ranges are possible.

In some embodiments, the second gap may have any of a variety of thickness. For example, as shown in FIG. 24A, second gap 306B has thickness G2. In some embodiments, the second gap has a thickness of at least 1 mm, at least 2 mm, at least 3 mm, at least 4 mm, at least 5 mm, at least 6 mm, at least 7 mm, at least 8 mm, at least 9 mm, at least 10 mm, at least 15 mm, and/or up to 20 mm, up to 21 mm, or up to 22 mm. Combinations of the above ranges are possible (e.g., at least 1 mm and up to 60 mm). Other ranges are possible. In some embodiments, the thickness of the first gap is the same as the thickness of the second gap. In some embodiments, the thickness of the first gap is different than the thickness of the second gap.

In some, but not all embodiments, the insulated unit may comprise a first gap or a second gap. In some embodiments, insulated units comprising three or more substrate layers may comprise a single gap. For example, an insulated unit may comprise the structure shown in FIG. 23A in addition to a third substate spaced apart from second substrate 302B as shown in FIGS. 24D-24G. In such instances, a gap may not be present between the first substrate, the aerogel, and the second substrate, but a gap may be present between the second substrate and the third substrate.

In some embodiments, the insulated unit may have any of a variety of distances between the substrates of the insulated unit. For example, as shown in FIG. 24C, the distance between first substrate layer 302A and second substrate layer 302B is X2, and the distance between second substrate layer 302B and third substrate layer 302C is X3. In some embodiments, the distance between substrate layers may be influenced by the presence of other layers (e.g., aerogel layers and/or coating layers) positioned between the substrates. In some embodiments, the distance between the first and second substrate layer and/or the distance between the second substrate layer and the third substrate layer of the insulated unit is at least 3 mm, at least 4 mm, at least 5 mm, at least 6 mm, at least 7 mm, at least 8 mm, at least 9 mm, at least 10 mm, at least 15 mm, at least 20 mm, at least 25 mm, at least 30, and/or up to 33 mm, up to 34 mm, or up to 35 mm. Combinations of these ranges are possible (e.g., at least 8 mm and up to 35 mm).

In some embodiments, the first and/or second gap may comprise a gas or be under vacuum. In embodiments where the first and/or second gap comprises a gas, the gas may be any of a variety of gases. For example, in some cases, the first and/or second gap may be an inert gas (e.g., argon). In some embodiments, the first and/or second gas comprises argon, nitrogen, air, and/or mixtures thereof. In some embodiments, the spacer of insulated unit may be provide a seal (e.g., a hermetic seal) such that air from the surrounding environment may not transported into the first and/or second gap. In some embodiments, the first and/or second gap comprises the gas at a gauge pressure of greater than or equal to 0 psi and less than or equal to 1 psi. In some embodiments, the first and/or second gap is under a vacuum. In some embodiments, the gas in the first gap and/or the pressure within the first gap is different than the gas in the second gap and/or the pressure within the second gap. In some embodiments, the gas in the first gap and/or the pressure within the first gap is the same as the gas in the second gap and/or the pressure within the second gap.

In some embodiments, the insulated units described herein comprise a number of layers each comprising a substrate, such as a transparent substrate. The transparent substrate may comprise a transparent sheet, such as a glass sheet or a polymeric sheet (e.g., an acrylic sheet and/or a polycarbonate sheet). In some embodiments, the substrate layers (e.g., the first, second, and/or third substrate layers) may comprise any of a variety of materials that are suitable transparent for window applications. Additional information regarding the substrates described herein can be found elsewhere in this disclosure. Examples of substrate layers include but are not limited to glass manufactured by Saint Gobain, Solarban, Pilkington, and Guardian Glass.

In some embodiments, the substrate layers (e.g., the transparent substrate layers) described herein may have any of a variety of thermal conductivities and visual transmittances. In some embodiments, the substrate layers have a visual transmittance of at least 0.7, at least 0.72, at least 0.75, or more. In some embodiments, the substrate layers have a thermal conductivity of at least 0.90 W/m-K, at least 0.95 W/m-K, at least 1 W/m-K, or more.

In some embodiments, the insulated unit has U-factor that is relatively low. In some embodiments, the U-factor of the insulated unit is less than or equal to 0.5 Btu/h·ft²·F, less than or equal to 0.45 Btu/h·ft²·F, less than or equal to 0.4 Btu/h·ft²·F, less than or equal to 0.35 Btu/h·ft²·F, less than or equal to 0.3 Btu/h·ft²·F, less than or equal to 0.25 Btu/h·ft²·F, less than or equal to 0.20 Btu/h·ft²·F, less than or equal to 0.15 Btu/h·ft²·F, less than or equal to 0.10 Btu/h·ft²·F, and/or less than or equal to 0.05 Btu/h·ft²·F. In some embodiments, the U-factor of the insulated unit is greater than or equal to 0.05 Btu/h·ft²·F, greater than or equal to 0.1 Btu/h·ft²·F, greater than or equal to 0.15 Btu/h·ft²·F, greater than or equal to 0.20 Btu/h·ft²·F, greater than or equal to 0.25 Btu/h·ft²·F, greater than or equal to 0.30 Btu/h·ft²·F, greater than or equal to 0.35 Btu/h·ft²·F, greater than or equal to 0.40 Btu/h·ft²·F, greater than or equal to 0.45 Btu/h·ft²·F, and/or greater than or equal to 0.5 Btu/h·ft²·F. Combinations of these ranges are possible (e.g., less than or equal to 0.5 Btu/h·ft²·F and greater than or equal to 0.1 Btu/h·ft²·F). Other ranges are possible. In some embodiments, the insulated unit has an advantageous U-factor that is less than or equal to 0.32 Btu/h·ft²·F, less than or equal to 0.28 Btu/h·ft²·F, less than or equal to 0.25 Btu/h·ft²·F, and/or less than or equal to 0.22 Btu/h·ft²·F. In som

The U-Factor of insulated units can be measured in accordance with NFRC 102.

In some embodiments, the insulated unit has a Rᵥₐₗ that is relatively high. The Rᵥₐₗ of the insulated unit is the reciprocal of the U-factor of the insulated unit. In some embodiments, the insulated unit has an Rᵥₐₗ of greater than or equal to 2 h·ft²·F/Btu, greater than or equal to 2.25 h·ft²·F/Btu, greater than or equal to 2.5 h·ft²·F/Btu, greater than or equal to 2.75 h·ft²·F/Btu, greater than or equal to 3 h·ft²·F/Btu, greater than or equal to 3.25 h·ft²·F/Btu, greater than or equal to 3.5 h·ft²·F/Btu, greater than or equal to 3.75 h·ft²·F/Btu, and/or greater than or equal to 4 h·ft²·F/Btu, greater than or equal to 4.25. In some embodiments, the insulated unit has an Rᵥₐₗ of less than or equal to 4.25 h·ft²·F/Btu, less than or equal to 4 h·ft²·F/Btu, less than or equal to 3.75 h·ft²·F/Btu, less than or equal to 3.5 h·ft²·F/Btu, less than or equal to 3.25 h·ft²·F/Btu, less than or equal to 3 h·ft²·F/Btu, less than or equal to 2.75 h·ft²·F/Btu, less than or equal to 2.5 h·ft²·F/Btu, less than or equal to 2.25 h·ft²·F/Btu, and/or less than or equal to 2 h·ft²·F/Btu. Combinations of these ranges are possible (e.g., greater than or equal to 2 h·ft²·F/Btu and less than or equal to 4.25 h·ft²·F/Btu). Other ranges are also possible.

The Rᵥₐₗ of insulated units, which is the reciprocal of the U-factor the insulated units, can be measured in accordance with NFRC 102.

In some embodiments, the insulated unit has a relatively high visible transmittance (Tᵥᵢₛ). In some embodiments, the visible transmittance through the insulated unit, without a coating layer, is greater than or equal to 0.7, greater than or equal to 0.71, greater than or equal to 0.72, greater than or equal to 0.73, greater than or equal to 0.74, greater than or equal to 0.75, greater than or equal to 0.76, greater than or equal to 0.77, greater than or equal to 0.78, greater than or equal to 0.79, greater than or equal to 0.8, greater than or equal to 0.81, and/or greater than or equal to 0.82. In some embodiments, the visible transmittance through the insulated unit, without a coating layer, is less than or equal to 0.82, less than or equal to 0.81, less than or equal to 0.80, less than or equal to 0.79, less than or equal to 0.78, less than or equal to 0.77, less than or equal to 0.76, less than or equal to 0.75, less than or equal to 0.74, less than or equal to 0.73, less than or equal to 0.72, less than or equal to 0.71, less than or equal to 0.7. Combinations of these ranges are possible (e.g., greater than or equal to 0.7 and less than or equal to 0.82). Other ranges are possible.

The visual transmittance of an insulated unit may be measured in accordance with NFRC 202.

In some embodiments, the insulated unit has a relatively high SHGC. In some embodiments, the insulated unit has a SHGC of greater than or equal to 0.1, greater than or equal to 0.2, greater than or equal to 0.3, greater than or equal to 0.4, greater than or equal to 0.5, greater than or equal to 0.6, greater than or equal to 0.7, greater than or equal to 0.8, greater than or equal to 0.9, and/or greater than or equal to 0.95. In some embodiments, the insulated unit has a SHGC of less than or equal to 0.95, less than or equal to 0.9, less than or equal to 0.8, less than or equal to 0.7, less than or equal to 0.6, less than or equal to 0.5, less than or equal to 0.4, less than or equal to 0.3, and/or less than or equal to 0.2, less than or equal to 0.1. Combinations of these ranges are possible (e.g., greater than or equal to 0.3 and less than or equal to 0.95). Other ranges are possible.

In some embodiments, the insulated unit has an advantageous SHGC. In some embodiments, the insulated unit has a SHGC of greater than or equal to 0.17, greater than or equal to 0.35, and/or greater than or equal to 0.40. In some embodiments, the insulated unit has a SHGC of less than or equal to 0.4 and/or less than or equal to 0.23. In embodiments where the insulated unit has a U-factor of 0.23 Btu/h·ft²·F, the insulated unit may have a SHGC of greater than or equal to 0.35. In embodiments where the insulated unit has a U-factor of 0.24 Btu/h·ft²·F, the insulated unit may have a SHGC of greater than or equal to 0.35. In embodiments where the insulated unit has a U-factor of 0.25 Btu/h·ft²·F, the insulated unit may have a SHGC of greater than or equal to 0.4. In embodiments where the insulated unit has a U-factor of 0.26 Btu/h·ft²·F, the insulated unit may have a SHGC of greater than or equal to 0.4.

In some embodiments, the insulated unit may have a SHGC of greater than or equal to 0.17 and a U-factor of less than or equal to 0.22 Btu/h·ft²·F. In some embodiments, the insulated unit may have a SHGC of less than or equal to 0.40 and a U-factor of less than or equal to 0.25 Btu/h·ft²·F. In some embodiments, the insulated unit may have a SHGC of less than or equal to 0.23 and a U-factor of less than or equal to 0.28 Btu/h·ft²·F. In some embodiments, the insulated unit may have a SHGC of less than or equal to 0.23 and a U-factor of less than or equal to 0.32 Btu/h·ft²·F.

The SHGC of an insulated unit may be measured using a LS182 Spectrum Transmission Meter and operated in accordance with Spectrum Transmission Meter Model: LS182 User Manual V6.13.

In some embodiments, a ratio of the Rᵥₐₗ of the insulated unit to the weight of the insulated unit is relatively large. In some embodiments, a ratio of the Rᵥₐₗ of the insulated unit to the weight of the insulated unit is greater than or equal to 0.2 h·ft²·F/Btu·lb, greater than or equal to 0.5 h·ft²·F/Btu·lb, greater than or equal to 0.75 h·ft²·F/Btu·lb, greater than or equal to 0.8 h·ft²·F/Btu·lb, greater than or equal to 0.9 h·ft²·F/Btu·lb, greater than or equal to 1 h·ft²·F/Btu·lb, greater than or equal to 1.1 h·ft²·F/Btu·lb, greater than or equal to 1.2 h·ft²·F/Btu·lb, greater than or equal to 1.3 h·ft²·F/Btu·lb, greater than or equal to 1.4 h ft²·F/Btu·lb, greater than or equal to 1.5 h·ft²·F/Btu·lb, greater than or equal to 1.6 h ft²·F/Btu·lb, and/or greater than or equal to 2 h·ft²·F/Btu·lb. In some embodiments, a ratio of the Rᵥₐₗ of the insulated unit to the weight of the insulated unit is less than or equal to 2 h ft²·F/Btu·lb, less than or equal to 1.6 h·ft²·F/Btu·lb, less than or equal to 1.5 h·ft²·F/Btu·lb, less than or equal to 1.4 h·ft²·F/Btu·lb, less than or equal to 1.3 h·ft²·F/Btu·lb, less than or equal to 1.2 h·ft²·F/Btu·lb, less than or equal to 1.1 h·ft²·F/Btu·lb, less than or equal to 1.0 h·ft²·F/Btu·lb, less than or equal to 0.9 h·ft²·F/Btu·lb, less than or equal to 0.8 h·ft²·F/Btu·lb, and/or less than or equal to 0.75 h·ft²·F/Btu·lb. Combination of these ranges are possible (e.g., greater than or equal to 0.2 h·ft²·F/Btu·lb and less than or equal to 2 h·ft²·F/Btu·lb). Other ranges are also possible.

The insulated unit may have any of a variety of thicknesses. For example, as shown in FIG. 24E, insulated unit 300H has thickness T6. In some embodiments, the thickness of the insulated unit is greater than or equal to 0.5 in, greater than or equal to 0.75 in, greater than or equal to 1 in, greater than or equal to 1.25 in, greater than or equal to 1.5 in, greater than or equal to 1.75 in, and/or greater than or equal to 2 in. In some embodiments, the thickness of the insulated unit is less than or equal to 2 in, less than or equal to 1.75 in, less than or equal to 1.5 in, less than or equal to 1.25 in, less than or equal to 1 in, less than or equal to 0.75 in, and/or less than or equal to 0.5 in. Combinations of these ranges are possible (e.g., greater than or equal to 0.5 in and less than or equal to 2 in). Other ranges are also possible.

In some embodiments, the insulated unit provide sound insulative properties. For instance, the insulated unit may limit the propagation of sounds waves therethrough, thereby providing noise reduction and transparent soundproofing for window applications. In some embodiments, the insulated unit reduces noise by at least 10 db, at least 12 db, at least 14 db, at least 16 db, at least 18 db, at least 20 db, at least 25 db, at least 30 db, at least 35 db, and/or at least 40 db, and/or up to 90 db, up to 95 db, or up to 100 db. Combinations of these ranges are also possible (e.g., at least 10 db and up to 100 db). Other ranges are possible.

In some embodiments, a ratio of the solar heat gain coefficient (SHGC) of the insulated unit to the visible transmittance through the insulated unit is relatively high. In some embodiments, the ratio of the solar heat gain coefficient (SHGC) of the insulated unit to the visible transmittance through the insulated unit is greater than or equal to 0.40, greater than or equal to 0.50, greater than or equal to 0.60, greater than or equal to 0.70, greater than or equal to 0.80, greater than or equal to 0.90, greater than or equal to 0.92, greater than or equal to 0.94, greater than or equal to 0.96, greater than or equal to 0.98, and/or greater than or equal to 0.99. In some embodiments, the ratio of the solar heat gain coefficient (SHGC) of the insulated unit to the visible transmittance through the insulated unit is less than or equal to 0.99, less than or equal to 0.98, less than or equal to 0.96, less than or equal to 0.94, less than or equal to 0.92, less than or equal to 0.90, less than or equal to 0.80, less than or equal to 0.70, less than or equal to 0.60, less than or equal to 0.50, and/or less than or equal to 0.40. Combinations of these ranges are possible (e.g., greater than or equal to 0.9 and less than or equal to 0.99). Other ranges are also possible.

In some embodiments, a ratio of the Rᵥₐₗ of the insulated unit to a thickness of the insulated unit is relatively high. In some embodiments, the ratio of the Rᵥₐₗ of the insulated unit to the thickness of the insulated unit is greater than or equal to 3 h·ft²·F/Btu·in, greater than or equal to 3.1 h·ft²·F/Btu·in, greater than or equal to 3.2 h·ft²·F/Btu·in, greater than or equal to 3.3 h·ft²·F/Btu·in, greater than or equal to 3.4 h·ft²·F/Btu·in, greater than or equal to 3.5 h·ft²·F/Btu·in, greater than or equal to 3.6 h·ft²·F/Btu in, greater than or equal to 3.7 h·ft²·F/Btu·in, greater than or equal to 3.8 h·ft²·F/Btu in, greater than or equal to 3.9 h·ft²·F/Btu·in, greater than or equal to 4 h·ft²·F/Btu·in, greater than or equal to 5 h·ft²·F/Btu·in, greater than or equal to 7 h·ft²·F/Btu in, greater than or equal to 7.1 h·ft²·F/Btu·in, greater than or equal to 8 h·ft²·F/Btu in, greater than or equal to 9 h·ft²·F/Btu in, greater than or equal to 10 h·ft²·F/Btu·in, greater than or equal to 12 h·ft²·F/Btu·in, greater than or equal to 15 h·ft²·F/Btu in, and/or greater than or equal to 20 h·ft²·F/Btu·in. In some embodiments, the ratio of the Rᵥₐₗ of the insulated unit to the thickness of the insulated unit is less than or equal to 20 h·ft²·F/Btu·in, less than or equal to 15 h·ft²·F/Btu·in, less than or equal to 12 h·ft²·F/Btu·in, less than or equal to 10 h·ft²·F/Btu·in, less than or equal to 7.1 h·ft²·F/Btu·in, less than or equal to 7.1 h·ft²·F/Btu·in, less than or equal to 5 h·ft²·F/Btu in, less than or equal to 4 h·ft²·F/Btu·in, less than or equal to 3.9 h·ft²·F/Btu·in, less than or equal to 3.8 h·ft²·F/Btu·in, less than or equal to 3.7 h ft²·F/Btu·in, less than or equal to 3.6 h·ft²·F/Btu·in, less than or equal to 3.5 h·ft²·F/Btu·in, less than or equal to 3.4 h·ft²·F/Btu·in, less than or equal to 3.3 h·ft²·F/Btu·in, less than or equal to 3.2 h·ft²·F/Btu·in, less than or equal to 3.1 h·ft²·F/Btu·in, and/or less than or equal to 3 h·ft²·F/Btu·in. Combinations of these ranges are possible (e.g., greater than or equal to 3 h·ft²·F/Btu·in and less than or equal to 4 h·ft²·F/Btu·in). Other ranges are possible.

As described above, the ratio of the Rᵥₐₗ of the insulated unit to the thickness of the insulated unit is relatively high. In some embodiments, an essentially identical insulated unit, absent the aerogel, has a ratio of the Rᵥₐₗ of the essentially identical insulated unit to the thickness of the essentially identical insulated unit that is less than the ratio of the Rᵥₐₗ of the insulated unit to a thickness of the insulated unit. In some embodiments, the ratio of the Rᵥₐₗ of the insulated unit to the thickness of the insulated unit is at least 1% (or at least 5%, at least 10%, at least 20%, at least 30%, at least 40%, at least 50%, at least 60%, at least 70%, at least 80%, at least 90%, at least 95%, and/or up to 99%, up to 99.9%, or up to 99.95%) greater than the ratio of the Rᵥₐₗ of the essentially identical insulated unit to the thickness of the essentially identical insulated unit. The essentially identical insulated unit may be a conventional insulated glass unit.

In some embodiments, a ratio of the Rᵥₐₗ of the insulated unit to the visible transmittance through the insulated unit is relatively low. In some embodiments, the ratio of the Rᵥₐₗ of the insulated unit to a visible transmittance through the insulated unit is less than or equal to 9 h ft²·F/Btu, less than or equal to 8 h·ft²·F/Btu, less than or equal to 7 h·ft²·F/Btu, less than or equal to 6 h·ft²·F/Btu, less than or equal to 5 h·ft²·F/Btu, less than or equal to 4 h·ft²·F/Btu, less than or equal to 3 h·ft²·F/Btu, and/or less than or equal to 2 h·ft²·F/Btu. In some embodiments, the ratio of the Rᵥₐₗ of the insulated unit to a visible transmittance through the insulated unit is greater than or equal to 2 h·ft²·F/Btu, greater than or equal to 3 h·ft²·F/Btu, greater than or equal to 4 h ft²·F/Btu, greater than or equal to 5 h·ft²·F/Btu, greater than or equal to 6 h·ft²·F/Btu, greater than or equal to 7 h·ft²·F/Btu, greater than or equal to 8 h·ft²·F/Btu, and/or greater than or equal to 9 h·ft²·F/Btu. Combinations of these ranges are possible (e.g., less than or equal to 9 h·ft²·F/Btu and greater than or equal to 2 h·ft²·F/Btu). Other ranges are possible.

In some embodiments, the insulated units described herein have advantageous properties over essentially identical insulated units absent the aerogel. For instance, in some cases, an essentially identical insulated unit, absent the aerogel, has a U-factor that is greater than the U-factor of the insulated unit. In some embodiments, an essentially identical insulated unit, absent the aerogel, has a ratio of the Rᵥₐₗ of the essentially identical insulated unit to the weight of the essentially identical insulated unit that is less than the ratio of the Rᵥₐₗ of the insulated unit to the weight of the insulated unit comprising the aerogel.

The following examples are intended to illustrate certain embodiments of the present invention, but do not exemplify the full scope of the invention.

### Example 1

In this example, aerogels having relatively large areas and relatively low defects are fabricated.

### Materials and Methods

### Aerogel Sample Preparation

In this example, a 14″×20″ monolithic gel was cast using the following recipe described in Table 1 using the general process described in FIG. 2A.

TABLE 1
Recipe for monolithic gel

| | High-performance | Tetramethyl | |
|---|---|---|---|
| | liquid chromatograph | orthosilicate | 0.5M |
| | (HPLC) Grade | (TMOS) | Ammonium |
| Ingredient | Methanol | Oligomer | Hydroxide |
| Mass (g) | 390.38 | 99.74 | 75.35 |

Then, 12 gel samples approximately 33 mm in length and width were punched out from the monolithic gel. These samples were then transported to a container of methanol for a first solvent exchange step at room temperature for 24 hours. The samples were then organized into pairs for a heat treatment for a variety of durations under relatively high temperature (HT). The gel names and corresponding HT duration times are provided in Table 2.

TABLE 2
Gel samples and duration of exposure to relatively
high temperatures during heat treatment (HT)

| Gel | Time in HT (hr) |
|---|---|
| 1-1 (0 HR-1) | 0 |
| 1-2 (0 HR-2) | 0 |
| 2-1 (2 HR-1) | 2 |
| 2-2 (2 HR-2) | 2 |
| 3-1 (4 HR-1) | 4 |
| 3-2 (4 HR-2) | 4 |
| 4-1 (6 HR-1) | 6 |
| 4-2 (6 HR-2) | 6 |
| 5-1 (8 HR-1) | 8 |
| 5-2 (8 HR-2) | 8 |
| 6-1 (24 HR-1) | 24 (Control) |
| 6-2 (24 HR-2) | 24 (Control) |

After each sample was subjected to its corresponding HT duration described in Table 2, it was transported to containers with methanol for a third solvent exchange at room temperature. Then, the gels were moved to new containers with additional fresh methanol for a fourth solvent exchange at room temperature. After was completed, the gel samples were dried via a 1 liter Critical Point Dryer (CPD) and then subjected to a production style annealing process over the course of the weekend (e.g., 2-3 days). The production style annealing process generally involves a temperature ramping up to a temperature of 250 degrees Celsius at a rate of 3.83 degrees Celsius per minute. The aerogel is held at 250 degrees Celsius for 24 before the temperature is ramped down to 100 degrees Celsius at a rate of 3.83 degrees Celsius per minute.

The temperature is then held at 100 degrees Celsius for 18 hours before the temperature is reduced to room temperature. It should be noted that, in some case, the duration of each steps of the annealing process (e.g., 24 hours at 200 degrees Celsius and 18 hours at 100 degrees Celsius) may vary, as well as the temperatures and ramp rates can be varied. Dimensional measurements were taken between process steps. The overall process is summarized in Table 3.

TABLE 3
Summary of aerogel fabrication and corresponding
duration of each fabrication stage.

| Stage | Duration (hr) |
|---|---|
| Gel Preparation | N/A |
| Gel Aging | 2 |
| Gel Punchouts | N/A |
| First Solvent | 24 |
| Exchange | |
| Heat Treatment | Variable |
| (HT) | |
| Third Solvent | 16-24 |
| Exchange | |
| Fourth Solvent | 24 |
| Exchange | |
| CPD | 6 |
| Annealing | 72 |

### Dimensional Stability Measurements

Length and width measurements of the gel samples were acquired using a Dino-Lyte USB digital microscope with DinoCapture 2.0 software throughout processing in order to understand the effect of lower HT durations during the heat treatment on their dimensional stability profiles. Dimensional measurements began prior to the heat treatment and continued after each processing step. Two measurements were acquired for each gel and averaged to produce a final measurement for each step. These measurements were then plotted, and the resulting plots are described below.

### Results

### Dimensional Stability Results

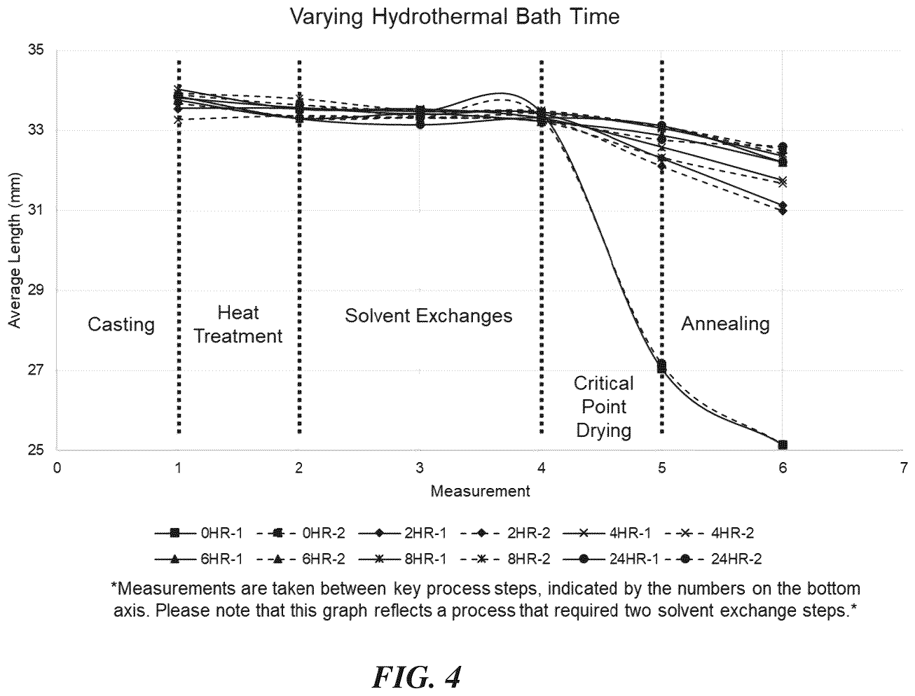

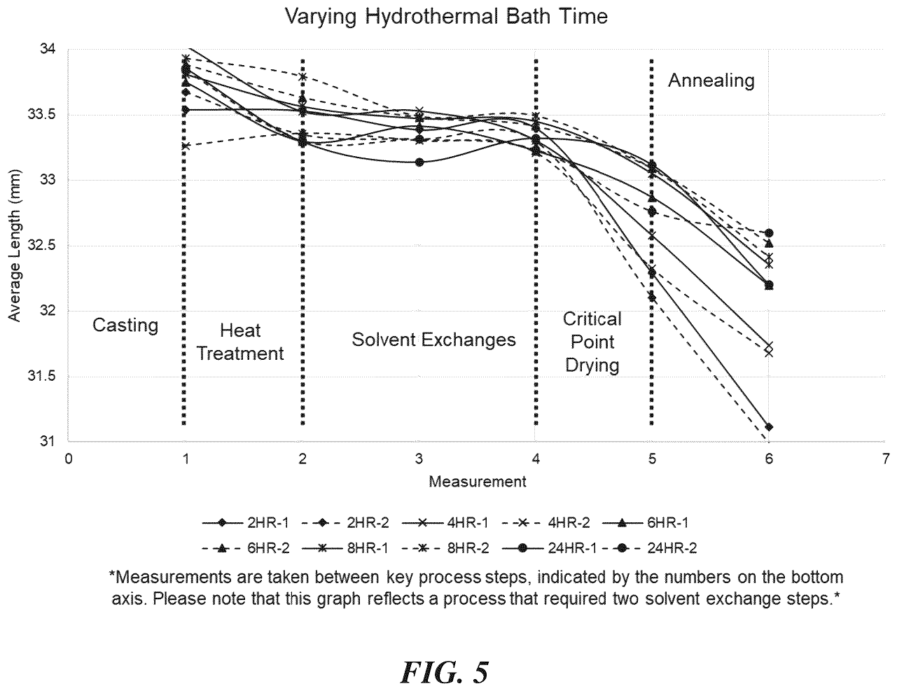

FIG. 4 shows the dimensional stability profiles of all of the gels used in this study as they went through processing. The average gel lengths were measured after each steps of the fabrication process of the gel, from casting to annealing. The plotted data series in FIG. 5 indicate the dimensional change exhibited by the gel samples having been exposed to a hydrothermal bath for various durations. Gel samples OHR-1 and OHR-2 were not subjected to the HT treatment and indicate the importance of this step. Both of these gels suffered catastrophic shrinkage of ˜25%. The bath composition and elevated temperature of the heat treatmentstrengthen the nanostructure of the gels such that the samples resisted nanoscale destruction that causes shrinkage and cracking. The OHR gels demonstrate the importance of these conditions in aerogel processing.

The dimensional stability profiles of the rest of the gels are better represented in FIG. 5, which omits the OHR gels. FIG. 5 shows a correlation between gel shrinkage and the heat treatment duration; lower heat treatment durations result in higher shrinkage, as demonstrated by the 2 HR and 4 HR gels. However, this shrinkage seems to plateau with durations of the heat treatment of 6 hours or more. The degree of shrinkage between the 6 HR gels appears to be similar to that of the 24 HR control gels. This suggests that sufficient gel strengthening can be achieved using a 6-hour duration for the heat treatment.

### Final Gel Properties

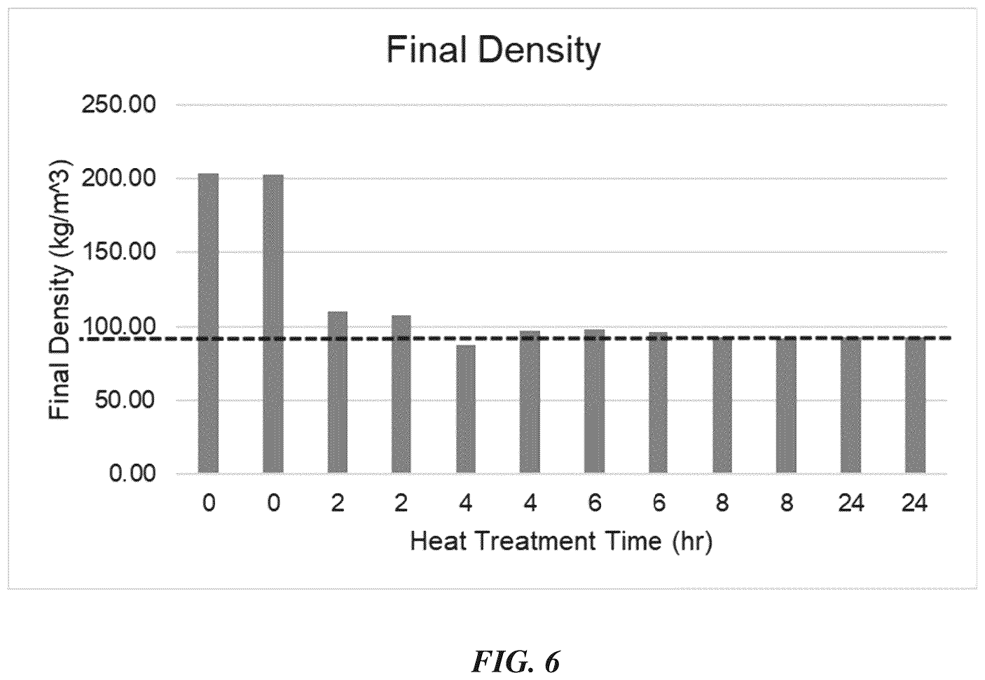

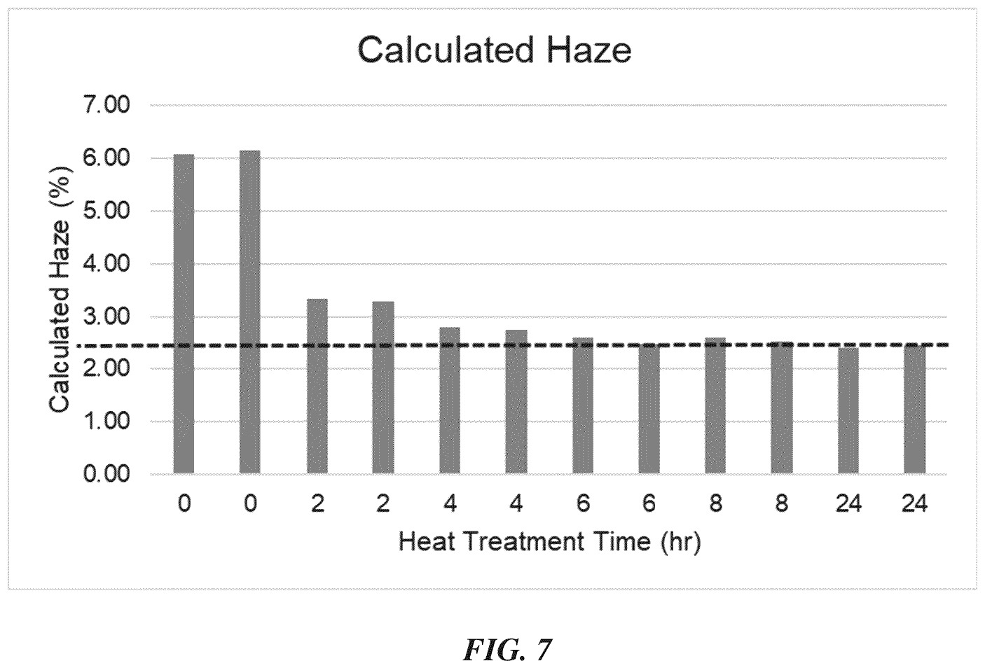

After the gel samples were fully processed, final density and haze values were acquired for each gel. These values are summarized in Table 4. Trends in both density and final gel haze follow the correlation shown in the dimensional stability profiles described above. Lowering the duration of the heat treatment results in gels that are generally denser and hazier than gels obtained with longer times. Surprisingly, the density and haze values of the 4-HR gel samples are similar to that of the gel samples that have undergone longer the heat treatment having longer durations, despite the higher degree of shrinkage. This may suggest that a surprisingly advantageous duration for the heat treatment could be found between 4 and 6 hours. Both the final density and haze values are graphically represented in FIG. 6 and FIG. 7.

Reduction in the duration of the heat treatment may be useful for an overall reduction in gel processing time. This data suggests that the heat treatment can be potentially shortened to 6 hours without adversely affecting final gel quality. Anything shorter than 6 hours has been demonstrated to lower the gels structural integrity, leading to high shrinkage, cracking, and higher density.

TABLE 4
Density and Calculated Haze of Aerogel Samples exposed
to various durations of the heat treatment.

| | Heat Treatment | Density | Calculated |
|---|---|---|---|
| Gel | Bath Time (hr) | (kg/m³) | Haze |
| 1-1 | 0 | 203.54 | 6.08 |
| 1-2 | 0 | 202.96 | 6.13 |
| 2-1 | 2 | 110.18 | 3.33 |
| 2-2 | 2 | 107.87 | 3.28 |
| 3-1 | 4 | 87.33 | 2.78 |
| 3-2 | 4 | 97.53 | 2.75 |
| 4-1 | 6 | 97.63 | 2.61 |
| 4-2 | 6 | 96.06 | 2.47 |
| 5-1 | 8 | 92.48 | 2.61 |
| 5-2 | 8 | 91.51 | 2.52 |
| 6-1 | 20 | 92.75 | 2.41 |
| 6-2 | 20 | 92.58 | 2.45 |

### Presence of Defects

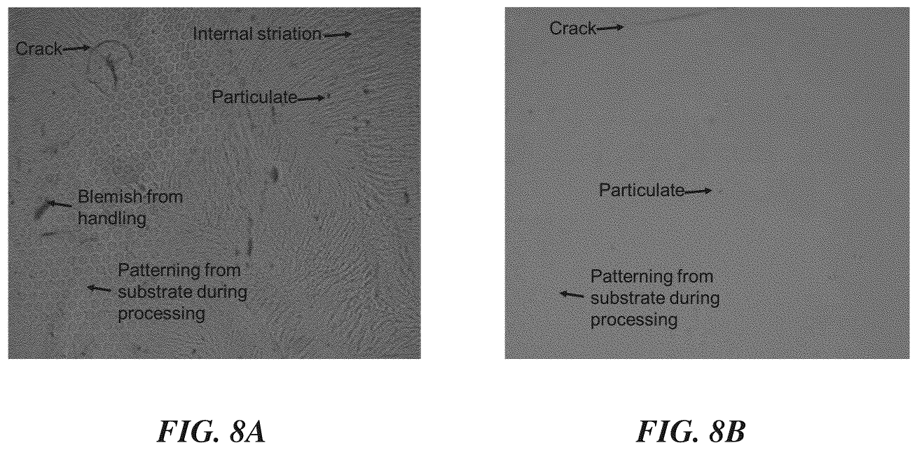

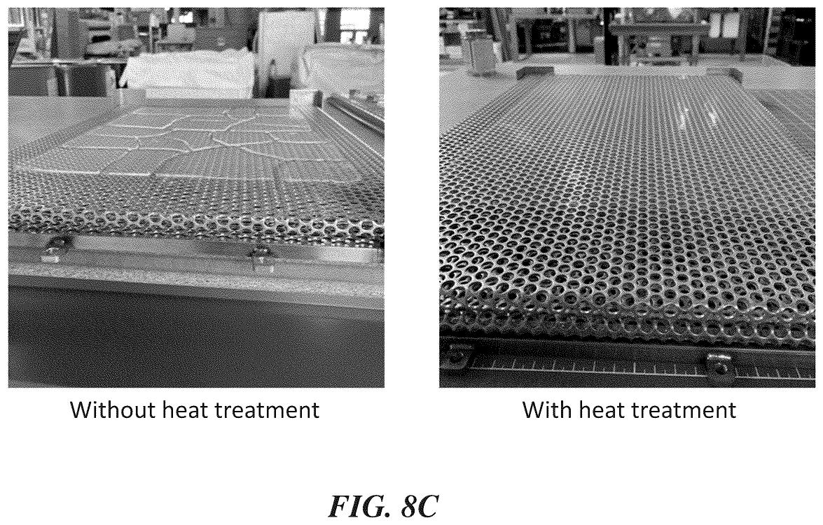

FIG. 8A and FIG. 8B shows an example of an aerogel having a relatively large amount of defects and an aerogel having a relatively low amount of defects that, in some cases, can be fabricated using the processes, or modifications of the processes, described in this example. As shown in FIG. 8A, a relatively large amount of defects are present in the aerogel sample including but not limited to cracks, patterning from substrates used during aerogel preparation (e.g., molding, demolding, and racking processes), internal striations (e.g., influenced by the style and orientation of the molding), particulates, and/or other blemishes (e.g., may be controlled through handling and storage methods). As shown in FIG. 8B, a relatively low amount of defects are present in the aerogel sample compared to that shown in FIG. 8A. FIG. 8C depicts images of a monolithic aerogel having undergone a heat treatment with and without the presence of water. Note that the presence of water during the heat treatment is observed to produce monolithic aerogels having less haze and relatively large areas.

### Example 2

This example generally describes a process to couple (e.g., adhere) aerogel sheets to glass with a relatively low increase in haze. The resulting article that is formed (e.g., an aerogel/glass composite) may then be used in insulated glass units (IGU). The bond between the aerogel and the glass allow for the resulting IGU to pass certain regulatory and certification standards, which include slam testing, thermal cycling, UV stability, optical quality, and static wind loads. The materials and processes described herein may be applied to other transparent and/or substantially transparent substrates as well (e.g., acrylic).

### Materials and Methods

Several methods were tested to couple a monolithic aerogel to a glass substrate. The first method involves coupling an aerogel to glass without the use of adhesives to form a composite. In this first method, the aerogel was applied to the glass with a pressure of 14 PSI using a vacuum chamber for a duration of 30 minutes, although a shorter duration (e.g., 2 minutes or less) may be used. The glass was cleaned using 70% Isopropyl alcohol before the aerogel is added. Other cleaning methods are possible and may involve water with trace amounts of surfactant.

The second method involved applying a double-sided optically clear adhesive (OCA) to the glass before the aerogel was disposed on the glass. The glass was cleaned using 70% Isopropyl before the OCA was added.

The third method involved using a VPS 4721 adhesion promoter, a bifunctional organosilane, to improve the adhesion between a glass substrate and the aerogel. Without wishing to be bound by any particular theory, in the presence of water, the methoxy groups of VPS 4721 hydrolyze to form reactive silanol groups which can bond the aerogel to glass. This promoter was sprayed onto the glass before the aerogel was disposed on the surface of the glass and then wetted for a duration of 2 minutes at 14 PSI. The aerogel/glass composite was then cured for 30 minutes at 180 degrees Celsius.

Each composite evaluated in this example, unless indicated otherwise, involved a 2″×2″ piece of glass adhered to a 1.5″x1.5″ aerogel, although the same or similar testing regimes may be used to evaluated larger composites or IGUs (e.g., having dimensions of 14″×20″).

### Characterization of Ultimate Shear Strength

The ultimate shear strength of composite samples were measured using a Rheometer test. The aerogel is stuck to an optically clear adhesive on side of it, and glass on the other (with an adhesion promoter in between). The aerogel-glass composite is twisted using a custom fixture in an Instron machine to measure the ultimate shear strength of the bond. The shear strength may be determined by monitoring the rotation and torque applied to the sample.

### Cyclic Slam Testing

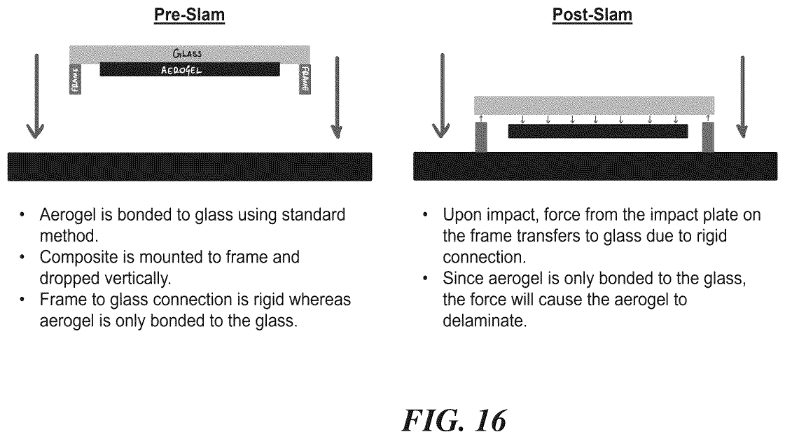

To assess the durability of the glass-aerogel composite, cyclic slam testing was conducted. Cyclic slam testing data may also indicate the relative strength of the bond. FIG. 16 describes the cyclic slam testing procedure. The glass-aerogel composite is loaded onto frame and the apparatus is then impacted against a surface. The deceleration of the impact between the apparatus comprising the composite is at least 200 g and for each cycle (e.g., slam), the force acting on the glass is intended to break the bond of the aerogel. Large scale slam testing is based on the standard test method, WDMA TM-7 which involves of 25,000 cycle at ˜200 g per impact.

The test method is completed with a 12″×12″ Insulated Glass Unit (IGU) that is mounted into a door and slammed against a fixture using a hinge mechanism.

### Characterization of Haze

To characterize the haze of the aerogel-glass composites, high-resolution (1200 dpi) optical scans of the composite were taken. The average pixel color of each scan was correlated with historical UV-VIS spectrophotometry haze values.

### Results and Discussion

### 1^{st} Method (No Adhesive)

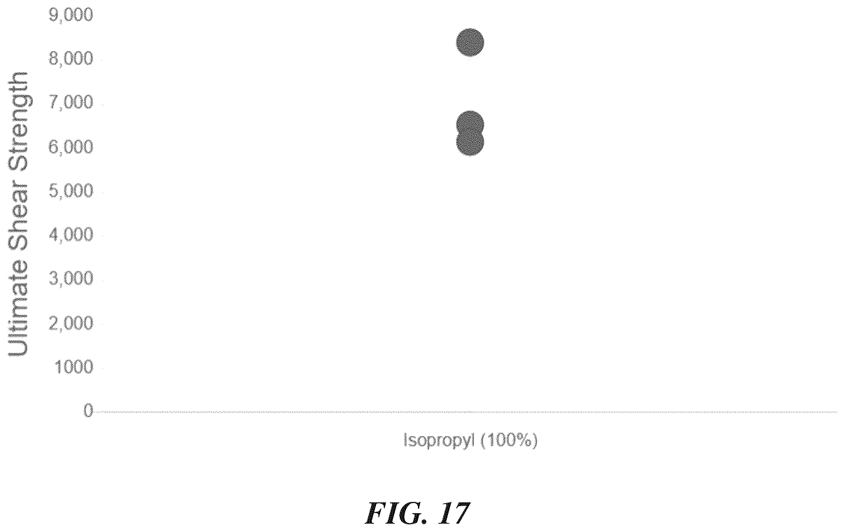

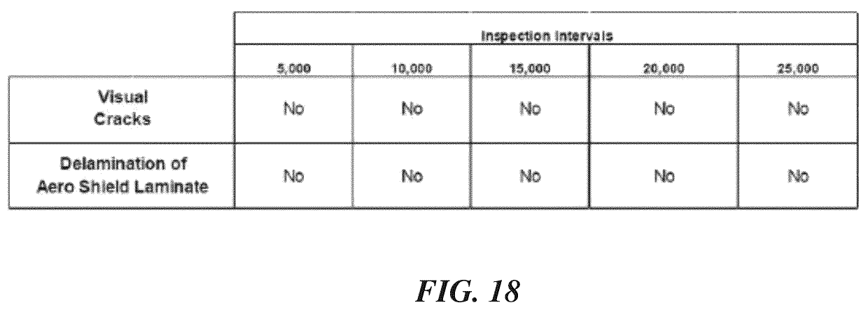

Characterization of ultimate shear strength, durability (small and large scale cyclic slam testing), and haze was conducted on samples fabricated using the first method, as described above. The ultimate shear strength of the aerogel-glass composite fabricated using the first method is shown in FIG. 17. The average ultimate shear strength was 7.02 KPa+/−1.21 Kpa. For cyclic slam testing, three 2″×2″ samples were tested. Each of the three samples survived<2000 slams. The results are shown in Table 5 below. The results of large scale slam testing of 12″×12″ samples are shown in FIG. 18. The samples did not appear to have any visual cracks nor were there any observations of delamination between the aerogel and the glass substrate after 25,000 cycles (slams).

TABLE 5
Number of slams survived using the cyclic slam testing method when
glass was prepped with 100% isopropyl before the aerogel was bonded
using 24 inHg of pressure for 30 minutes.
Number of slams survived for 3 different test samples using 100%
isopropyl as a glass cleaning method

| Sample | Slams Survived |
|---|---|
| 24 inHg Baseline | <2000 slams~1500 slams |
| 30 min adhesion 1 | |
| 24 inHg Baseline | <2000 slams~1200 slams |
| 30 min adhesion 2 | |
| 24 inHg Baseline | <2000 slams~1500 slams |
| 30 min adhesion 3 | |

### 2^{nd} Method (OCA)

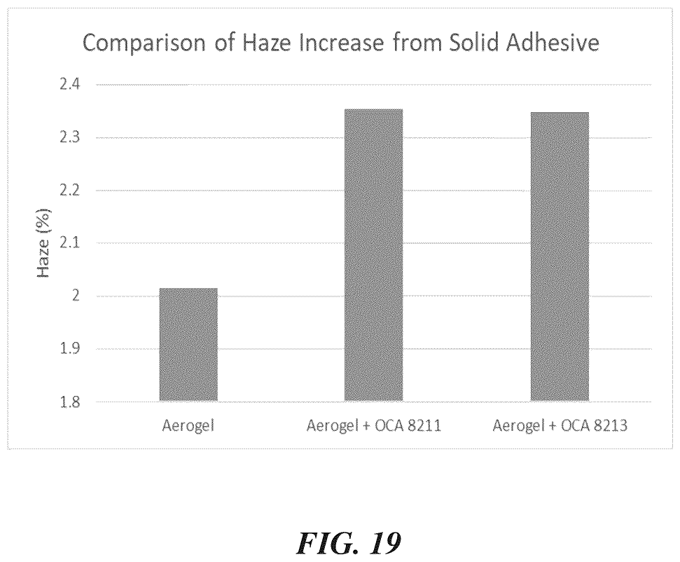

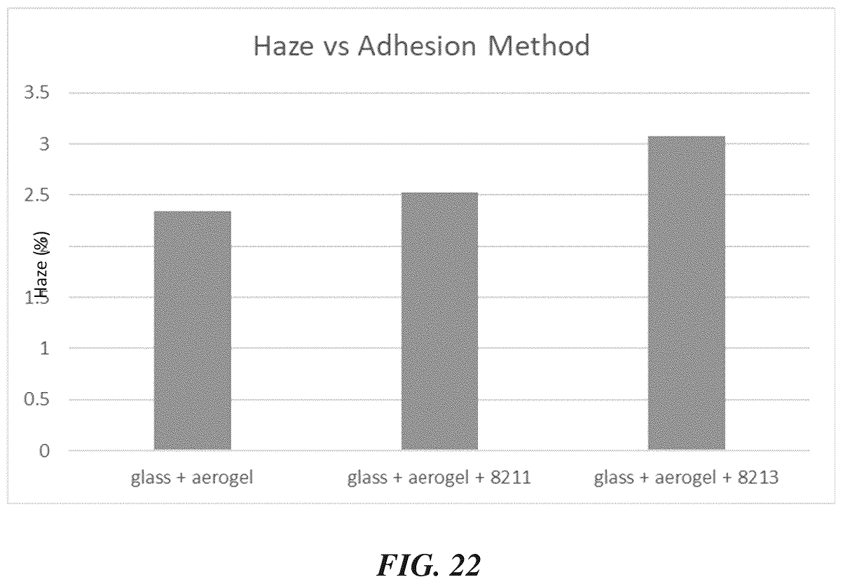

Characterization of haze was conducted on samples fabricated using the second method, as described above. Haze measurements were taken on two different OCA variants: OCA 8211 and OCA 8213. The haze of the OCA variants were compared to the haze of the aerogel. OCA 8211 had a predicted haze of 2.35%+/−0.3% while OCA 8213 had a predicted haze of 2.32%+/−0.3%. The measurement data is shown in FIG. 19. It should be noted that the haze measurements shown in FIG. 19 do not involve a substrate (e.g., a pane of glass). The haze measurements of aerogel-glass composites with and without OCAs are shown in FIG. 22.

### 3^{rd} Method (VPS)

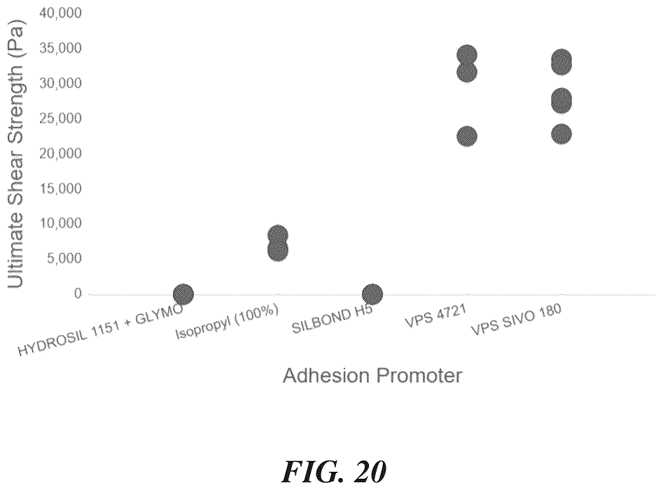

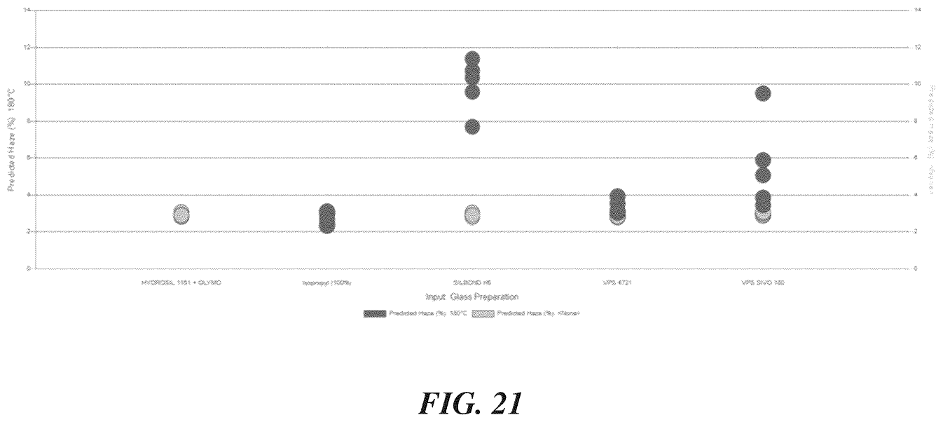

Characterization of ultimate shear strength, durability (small scale slam testing), and haze were conducted on samples fabricated using the third method, as described above. The samples fabricated using the third method had an average ultimate shears strength of 29.5 KPa+/−6.1 KPa. The data is shown in FIG. 20. VPS 4721 showed the highest average ultimate shear strength in comparison to the other adhesion promoters. Small scale slam testing conducted using numerous 2″×2″ samples. The 2″×2″ samples used various spray conditions, such as spray passes, to deposit VPS 4721. The samples having VPS 4721 deposited with 6 passes and 1 pass with wetting before curing survived 25,000 slams. Table 6 shows the comparison of these results below. Haze measurements on samples having VPS 4721 had a relatively low haze after curing with 6 passes at a value of 1.53%+/−0.37%. FIG. 21 shows the measurement of the haze value taken. VPS 4721 showed the lowest predicted haze value. As the third method showed sufficient durability and relatively low haze, the VPS 4721 application process was further evaluated with different number of passes. The results are shown in Table 7.

TABLE 6
Number of slams survived using the cyclic slam testing method when
glass was prepped with different numbers of passes of VPS 4721. Both
six passes with no wetting and one pass with 28 inHg of pressure
applied for 2 minutes survived 25k slams.
Number of slams survived for 4 different test samples using
different numbers of passes of VPS 4721

| Sample | Slams Survived |
|---|---|
| VPS one pass spray | <1000 slams~850 slams |
| VPS one pass spray | <7000 slams~6800 slams |
| VPS six pass spray | 25k slams |
| VPS one pass spray with | 25k slams |
| 28 inHg for 2 mins | |

TABLE 7
VPS 4721 application with spray passes ranging from 1 to 12 passes. 6
passes showed the lowest haze value at 1.53% +/− 0.37%.

| Variant | Vacuum? | VPS? | Passes | ImageJ | Haze |
|---|---|---|---|---|---|
| Composite | No | Yes | 6 | 26.923 | 1.53 |
| with VPS 6P | | | | | |
| Composite | No | Yes | 1 | 27.072 | 1.56 |
| with VPS 1P | | | | | |
| Composite | No | Yes | 6 | 27.088 | 1.56 |
| with VPS 6P | | | | | |
| Composite | No | Yes | 6 | 27.941 | 1.74 |
| with VPS 6P | | | | | |
| Composite | Yes | Yes | 1 | 28.038 | 1.76 |
| with VPS | | | | | |
| 1P + Vac | | | | | |
| Composite | Yes | Yes | 6 | 28.583 | 1.88 |
| with VPS | | | | | |
| 6P + Vac | | | | | |
| Composite | Yes | Yes | 1 | 28.738 | 1.91 |
| with VPS | | | | | |
| 1P + Vac | | | | | |
| Composite | No | Yes | 12 | 28.974 | 1.97 |
| with VPS | | | | | |
| 12P | | | | | |
| Composite | No | Yes | 12 | 29.04 | 1.98 |
| with VPS | | | | | |
| 12P | | | | | |
| Composite | No | Yes | 1 | 29.898 | 2.16 |
| with VPS 1P | | | | | |
| Composite | Yes | Yes | 6 | 29.925 | 2.17 |
| with VPS | | | | | |
| 6P + Vac | | | | | |
| Composite | No | Yes | 3 | 30.038 | 2.19 |
| with VPS 3P | | | | | |
| Composite | No | Yes | 1 | 30.218 | 2.23 |
| with VPS 1P | | | | | |
| Composite | Yes | Yes | 1 | 30.237 | 2.24 |
| with VPS | | | | | |
| 1P + Vac | | | | | |
| Composite | Yes | Yes | 6 | 30.563 | 2.31 |
| with VPS | | | | | |
| 6P + Vac | | | | | |
| Composite | No | Yes | 3 | 30.657 | 2.33 |
| with VPS 3P | | | | | |
| Composite | No | Yes | 3 | 33.645 | 2.97 |
| with VPS 3P | | | | | |
| Composite | No | Yes | 12 | 33.724 | 2.98 |
| with VPS | | | | | |
| 12P | | | | | |

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, “wt %” is an abbreviation of weight percentage. As used herein, “at %” is an abbreviation of atomic percentage.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An article, comprising:
an aerogel comprising silica, wherein the aerogel has a volume greater than or equal to 400 cm³ and haze less than or equal to 5% through at least a portion of the aerogel.

2. An article, comprising:
an aerogel comprising silica and having a surface with a continuous substantially transparent area of at least 900 cm², wherein the entire continuous substantially transparent area is defined by a plurality of 1 cm² geometric areas, and transmittance measured through the aerogel perpendicular to the surface through at least one location within each of the 1 cm² geometric areas is greater than or equal to 85% at at least one wavelength greater than or equal to 360 nm and less than or equal to 780 nm when measured at a thickness of at least 0.5 mm.

3. An article, comprising:
an aerogel comprising silica and having a surface with a continuous substantially transparent area of at least 900 cm², wherein the entire continuous substantially transparent area is defined by a plurality of 1 cm² geometric areas, and at no location within the entire continuous substantially transparent area is there a 1 cm² geometric area through which maximum transmittance through the aerogel perpendicular to the surface differs by more than 10% relative to the average of transmittance through all of the 1 cm² geometric areas of the continuous substantially transparent area, all measured at at least one wavelength greater than or equal to 360 nm and less than or equal to 780 nm and measured at a thickness of at least 0.5 mm.

4.-16. (canceled)

17. The article of claim 1, wherein the haze of less than or equal to 5% is measured at the shortest pathway through the article.

18. The article of claim 1, wherein the haze less than or equal to 5% is measured at a thickness of the aerogel of at least 0.5 mm.

19. The article of claim 2, wherein the aerogel has a maximum transverse dimension greater than or equal to 25 cm.

20. The article of claim 2, wherein the aerogel has a maximum transverse dimension greater than or equal to 50 cm.

21. The article, wherein transmittance measured through the aerogel perpendicular to the surface through at least one location within each of the 1 cm² geometric areas of the continuous substantially transparent area is greater than or equal to 85% at at least one wavelength greater than or equal to 380 nm and less than or equal to 410 nm when measured at a thickness of at least 0.5 mm.

22.-31. (canceled)

32. The article of claim 3, wherein the aerogel has a geometric surface area greater than 2000 cm².

33. The article of claim 3, wherein the aerogel has a thermal conductivity less than or equal to 25 mW/mK.

34. The article of claim 1, wherein the aerogel has a transmittance that is greater than or equal to 95 at at least one wavelength greater than or equal to 380 and less than or equal to 410 nm when measured at a thickness of at least 0.5 mm.

35. The article of claim 1, wherein the aerogel comprises a continuous volume of at least 400 cm³, wherein the entire continuous volume of the aerogel is defined by a plurality of 40 cm³ geometric volumes, and thermal conductivity of each of the 40 cm³ geometric volumes of the continuous volume is less than or equal to 25 mW/mK.

36. The article of claim 1, wherein the aerogel comprises a continuous volume of at least 400 cm³, wherein the entire continuous volume of the aerogel is defined by a plurality of 40 cm³ geometric volumes, and the density of each of the 40 cm³ geometric volumes of the continuous volume is less than or equal to 350 kg/m³.

37.-44. (canceled)

45. The article of claim 1, wherein the aerogel has a mean scattering radius less than or equal to 5 nm.

46. The article, of claim 1, wherein the aerogel has a mean pore radius of less than or equal to 10 nm.

47. The article of claim 1, wherein the aerogel has a mean particle radius of less than or equal to 2 nm.

48. The article of claim 1, wherein the aerogel has a porosity of greater than or equal to 90%.

49.-57. (canceled)

58. The article of claim 3, wherein the aerogel has a volume greater than or equal to 1000 cm³.

59. (canceled)

60. The article of claim 3, wherein at least a portion of the aerogel has a fracture toughness greater than or equal to 500 Kpa·m^{1/2} and less than or equal to 1500 Kpa·m^{1/2}.

61. The article of claim 1, wherein at least a portion of the aerogel comprises a defect having a critical flaw size greater than or equal to 2 mm and less than or equal to 3 mm.

62.-117. (canceled)
